(19) United States
(12) Patent Application Publication
(10) Pub. No.: US 2019/0340737 A1
(43) Pub. Date: Nov. 7, 2019

(54) IMAGE PROCESSING APPARATUS, IMAGE PROCESSING SYSTEM, IMAGE CAPTURING SYSTEM, IMAGE PROCESSING METHOD, AND RECORDING MEDIUM

(71) Applicants: Keiichi KAWAGUCHI, Kanagawa (JP); Hiroshi SUITOH, Kanagawa (JP); Kazuhiro YOSHIDA, Kanagawa (JP); Takahiro ASAI, Kanagawa (JP)

(72) Inventors: Keiichi KAWAGUCHI, Kanagawa (JP); Hiroshi SUITOH, Kanagawa (JP); Kazuhiro YOSHIDA, Kanagawa (JP); Takahiro ASAI, Kanagawa (JP)

(21) Appl. No.: 16/474,458

(22) PCT Filed: Dec. 28, 2017
(86) PCT No.: PCT/JP2017/047192

§ 371 Date: Jun. 27, 2019

(30) Foreign Application Priority Data
Dec. 28, 2016 (JP) 2016-256581
Mar. 16, 2017 (JP) 2017-051838
Oct. 27, 2017 (JP) 2017-208677
Dec. 21, 2017 (JP) 2017-245455

(51) Int. Cl. G06T 5/50; G06T 3/40; G06T 5/00; H04N 5/217; H04N 5/265; G06T 7/62

(52) U.S. Cl. CPC G06T 5/50; G06T 3/4038; G06T 5/007; G06T 2207/20221; H04N 5/265; G06T 7/62; H04N 5/217

(57) ABSTRACT

An image processing apparatus includes: an obtainer to obtain a first image and a second image; a display control to control a display to display an image of a predetermined area of the first image, the first image being superimposed with the second image; and a correction unit to correct at least one of brightness and color of at least one of the first image and the second image, either according to a ratio of an area of the second image in the predetermined area with respect to the predetermined area of the first image, or according to a difference between a line of sight direction in the first image and a central point of the second image.

### TECHNICAL FIELD

The present invention relates to an image processing apparatus, an image processing system, an image capturing system, an image processing method, and a recording medium.

### BACKGROUND ART

The wide-angle image, taken with a wide-angle lens, is useful in capturing such as landscape, as the image tends to cover large areas. For example, there is an image capturing system, which captures a wide-angle image of a target object and its surroundings, and an enlarged image of the target object. The wide-angle image is combined with the enlarged image such that, even when a part of the wide-angle image showing the target object is enlarged, that part embedded with the enlarged image is displayed in high resolution (See PTL1).

On the other hand, a digital camera that captures two hemispherical images from which a 360-degree, spherical image is generated, has been proposed (See PTL 2). Such digital camera generates an equirectangular projection image based on two hemispherical images, and transmits the equirectangular projection image to a communication terminal, such as a smart phone, for display to a user.

### CITATION LIST

### Patent Literature

PTL 1: Japanese Unexamined Patent Application Publication No. 2016-96487
PTL 2: Japanese Unexamined Patent Application Publication No. 2012-178135
PTL 3: Japanese Patent Application Registration No. 5745134

### SUMMARY OF INVENTION

### Technical Problem

The inventors of the present invention have realized that, the spherical image of a target object and its surroundings, can be combined with such as a planar image of the target object, in a similar manner as described above. However, if the spherical image is to be displayed with the planar image of the target object, brightness or color of these images may differ from each other. Accordingly, the planar image stands out from the spherical image.

In view of this, the inventors of the present invention have thought about correcting brightness of the planar image to correct image data that differ in exposure using any desired known method (See PTL3). However, since the spherical image tends to suffer from overexposure or underexposure as it covers wider area, if the planar image P is to be simply corrected to match brightness or color of the spherical image CE, such correction may not be desirable.

### Solution to Problem

Example embodiments of the present invention include an image processing apparatus including: an obtainer to obtain a first image and a second image; a display control to control a display to display an image of a predetermined area of the first image, the first image being superimposed with the second image; and a correction unit to correct at least one of brightness and color of the second image according to a ratio of an area of the second image in the predetermined area with respect to the predetermined area of the first image.

Example embodiments of the present invention include an image processing apparatus including: an obtainer to obtain a first image and a second image; a display control to control a display to display an image of a predetermined area of the first image, the first image being superimposed with the second image; and a correction unit to correct at least one of brightness and color of at least one of the first image and the second image, according to a difference between a line of sight direction in the first image and a central point of the second image.

Example embodiments of the present invention include an image capturing system including the image processing apparatus, an image processing system, an image processing method, and a recording medium.

### Advantageous Effects of Invention

According to one or more embodiments of the present invention, even when one image is superimposed on other image that are different in brightness or color, the difference in brightness or color between these images is adequacy lowered.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIGS. 1A, 1B, 1C, and 1D (FIG. 1) are a left side view, a rear view, a plan view, and a bottom side view of a special image capturing device, according to an embodiment.

FIG. 2 is an illustration for explaining how a user uses the image capturing device, according to an embodiment.

FIGS. 3A, 3B, and 3C are views illustrating a front side of a hemispherical image, a back side of the hemispherical image, and an image in equirectangular projection, respectively, captured by the image capturing device, according to an embodiment.

FIG. 4A and FIG. 4B are views respectively illustrating the image in equirectangular projection covering a surface of a sphere, and a spherical image, according to an embodiment.

FIG. 5 is a view illustrating positions of a virtual camera and a predetermined area in a case in which the spherical image is represented as a three-dimensional solid sphere according to an embodiment.

FIGS. 6A and 6B are respectively a perspective view of FIG. 5, and a view illustrating an image of the predetermined area on a display, according to an embodiment.

FIG. 7 is a view illustrating a relation between predetermined-area information and a predetermined-area image according to an embodiment.

FIG. 8 is a schematic view illustrating an image capturing system according to a first embodiment.

FIG. 9 is a perspective view illustrating an adapter, according to the first embodiment.

FIG. 10 illustrates how a user uses the image capturing system, according to the first embodiment.

FIG. 11 is a schematic block diagram illustrating a hardware configuration of a special-purpose image capturing device according to the first embodiment.

FIG. 12 is a schematic block diagram illustrating a hardware configuration of a general-purpose image capturing device according to the first embodiment.

FIG. 13 is a schematic block diagram illustrating a hardware configuration of a smart phone, according to the first embodiment.

FIG. 14 is a functional block diagram of the image capturing system according to the first embodiment.

FIGS. 15A and 15B are conceptual diagrams respectively illustrating a linked image capturing device management table, and a linked image capturing device configuration screen, according to the first embodiment.

FIG. 16 is a block diagram illustrating a functional configuration of an image and audio processing unit according to the first embodiment.

FIG. 17 is an illustration of a data structure of superimposed display metadata according to the first embodiment.

FIGS. 18A and 18B are conceptual diagrams respectively illustrating a plurality of grid areas in a second area, and a plurality of grid areas in a third area, according to the first embodiment.

FIG. 19 is a data sequence diagram illustrating operation of capturing the image, performed by the image capturing system, according to the first embodiment.

FIG. 20 is a conceptual diagram illustrating operation of generating a superimposed display metadata, according to the first embodiment.

FIGS. 21A and 21B are conceptual diagrams for describing determination of a peripheral area image, according to the first embodiment.

FIGS. 22A and 22B are conceptual diagrams for explaining operation of dividing the second area into a plurality of grid areas, according to the first embodiment.

FIG. 23 is a conceptual diagram for explaining determination of the third area in the equirectangular projection image, according to the first embodiment.

FIGS. 24A, 24B, and 24C are conceptual diagrams illustrating operation of generating a correction parameter, according to the first embodiment.

FIG. 25 is a conceptual diagram illustrating operation of superimposing images, with images being processed or generated, according to the first embodiment.

FIG. 26 is a conceptual diagram illustrating a two-dimensional view of the spherical image superimposed with the planar image, according to the first embodiment.

FIG. 27 is a conceptual diagram illustrating a three-dimensional view of the spherical image superimposed with the planar image, according to the first embodiment.

FIGS. 28A and 28B are conceptual diagrams illustrating a two-dimensional view of a spherical image superimposed with a planar image, without using the location parameter, according to a comparative example.

FIGS. 29A and 29B are conceptual diagrams illustrating a two-dimensional view of the spherical image superimposed with the planar image, using the location parameter, in the first embodiment.

FIGS. 30A, 30B, 30C, and 30D are illustrations of a wide-angle image without superimposed display, a telephoto image without superimposed display, a wide-angle image with superimposed display, and a telephoto image with superimposed display, according to the first embodiment.

FIG. 31 is a schematic view illustrating an image capturing system according to a second embodiment.

FIG. 32 is a schematic diagram illustrating a hardware configuration of an image processing server according to the second embodiment.

FIG. 33 is a schematic block diagram illustrating a functional configuration of the image capturing system of FIG. 31 according to the second embodiment.

FIG. 34 is a block diagram illustrating a functional configuration of an image and audio processing unit according to the second embodiment.

FIG. 35 is a data sequence diagram illustrating operation of capturing the image, performed by the image capturing system, according to the second embodiment.

FIG. 36 is a conceptual diagram illustrating processing to correct the planar image with images being processed or generated, according to a third embodiment.

FIG. 37 is an illustration of an image generated based on a planar image having brightness and color corrected, and an image generated based on a planar image having brightness and color not corrected, according to the third embodiment.

FIG. 38 is an illustration of images having brightness and color corrected according to a ratio of an area of the superimposed image with respect to the predetermined-area image, according to the third embodiment.

FIG. 39 is an illustration of predetermined-area images, each with a superimposed image having brightness and color corrected according to an area of the superimposed image with respect to the predetermined-area image, according to the third embodiment.

FIG. 40 is a conceptual diagram illustrating a relation between the predetermined area and an area of the superimposed image, according to the third embodiment;

FIG. 41 is an illustration of various areas of a predetermined area image, according to the third embodiment.

FIG. 42 is a conceptual diagram illustrating processing to correct the planar image according to other example of the third embodiment.

FIG. 43 is a conceptual diagram illustrating processing to correct the planar image and equirectangular projection image with images being processed or generated, according to a fourth embodiment.

FIG. 44 is a conceptual diagram illustrating processing to correct the equirectangular projection image with images being processed or generated, according to the fourth embodiment.

FIG. 45 is a conceptual diagram illustrating operation of changing a combined ratio of the planar image and the equirectangular projection image according to the fourth embodiment.

FIG. 46 is an illustration for explaining a relation between the line of sight direction of the virtual camera and the central point of the superimposed image, according to the fourth embodiment.

FIG. 47 is an illustration for explaining a relation between the line of sight direction of the virtual camera and the central point of the superimposed image, according to the fourth embodiment.

FIG. 48 is an illustration for explaining effects in correcting the overexposed spherical image.

FIG. 49 is an illustration for explaining effects in correcting the underexposed spherical image.

FIG. 50 is a conceptual diagram illustrating processing to correct the equirectangular projection image with images being processed or generated, according to the fifth embodiment.

FIG. 51 is an illustration for explaining a relation between the location parameter and the correction parameter, when a plurality of equirectangular projection images that differ in exposure is used, according to the fifth embodiment.

FIG. 52 is an illustration for explaining generation of corrected images having brightness and color corrected, according to the fifth embodiment.

FIG. 53 is an example image of a predetermined area being superimposed with a plurality of superimposed images, according to a sixth embodiment.

FIG. 54 is an illustration for explaining a relation between the line of sight direction and the central point of the superimposed image, when the plurality of superimposed images is superimposed on the predetermined area, according to the sixth embodiment.

FIG. 55 is a conceptual diagram illustrating processing to correct the planar images with images being processed or generated, according to the sixth embodiment.

FIG. 56 is an illustration for explaining generation of corrected images having brightness and color corrected, when there is one planar image as a target for correction, according to the sixth embodiment.

FIG. 57 is an illustration for explaining generation of corrected images having brightness and color corrected, when there is one planar image as a target for correction, according to the sixth embodiment.

FIG. 58 is an illustration for explaining generation of corrected images having brightness and color corrected, when there are two planar images as a target for correction, according to the sixth embodiment.

FIG. 59 is a conceptual diagram illustrating processing to correct the equirectangular projection image with images being processed or generated, according to a seventh embodiment.

FIG. 60 is a conceptual diagram illustrating processing to correct the equirectangular projection image, according to the seventh embodiment.

FIG. 61 is a flowchart illustrating operation of selecting one of the equirectangular projection images to be combined with the predetermined area image, according to the seventh embodiment.

FIG. 62 is an illustration for explaining specific examples of combining images using an overexposed image, according to the seventh embodiment.

FIG. 63 is an illustration for explaining specific examples of combining images using an underexposed image, according to the seventh embodiment.

FIG. 64 is a conceptual diagram illustrating processing to correct the equirectangular projection image with images being processed or generated, according to an eighth embodiment.

FIG. 65 is an illustration for explaining a relation between the corrected equirectangular projection image and the corrected planar image, according to the eighth embodiment.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In this disclosure, a first image is an image superimposed with a second image, and a second image is an image to be superimposed on the first image. For example, the first image is an image covering an area larger than that of the second image. In another example, the first image and the second image are images expressed in different projections. In another example, the second image is an image with image quality higher than that of the first image, for example, in terms of image resolution. Examples of the first image include a spherical image, an equirectangular projection image, and a low-definition image. Examples of the second image include a planar image, a perspective projection image, and a high-definition image.

Further, in this disclosure, the spherical image does not have to be the full-view spherical image. For example, the spherical image may be the wide-angle view image having an angle of about 180 to 360 degrees in the horizontal direction. As described below, it is desirable that the spherical image is image data having at least a part that is not entirely displayed in the predetermined area T.

Referring to the drawings, embodiments of the present invention are described below.

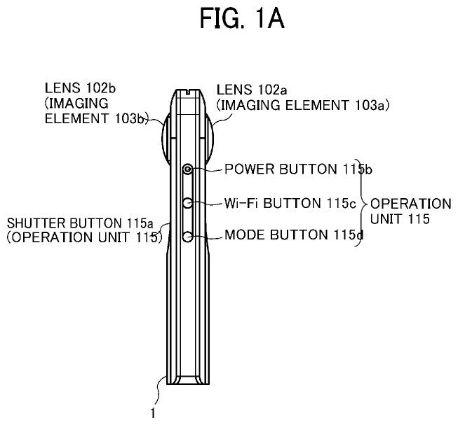

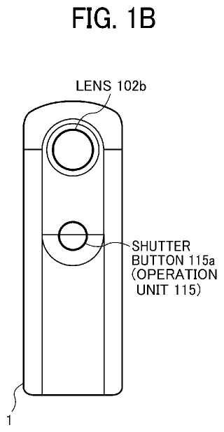

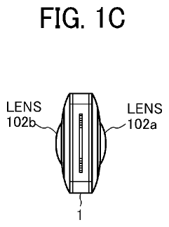

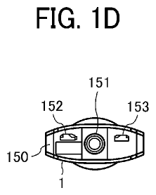

First, referring to FIGS. 1 to 7, operation of generating a spherical image is described according to an embodiment.

First, referring to FIGS. 1A to 1D, an external view of a special-purpose (special) image capturing device 1, is described according to the embodiment. The special image capturing device 1 is a digital camera for capturing images from which a 360-degree spherical image is generated. FIGS. 1A to 1D are respectively a left side view, a rear view, a plan view, and a bottom view of the special image capturing device 1.

As illustrated in FIGS. 1A to 1D, the special image capturing device 1 has an upper part, which is provided with a fish-eye lens 102a on a front side (anterior side) thereof, and a fish-eye lens 102b on a back side (rear side) thereof. The special image capturing device 1 includes imaging elements (imaging sensors) 103a and 103b in its inside. The imaging elements 103a and 103b respectively capture images of an object or surroundings via the lenses 102a and 102b, to each obtain a hemispherical image (the image with an angle of view of 180 degrees or greater). As illustrated in FIG. 1B, the special image capturing device 1 further includes a shutter button 115a on a rear side of the special image capturing device 1, which is opposite of the front side of the special image capturing device 1. As illustrated in FIG. 1A, the left side of the special image capturing device 1 is provided with a power button 115b, a Wireless Fidelity (Wi-Fi) button 115c, and an image capturing mode button 115d. Any one of the power button 115b and the Wi-Fi button 115c switches between ON and OFF, according to selection (pressing) by the user. The image capturing mode button 115d switches between a still-image capturing mode and a moving image capturing mode, according to selection (pressing) by the user. The shutter button 115a, power button 115b, Wi-Fi button 115c, and image capturing mode button 115d are a part of an operation unit 115. The operation unit 115 is any section that receives a user instruction, and is not limited to the above-described buttons or switches.

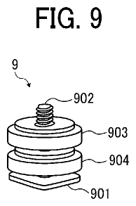

As illustrated in FIG. 1D, the special image capturing device 1 is provided with a tripod mount hole 151 at a center of its bottom face 150. The tripod mount hole 151 receives a screw of a tripod, when the special image capturing device 1 is mounted on the tripod. In this embodiment, the tripod mount hole 151 is where the generic image capturing device 3 is attached via an adapter 9, described later referring to FIG. 9. The bottom face 150 of the special image capturing device 1 further includes a Micro Universal Serial Bus (Micro USB) terminal 152, on its left side. The bottom face 150 further includes a High-Definition Multimedia Interface (HDMI, Registered Trademark) terminal 153, on its right side.

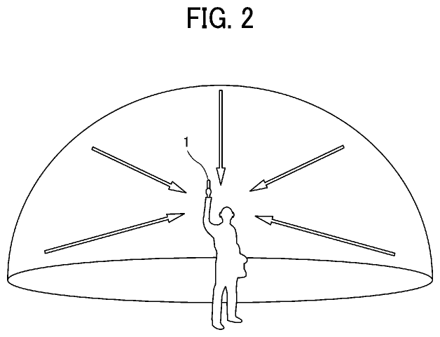

Next, referring to FIG. 2, a description is given of a situation where the special image capturing device 1 is used. FIG. 2 illustrates an example of how the user uses the special image capturing device 1. As illustrated in FIG. 2, for example, the special image capturing device 1 is used for capturing objects surrounding the user who is holding the special image capturing device 1 in his or her hand. The imaging elements 103a and 103b illustrated in FIGS. 1A to 1D capture the objects surrounding the user to obtain two hemispherical images.

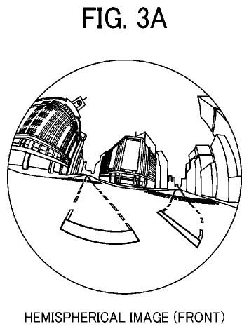

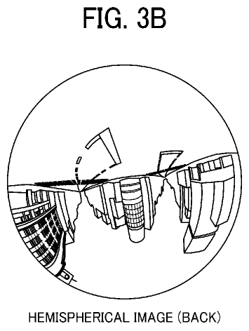

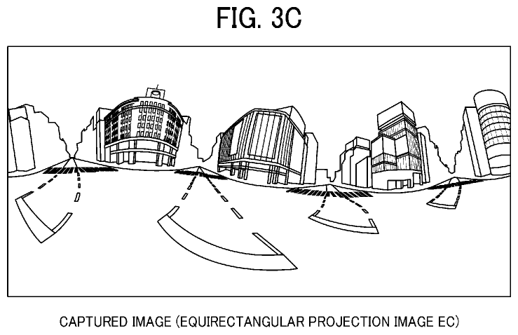

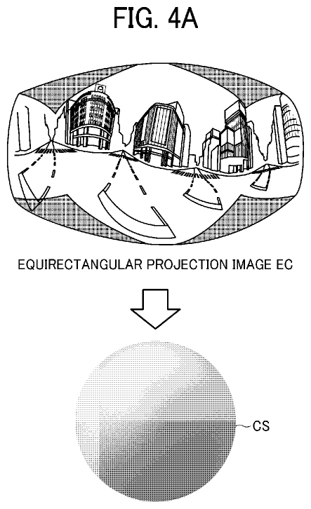

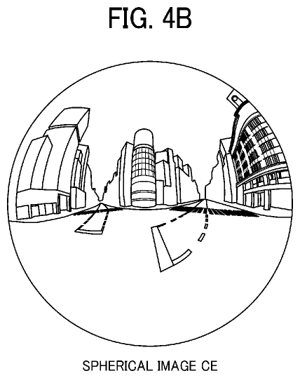

Next, referring to FIGS. 3A to 3C and FIGS. 4A and 4B, a description is given of an overview of an operation of generating an equirectangular projection image EC and a spherical image CE from the images captured by the special image capturing device 1. FIG. 3A is a view illustrating a hemispherical image (front side) captured by the special image capturing device 1. FIG. 3B is a view illustrating a hemispherical image (back side) captured by the special image capturing device 1. FIG. 3C is a view illustrating an image in equirectangular projection, which is referred to as an “equirectangular projection image” (or equidistant cylindrical projection image) EC. FIG. 4A is a conceptual diagram illustrating an example of how the equirectangular projection image maps to a surface of a sphere. FIG. 4B is a view illustrating the spherical image.

As illustrated in FIG. 3A, an image captured by the imaging element 103a is a curved hemispherical image (front side) taken through the fish-eye lens 102a. Also, as illustrated in FIG. 3B, an image captured by the imaging element 103b is a curved hemispherical image (back side) taken through the fish-eye lens 102b. The hemispherical image (front side) and the hemispherical image (back side), which are reversed by 180-degree from each other, are combined by the special image capturing device 1. This results in generation of the equirectangular projection image EC as illustrated in FIG. 3C.

The equirectangular projection image is mapped on the sphere surface using Open Graphics Library for Embedded Systems (OpenGL ES) as illustrated in FIG. 4A. This results in generation of the spherical image CE as illustrated in FIG. 4B. In other words, the spherical image CE is represented as the equirectangular projection image EC, which corresponds to a surface facing a center of the sphere CS. It should be noted that OpenGL ES is a graphic library used for visualizing two-dimensional (2D) and three-dimensional (3D) data. The spherical image CE is either a still image or a moving image.

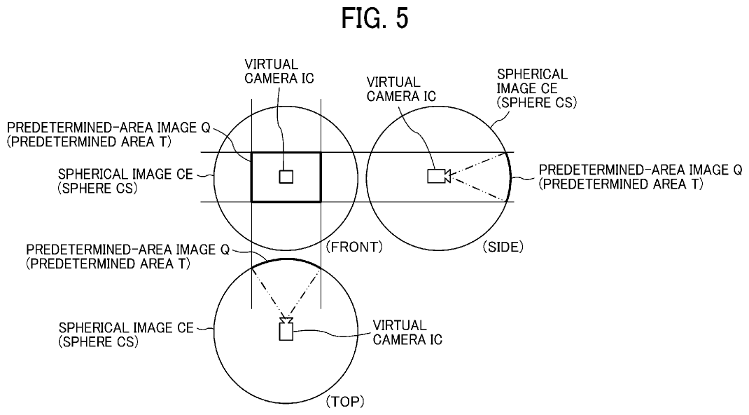

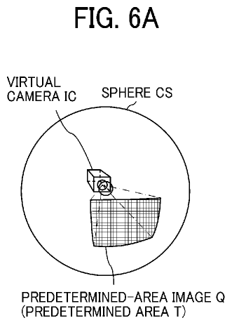

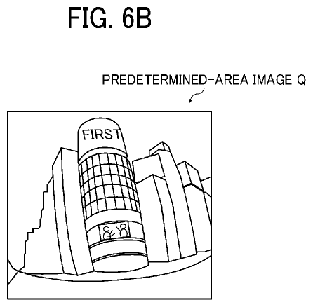

Since the spherical image CE is an image attached to the sphere surface, as illustrated in FIG. 4B, a part of the image may look distorted when viewed from the user, providing a feeling of strangeness. To resolve this strange feeling, an image of a predetermined area, which is a part of the spherical image CE, is displayed as a flat image having fewer curves. The predetermined area is, for example, a part of the spherical image CE that is viewable by the user. In this disclosure, the image of the predetermined area is referred to as a “predetermined-area image” Q. Hereinafter, a description is given of displaying the predetermined-area image Q with reference to FIG. 5 and FIGS. 6A and 6B.

FIG. 5 is a view illustrating positions of a virtual camera IC and a predetermined area T in a case in which the spherical image is represented as a surface area of a three-dimensional solid sphere. The virtual camera IC corresponds to a position of a point of view (viewpoint) of a user who is viewing the spherical image CE represented as a surface area of the three-dimensional solid sphere CS. FIG. 6A is a perspective view of the spherical image CE illustrated in FIG. 5. FIG. 6B is a view illustrating the predetermined-area image Q when displayed on a display. In FIG. 6A, the spherical image CE illustrated in FIG. 4B is represented as a surface area of the three-dimensional solid sphere CS. Assuming that the spherical image CE is a surface area of the solid sphere CS, the virtual camera IC is inside of the spherical image CE as illustrated in FIG. 5. The predetermined area T in the spherical image CE is an imaging area of the virtual camera IC. Specifically, the predetermined area T is specified by predetermined-area information indicating an imaging direction and an angle of view of the virtual camera IC in a three-dimensional virtual space containing the spherical image CE.

The predetermined-area image Q, which is an image of the predetermined area T illustrated in FIG. 6A, is displayed on a display as an image of an imaging area of the virtual camera IC, as illustrated in FIG. 6B. FIG. 6B illustrates the predetermined-area image Q represented by the predetermined-area information that is set by default. The following explains the position of the virtual camera IC, using an imaging direction (ea, aa) and an angle of view α of the virtual camera IC.

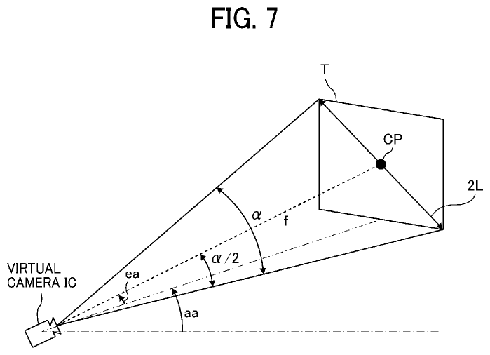

Referring to FIG. 7, a relation between the predetermined-area information and the image of the predetermined area T is described according to the embodiment. FIG. 7 is a view illustrating a relation between the predetermined-area information and the image of the predetermined area T. As illustrated in FIG. 7, “ea” denotes an elevation angle, “aa” denotes an azimuth angle, and “a” denotes an angle of view, respectively, of the virtual camera IC. The position of the virtual camera IC is adjusted, such that the point of gaze of the virtual camera IC, indicated by the imaging direction (ea, aa), matches the central point CP of the predetermined area T as the imaging area of the virtual camera IC. The predetermined-area image Q is an image of the predetermined area T, in the spherical image CE. “f” denotes a distance from the virtual camera IC to the central point CP of the predetermined area T. “L” denotes a distance between the central point CP and a given vertex of the predetermined area T (2L is a diagonal line). In FIG. 7, a trigonometric function equation generally expressed by the following Equation 1 is satisfied.

L/f=tan(α/2) (Equation 1)

### First Embodiment

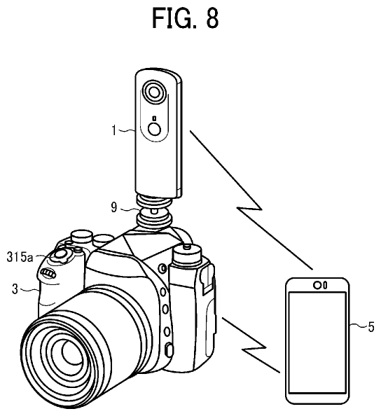

Referring to FIGS. 8 to 30D, the image capturing system according to a first embodiment of the present invention is described.

<Overview of Image Capturing System>

First, referring to FIG. 8, an overview of the image capturing system is described according to the first embodiment. FIG. 8 is a schematic diagram illustrating a configuration of the image capturing system according to the embodiment.

As illustrated in FIG. 8, the image capturing system includes the special image capturing device 1, a general-purpose (generic) capturing device 3, a smart phone 5, and an adapter 9. The special image capturing device 1 is connected to the generic image capturing device 3 via the adapter 9.

The special image capturing device 1 is a special digital camera, which captures an image of an object or surroundings such as scenery to obtain two hemispherical images, from which a spherical (such as panoramic) image is generated, as described above referring to FIGS. 1 to 7.

The generic image capturing device 3 is a digital single-lens reflex camera, however, it may be implemented as a compact digital camera. The generic image capturing device 3 is provided with a shutter button 315a, which is a part of an operation unit 315 described below.

The smart phone 5 is wirelessly communicable with the special image capturing device 1 and the generic image capturing device 3 using near-distance wireless communication, such as Wi-Fi, Bluetooth (Registered Trademark), and Near Field Communication (NFC). The smart phone 5 is capable of displaying the images obtained respectively from the special image capturing device 1 and the generic image capturing device 3, on a display 517 provided for the smart phone 5 as described below.

The smart phone 5 may communicate with the special image capturing device 1 and the generic image capturing device 3, without using the near-distance wireless communication, but using wired communication such as a cable. The smart phone 5 is an example of an image processing apparatus capable of processing images being captured. Other examples of the image processing apparatus include, but not limited to, a tablet personal computer (PC), a note PC, and a desktop PC. The smart phone 5 may operate as a communication terminal described below.

FIG. 9 is a perspective view illustrating the adapter 9 according to the embodiment. As illustrated in FIG. 9, the adapter 9 includes a shoe adapter 901, a bolt 902, an upper adjuster 903, and a lower adjuster 904. The shoe adapter 901 is attached to an accessory shoe of the generic image capturing device 3 as it slides. The bolt 902 is provided at a center of the shoe adapter 901, which is to be screwed into the tripod mount hole 151 of the special image capturing device 1. The bolt 902 is provided with the upper adjuster 903 and the lower adjuster 904, each of which is rotatable around the central axis of the bolt 902. The upper adjuster 903 secures the object attached with the bolt 902 (such as the special image capturing device 1). The lower adjuster 904 secures the object attached with the shoe adapter 901 (such as the generic image capturing device 3).

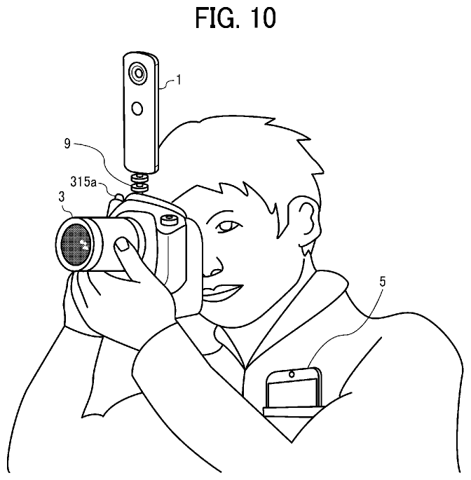

FIG. 10 illustrates how a user uses the image capturing device, according to the embodiment. As illustrated in FIG. 10, the user puts his or her smart phone 5 into his or her pocket. The user captures an image of an object using the generic image capturing device 3 to which the special image capturing device 1 is attached by the adapter 9. While the smart phone 5 is placed in the pocket of the user's shirt, the smart phone 5 may be placed in any area as long as it is wirelessly communicable with the special image capturing device 1 and the generic image capturing device 3.

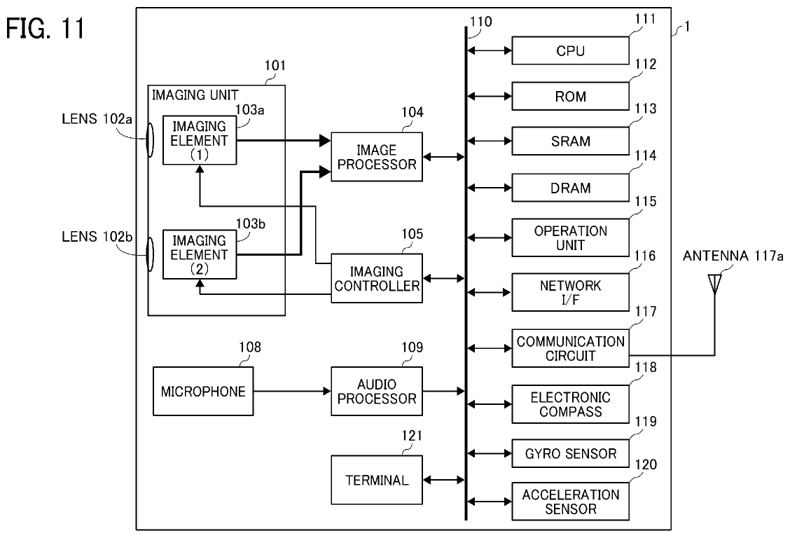

Next, referring to FIGS. 11 to 13, hardware configurations of the special image capturing device 1, generic image capturing device 3, and smart phone 5 are described according to the embodiment.

<Hardware Configuration of Special Image Capturing Device>

First, referring to FIG. 11, a hardware configuration of the special image capturing device 1 is described according to the embodiment. FIG. 11 illustrates the hardware configuration of the special image capturing device 1. The following describes a case in which the special image capturing device 1 is a spherical (such as omnidirectional) image capturing device having two imaging elements. However, the special image capturing device 1 may include any suitable number of imaging elements, providing that it includes at least two imaging elements. In addition, the special image capturing device 1 is not necessarily an image capturing device dedicated to omnidirectional image capturing. Alternatively, an external omnidirectional image capturing unit may be attached to a general-purpose digital camera or a smartphone to implement an image capturing device having substantially the same function as that of the special image capturing device 1.

As illustrated in FIG. 11, the special image capturing device 1 includes an imaging unit 101, an image processor 104, an imaging controller 105, a microphone 108, an audio processor 109, a central processing unit (CPU) 111, a read only memory (ROM) 112, a static random access memory (SRAM) 113, a dynamic random access memory (DRAM) 114, the operation unit 115, a network interface (I/F) 116, a communication circuit 117, an antenna 117a, an electronic compass 118, a gyro sensor 119, an acceleration sensor 120, and a Micro USB terminal 121.

The imaging unit 101 includes two wide-angle lenses (so-called fish-eye lenses) 102a and 102b, each having an angle of view of equal to or greater than 180 degrees so as to form a hemispherical image. The imaging unit 101 further includes the two imaging elements 103a and 103b corresponding to the wide-angle lenses 102a and 102b respectively. The imaging elements 103a and 103b each includes an imaging sensor such as a complementary metal oxide semiconductor (CMOS) sensor and a charge-coupled device (CCD) sensor, a timing generation circuit, and a group of registers. The imaging sensor converts an optical image formed by the wide-angle lenses 102a and 102b into electric signals to output image data. The timing generation circuit generates horizontal or vertical synchronization signals, pixel clocks and the like for the imaging sensor. Various commands, parameters and the like for operations of the imaging elements 103a and 103b are set in the group of registers.

Each of the imaging elements 103a and 103b of the imaging unit 101 is connected to the image processor 104 via a parallel I/F bus. In addition, each of the imaging elements 103a and 103b of the imaging unit 101 is connected to the imaging controller 105 via a serial I/F bus such as an I2C bus. The image processor 104, the imaging controller 105, and the audio processor 109 are each connected to the CPU 111 via a bus 110. Furthermore, the ROM 112, the SRAM 113, the DRAM 114, the operation unit 115, the network I/F 116, the communication circuit 117, and the electronic compass 118 are also connected to the bus 110.

The image processor 104 acquires image data from each of the imaging elements 103a and 103b via the parallel I/F bus and performs predetermined processing on each image data. Thereafter, the image processor 104 combines these image data to generate data of the equirectangular projection image as illustrated in FIG. 3C.

The imaging controller 105 usually functions as a master device while the imaging elements 103a and 103b each usually functions as a slave device. The imaging controller 105 sets commands and the like in the group of registers of the imaging elements 103a and 103b via the serial I/F bus such as the I2C bus. The imaging controller 105 receives various commands from the CPU 111. Further, the imaging controller 105 acquires status data and the like of the group of registers of the imaging elements 103a and 103b via the serial I/F bus such as the I2C bus. The imaging controller 105 sends the acquired status data and the like to the CPU 111.

The imaging controller 105 instructs the imaging elements 103a and 103b to output the image data at a time when the shutter button 115a of the operation unit 115 is pressed. In some cases, the special image capturing device 1 is capable of displaying a preview image on a display (e.g., the display of the smart phone 5) or displaying a moving image (movie). In case of displaying movie, the image data are continuously output from the imaging elements 103a and 103b at a predetermined frame rate (frames per minute).

Furthermore, the imaging controller 105 operates in cooperation with the CPU 111 to synchronize the time when the imaging element 103a outputs image data and the time when the imaging element 103b outputs the image data. It should be noted that, although the special image capturing device 1 does not include a display in this embodiment, the special image capturing device 1 may include the display.

The microphone 108 converts sounds to audio data (signal). The audio processor 109 acquires the audio data output from the microphone 108 via an I/F bus and performs predetermined processing on the audio data.

The CPU 111 controls entire operation of the special image capturing device 1, for example, by performing predetermined processing. The ROM 112 stores various programs for execution by the CPU 111. The SRAM 113 and the DRAM 114 each operates as a work memory to store programs loaded from the ROM 112 for execution by the CPU 111 or data in current processing. More specifically, in one example, the DRAM 114 stores image data currently processed by the image processor 104 and data of the equirectangular projection image on which processing has been performed.

The operation unit 115 collectively refers to various operation keys, such as the shutter button 115a. In addition to the hardware keys, the operation unit 115 may also include a touch panel. The user operates the operation unit 115 to input various image capturing (photographing) modes or image capturing (photographing) conditions.

The network I/F 116 collectively refers to an interface circuit such as a USB I/F that allows the special image capturing device 1 to communicate data with an external medium such as an SD card or an external personal computer. The network I/F 116 supports at least one of wired and wireless communications. The data of the equirectangular projection image, which is stored in the DRAM 114, is stored in the external medium via the network I/F 116 or transmitted to the external device such as the smart phone 5 via the network I/F 116, at any desired time.

The communication circuit 117 communicates data with the external device such as the smart phone 5 via the antenna 117a of the special image capturing device 1 by near-distance wireless communication such as Wi-Fi, NFC, and Bluetooth. The communication circuit 117 is also capable of transmitting the data of equirectangular projection image to the external device such as the smart phone 5.

The electronic compass 118 calculates an orientation of the special image capturing device 1 from the Earth's magnetism to output orientation information. This orientation information is an example of related information, which is metadata described in compliance with Exif. This information is used for image processing such as image correction of captured images. The related information also includes a date and time when the image is captured by the special image capturing device 1, and a size of the image data.

The gyro sensor 119 detects the change in tilt of the special image capturing device 1 (roll, pitch, yaw) with movement of the special image capturing device 1. The change in angle is one example of related information (metadata) described in compliance with Exif. This information is used for image processing such as image correction of captured images.

The acceleration sensor 120 detects acceleration in three axial directions. The position (an angle with respect to the direction of gravity) of the special image capturing device 1 is determined, based on the detected acceleration. With the gyro sensor 119 and the acceleration sensor 120, accuracy in image correction improves.
The Micro USB terminal 121 is a connector to be connected with such as a Micro USB cable, or other electronic device.

<Hardware Configuration of Generic Image Capturing Device>

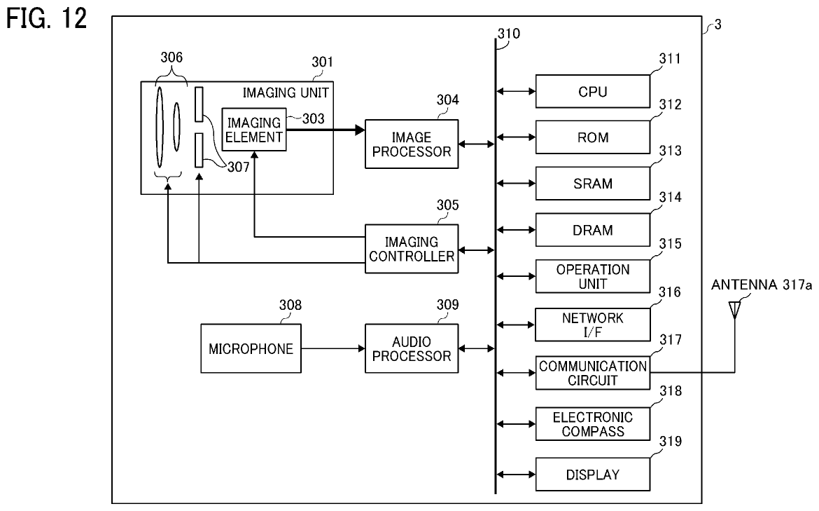

Next, referring to FIG. 12, a hardware configuration of the generic image capturing device 3 is described according to the embodiment. FIG. 12 illustrates the hardware configuration of the generic image capturing device 3. As illustrated in FIG. 12, the generic image capturing device 3 includes an imaging unit 301, an image processor 304, an imaging controller 305, a microphone 308, an audio processor 309, a bus 310, a CPU 311, a ROM 312, a SRAM 313, a DRAM 314, an operation unit 315, a network I/F 316, a communication circuit 317, an antenna 317a, an electronic compass 318, and a display 319. The image processor 304 and the imaging controller 305 are each connected to the CPU 311 via the bus 310.

The elements 304, 310, 311, 312, 313, 314, 315, 316, 317, 317a, and 318 of the generic image capturing device 3 are substantially similar in structure and function to the elements 104, 110, 111, 112, 113, 114, 115, 116, 117, 117a, and 118 of the special image capturing device 1, such that the description thereof is omitted.

Further, as illustrated in FIG. 12, in the imaging unit 301 of the generic image capturing device 3, a lens unit 306 having a plurality of lenses, a mechanical shutter button 307, and the imaging element 303 are disposed in this order from a side facing the outside (that is, a side to face the object to be captured).

The imaging controller 305 is substantially similar in structure and function to the imaging controller 105. The imaging controller 305 further controls operation of the lens unit 306 and the mechanical shutter button 307, according to user operation input through the operation unit 315.

The display 319 is capable of displaying an operational menu, an image being captured, or an image that has been captured, etc.

<Hardware Configuration of Smart Phone>

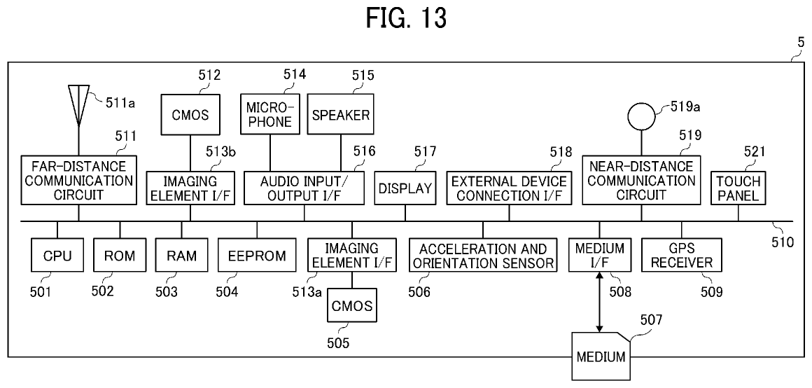

Referring to FIG. 13, a hardware configuration of the smart phone 5 is described according to the embodiment. FIG. 13 illustrates the hardware configuration of the smart phone 5. As illustrated in FIG. 13, the smart phone 5 includes a CPU 501, a ROM 502, a RAM 503, an EEPROM 504, a Complementary Metal Oxide Semiconductor (CMOS) sensor 505, an imaging element I/F 513a, an acceleration and orientation sensor 506, a medium I/F 508, and a GPS receiver 509.

The CPU 501 controls entire operation of the smart phone 5. The ROM 502 stores a control program for controlling the CPU 501 such as an IPL. The RAM 503 is used as a work area for the CPU 501. The EEPROM 504 reads or writes various data such as a control program for the smart phone 5 under control of the CPU 501. The CMOS sensor 505 captures an object (for example, the user operating the smart phone 5) under control of the CPU 501 to obtain captured image data. The imaging element 1/F 513a is a circuit that controls driving of the CMOS sensor 512. The acceleration and orientation sensor 506 includes various sensors such as an electromagnetic compass for detecting geomagnetism, a gyrocompass, and an acceleration sensor. The medium I/F 508 controls reading or writing of data with respect to a recording medium 507 such as a flash memory. The GPS receiver 509 receives a GPS signal from a GPS satellite.

The smart phone 5 further includes a far-distance communication circuit 511, an antenna 511a for the far-distance communication circuit 511, a CMOS sensor 512, an imaging element I/F 513b, a microphone 514, a speaker 515, an audio input/output I/F 516, a display 517, an external device connection I/F 518, a near-distance communication circuit 519, an antenna 519a for the near-distance communication circuit 519, and a touch panel 521.

The far-distance communication circuit 511 is a circuit that communicates with other device through the communication network 100. The CMOS sensor 512 is an example of a built-in imaging device capable of capturing a subject under control of the CPU 501. The imaging element 1/F 513b is a circuit that controls driving of the CMOS sensor 512. The microphone 514 is an example of built-in audio collecting device capable of inputting audio under control of the CPU 501. The audio I/O I/F 516 is a circuit for inputting or outputting an audio signal between the microphone 514 and the speaker 515 under control of the CPU 501. The display 517 may be a liquid crystal or organic electro luminescence (EL) display that displays an image of a subject, an operation icon, or the like. The external device connection I/F 518 is an interface circuit that connects the smart phone 5 to various external devices. The near-distance communication circuit 519 is a communication circuit that communicates in compliance with the Wi-Fi, NFC, Bluetooth, and the like. The touch panel 521 is an example of input device that enables the user to input a user instruction through touching a screen of the display 517.

The smart phone 5 further includes a bus line 510. Examples of the bus line 510 include an address bus and a data bus, which electrically connects the elements such as the CPU 501.

It should be noted that a recording medium such as a CD-ROM or HD storing any of the above-described programs may be distributed domestically or overseas as a program product.

<Functional Configuration of Image Capturing System>

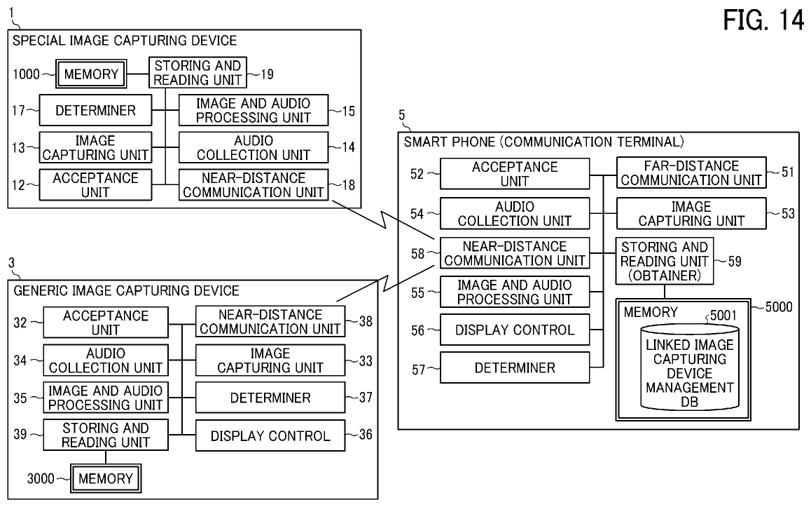

Referring now to FIGS. 11 to 14, a functional configuration of the image capturing system is described according to the embodiment. FIG. 14 is a schematic block diagram illustrating functional configurations of the special image capturing device 1, generic image capturing device 3, and smart phone 5, in the image capturing system, according to the embodiment.

<Functional Configuration of Special Image Capturing Device>

Referring to FIGS. 11 and 14, a functional configuration of the special image capturing device 1 is described according to the embodiment. As illustrated in FIG. 14, the special image capturing device 1 includes an acceptance unit 12, an image capturing unit 13, an audio collection unit 14, an image and audio processing unit 15, a determiner 17, a near-distance communication unit 18, and a storing and reading unit 19. These units are functions that are implemented by or that are caused to function by operating any of the elements illustrated in FIG. 11 in cooperation with the instructions of the CPU 111 according to the special image capturing device control program expanded from the SRAM 113 to the DRAM 114.

The special image capturing device 1 further includes a memory 1000, which is implemented by the ROM 112, the SRAM 113, and the DRAM 114 illustrated in FIG. 11.

Still referring to FIGS. 11 and 14, each functional unit of the special image capturing device 1 is described according to the embodiment.

The acceptance unit 12 of the special image capturing device 1 is implemented by the operation unit 115 illustrated in FIG. 11, which operates under control of the CPU 111. The acceptance unit 12 receives an instruction input from the operation unit 115 according to a user operation.

The image capturing unit 13 is implemented by the imaging unit 101, the image processor 104, and the imaging controller 105, illustrated in FIG. 11, each operating under control of the CPU 111. The image capturing unit 13 captures an image of the object or surroundings to obtain captured image data. As the captured image data, the two hemispherical images, from which the spherical image is generated, are obtained as illustrated in FIGS. 3A and 3B.

The audio collection unit 14 is implemented by the microphone 108 and the audio processor 109 illustrated in FIG. 11, each of which operates under control of the CPU 111. The audio collection unit 14 collects sounds around the special image capturing device 1.

The image and audio processing unit 15 is implemented by the instructions of the CPU 111, illustrated in FIG. 11. The image and audio processing unit 15 applies image processing to the captured image data obtained by the image capturing unit 13. The image and audio processing unit 15 applies audio processing to audio obtained by the audio collection unit 14. For example, the image and audio processing unit 15 generates data of the equirectangular projection image (FIG. 3C), using two hemispherical images (FIGS. 3A and 3B) respectively obtained by the imaging elements 103a and 103b.

The determiner 17, which is implemented by instructions of the CPU 111, performs various determinations.

The near-distance communication unit 18, which is implemented by instructions of the CPU 111, and the communication circuit 117 with the antenna 117a, communicates data with a near-distance communication unit 58 of the smart phone 5 using the near-distance wireless communication in compliance with such as Wi-Fi.

The storing and reading unit 19, which is implemented by instructions of the CPU 111 illustrated in FIG. 11, stores various data or information in the memory 1000 or reads out various data or information from the memory 1000.

<Functional Configuration of Generic Image Capturing Device>

Next, referring to FIGS. 12 and 14, a functional configuration of the generic image capturing device 3 is described according to the embodiment. As illustrated in FIG. 14, the generic image capturing device 3 includes an acceptance unit 32, an image capturing unit 33, an audio collection unit 34, an image and audio processing unit 35, a display control 36, a determiner 37, a near-distance communication unit 38, and a storing and reading unit 39. These units are functions that are implemented by or that are caused to function by operating any of the elements illustrated in FIG. 12 in cooperation with the instructions of the CPU 311 according to the image capturing device control program expanded from the SRAM 313 to the DRAM 314.

The generic image capturing device 3 further includes a memory 3000, which is implemented by the ROM 312, the SRAM 313, and the DRAM 314 illustrated in FIG. 12.

The acceptance unit 32 of the generic image capturing device 3 is implemented by the operation unit 315 illustrated in FIG. 12, which operates under control of the CPU 311. The acceptance unit 32 receives an instruction input from the operation unit 315 according to a user operation.

The image capturing unit 33 is implemented by the imaging unit 301, the image processor 304, and the imaging controller 305, illustrated in FIG. 12, each of which operates under control of the CPU 311. The image capturing unit 13 captures an image of the object or surroundings to obtain captured image data. In this example, the captured image data is planar image data, captured with a perspective projection method.

The audio collection unit 34 is implemented by the microphone 308 and the audio processor 309 illustrated in FIG. 12, each of which operates under control of the CPU 311. The audio collection unit 34 collects sounds around the generic image capturing device 3.

The image and audio processing unit 35 is implemented by the instructions of the CPU 311, illustrated in FIG. 12. The image and audio processing unit 35 applies image processing to the captured image data obtained by the image capturing unit 33. The image and audio processing unit 35 applies audio processing to audio obtained by the audio collection unit 34.

The display control 36, which is implemented by the instructions of the CPU 311 illustrated in FIG. 12, controls the display 319 to display a planar image P based on the captured image data that is being captured or that has been captured.

The determiner 37, which is implemented by instructions of the CPU 311, performs various determinations. For example, the determiner 37 determines whether the shutter button 315a has been pressed by the user.

The near-distance communication unit 38, which is implemented by instructions of the CPU 311, and the communication circuit 317 with the antenna 317a, communicates data with the near-distance communication unit 58 of the smart phone 5 using the near-distance wireless communication in compliance with such as Wi-Fi.

The storing and reading unit 39, which is implemented by instructions of the CPU 311 illustrated in FIG. 12, stores various data or information in the memory 3000 or reads out various data or information from the memory 3000.

<Functional Configuration of Smart Phone>

Referring now to FIGS. 13 to 16, a functional configuration of the smart phone 5 is described according to the embodiment. As illustrated in FIG. 14, the smart phone 5 includes a far-distance communication unit 51, an acceptance unit 52, an image capturing unit 53, an audio collection unit 54, an image and audio processing unit 55, a display control 56, a determiner 57, the near-distance communication unit 58, and a storing and reading unit 59. These units are functions that are implemented by or that are caused to function by operating any of the hardware elements illustrated in FIG. 13 in cooperation with the instructions of the CPU 501 according to the control program for the smart phone 5, expanded from the EEPROM 504 to the RAM 503.

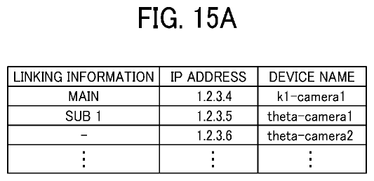

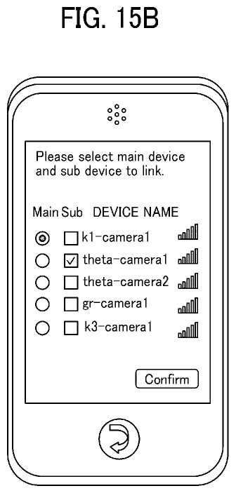

The smart phone 5 further includes a memory 5000, which is implemented by the ROM 502, RAM 503 and EEPROM 504 illustrated in FIG. 13. The memory 5000 stores a linked image capturing device management DB 5001. The linked image capturing device management DB S001 is implemented by a linked image capturing device management table illustrated in FIG. 15A. FIG. 15A is a conceptual diagram illustrating the linked image capturing device management table, according to the embodiment.

Referring now to FIG. 15A, the linked image capturing device management table is described according to the embodiment. As illustrated in FIG. 15A, the linked image capturing device management table stores, for each image capturing device, linking information indicating a relation to the linked image capturing device, an IP address of the image capturing device, and a device name of the image capturing device, in association with one another. The linking information indicates whether the image capturing device is “main” device or “sub” device in performing the linking function. The image capturing device as the “main” device, starts capturing the image in response to pressing of the shutter button provided for that device. The image capturing device as the “sub” device, starts capturing the image in response to pressing of the shutter button provided for the “main” device. The IP address is one example of destination information of the image capturing device. The IP address is used in case the image capturing device communicates using Wi-Fi. Alternatively, a manufacturer's identification (ID) or a product ID may be used in case the image capturing device communicates using a wired USB cable. Alternatively, a Bluetooth Device (BD) address is used in case the image capturing device communicates using wireless communication such as Bluetooth.

The far-distance communication unit 51 of the smart phone 5 is implemented by the far-distance communication circuit 511 that operates under control of the CPU 501, illustrated in FIG. 13, to transmit or receive various data or information to or from other device (for example, other smart phone or server) through a communication network such as the Internet.

The acceptance unit 52 is implement by the touch panel 521, which operates under control of the CPU 501, to receive various selections or inputs from the user. While the touch panel 521 is provided separately from the display 517 in FIG. 13, the display 517 and the touch panel 521 may be integrated as one device. Further, the smart phone 5 may include any hardware key, such as a button, to receive the user instruction, in addition to the touch panel 521.

The image capturing unit 53 is implemented by the CMOS sensors 505 and 512, which operate under control of the CPU 501, illustrated in FIG. 13. The image capturing unit 13 captures an image of the object or surroundings to obtain captured image data.

In this example, the captured image data is planar image data, captured with a perspective projection method.

The audio collection unit 54 is implemented by the microphone 514 that operates under control of the CPU 501. The audio collecting unit 14a collects sounds around the smart phone 5.

The image and audio processing unit 55 is implemented by the instructions of the CPU 501, illustrated in FIG. 13. The image and audio processing unit 55 applies image processing to an image of the object that has been captured by the image capturing unit 53. The image and audio processing unit 15 applies audio processing to audio obtained by the audio collection unit 54.

The display control 56, which is implemented by the instructions of the CPU 501 illustrated in FIG. 13, controls the display 517 to display the planar image P based on the captured image data that is being captured or that has been captured by the image capturing unit 53. The display control 56 superimposes the planar image P, on the spherical image CE, using superimposed display metadata, generated by the image and audio processing unit 55. With the superimposed display metadata, each grid area LAO of the planar image P is placed at a location indicated by a location parameter, and is adjusted to have a brightness value and a color value indicated by a correction parameter.

In this example, the location parameter is one example of location information. The correction parameter is one example of correction information.

The determiner 57 is implemented by the instructions of the CPU 501, illustrated in FIG. 13, to perform various determinations.

The near-distance communication unit 58, which is implemented by instructions of the CPU 501, and the near-distance communication circuit 519 with the antenna 519a, communicates data with the near-distance communication unit 18 of the special image capturing device 1, and the near-distance communication unit 38 of the generic image capturing device 3, using the near-distance wireless communication in compliance with such as Wi-Fi.

The storing and reading unit 59, which is implemented by instructions of the CPU 501 illustrated in FIG. 13, stores various data or information in the memory S000 or reads out various data or information from the memory 5000. For example, the superimposed display metadata may be stored in the memory 5000. In this embodiment, the storing and reading unit 59 functions as an obtainer that obtains various data from the memory 5000.

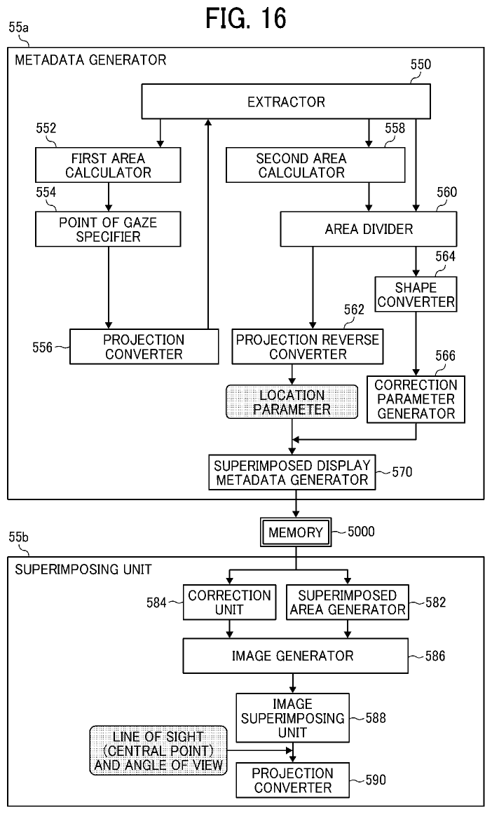

Referring to FIG. 16, a functional configuration of the image and audio processing unit 55 is described according to the embodiment. FIG. 16 is a block diagram illustrating the functional configuration of the image and audio processing unit 55 according to the embodiment.

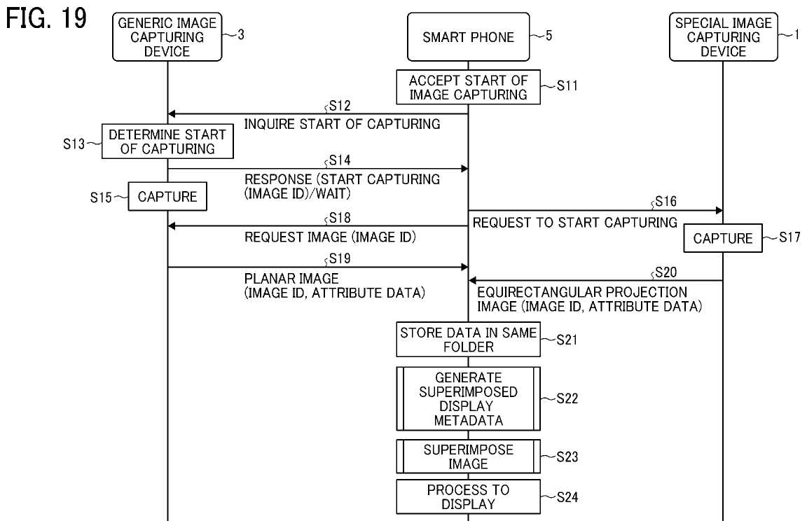

The image and audio processing unit 55 mainly includes a metadata generator 55a that performs encoding, and a superimposing unit 55b that performs decoding. In this example, the encoding corresponds to processing to generate metadata to be used for superimposing images for display (“superimposed display metadata”). Further, in this example, the decoding corresponds to processing to generate images for display using the superimposed display metadata. The metadata generator 55a performs processing of S22, which is processing to generate superimposed display metadata, as illustrated in FIG. 19. The superimposing unit 55b performs processing of S23, which is processing to superimpose the images using the superimposed display metadata, as illustrated in FIG. 19.

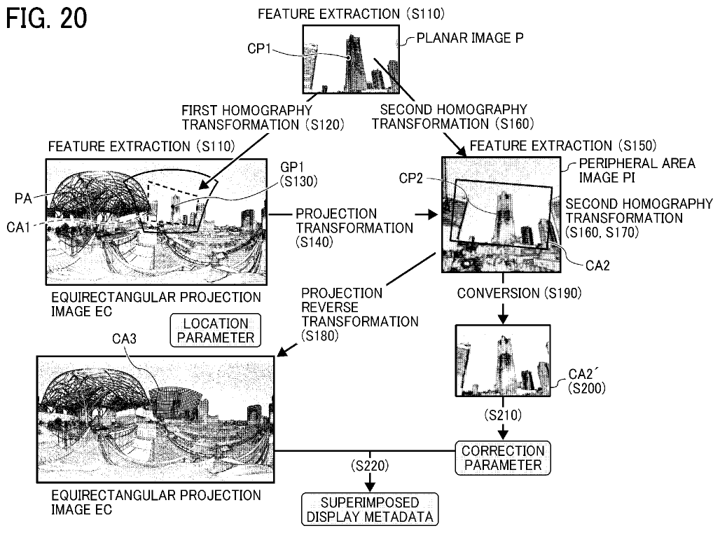

First, a functional configuration of the metadata generator 55a is described according to the embodiment. The metadata generator 55a includes an extractor 550, a first area calculator 552, a point of gaze specifier 554, a projection converter 556, a second area calculator 558, an area divider 560, a projection reverse converter 562, a shape converter 564, a correction parameter generator 566, and a superimposed display metadata generator 570. In case the brightness and color is not to be corrected, the shape converter 564 and the correction parameter generator 566 do not have to be provided. FIG. 20 is a conceptual diagram illustrating operation of generating the superimposed display metadata, with images processed or generated in such operation.

The extractor 550 extracts feature points according to local features of each of two images having the same object. The feature points are distinctive keypoints in both images. The local features correspond to a pattern or structure detected in the image such as an edge or blob. In this embodiment, the extractor 550 extracts the features points for each of two images that are different from each other. These two images to be processed by the extractor 550 may be the images that have been generated using different image projection methods. Unless the difference in projection methods cause highly distorted images, any desired image projection methods may be used. For example, referring to FIG. 20, the extractor 550 extracts feature points from the rectangular, equirectangular projection image EC in equirectangular projection (S110), and the rectangular, planar image P in perspective projection (S110), based on local features of each of these images including the same object. Further, the extractor 550 extracts feature points from the rectangular, planar image P (S110), and a peripheral area image PI converted by the projection converter 556 (S150), based on local features of each of these images having the same object. In this embodiment, the equirectangular projection method is one example of a first projection method, and the perspective projection method is one example of a second projection method. The equirectangular projection image is one example of the first projection image, and the planar image P is one example of the second projection image.

The first area calculator 552 calculates the feature value fv1 based on the plurality of feature points fp1 in the equirectangular projection image EC. The first area calculator 552 further calculates the feature value fv2 based on the plurality of feature points fp2 in the planar image P. The feature values, or feature points, may be detected in any desired method. However, it is desirable that feature values, or feature points, are invariant or robust to changes in scale or image rotation. The first area calculator 552 specifies corresponding points between the images, based on similarity between the feature value fv1 of the feature points fp1 in the equirectangular projection image EC, and the feature value fv2 of the feature points fp2 in the planar image P. Based on the corresponding points between the images, the first area calculator 552 calculates the homography for transformation between the equirectangular projection image EC and the planar image P. The first area calculator 552 then applies first homography transformation to the planar image P (S120). Accordingly, the first area calculator 552 obtains a first corresponding area CA1 (“first area CA1”), in the equirectangular projection image EC, which corresponds to the planar image P. In such case, a central point CP1 of a rectangle defined by four vertices of the planar image P, is converted to the point of gaze GP1 in the equirectangular projection image EC, by the first homography transformation.

Here, the coordinates of four vertices p1, p2, p3, and p4 of the planar image P are p1=(x1, y1), p2=(x2, y2), p3=(x3, y3), and p4=(x4, y4). The first area calculator 552 calculates the central point CP1 (x, y) using the equation 2 below.

S1={(x4−x2)*(y1−y2)−(y4−y2)*(x1−x2)}/2, S2={(x4−x2)*(y2−y3)−(y4-y2)*(x2−x3)}/2, x=x1+(x3−x1)*S1/(S1+S2), y=y1+(y3−y1)*S1/(S1+S2) (Equation 2)

While the planar image P is a rectangle in the case of FIG. 20, the central point CP1 may be calculated using the equation 2 with an intersection of diagonal lines of the planar image P, even when the planar image P is a square, trapezoid, or rhombus. When the planar image P has a shape of rectangle or square, the central point of the diagonal line may be set as the central point CP1. In such case, the central points of the diagonal lines of the vertices p1 and p3 are calculated, respectively, using the equation 3 below.

x=(x1+x3)/2, y=(y1+y3)/2 (Equation 3)

The point of gaze specifier 554 specifies the point (referred to as the point of gaze) in the equirectangular projection image EC, which corresponds to the central point CP1 of the planar image P after the first homography transformation (S130).

Here, the point of gaze GP1 is expressed as a coordinate on the equirectangular projection image EC. The coordinate of the point of gaze GP1 may be transformed to the latitude and longitude. Specifically, a coordinate in the vertical direction of the equirectangular projection image EC is expressed as a latitude in the range of −90 degree (−0.5π) to +90 degree (+0.5π). Further, a coordinate in the horizontal direction of the equirectangular projection image EC is expressed as a longitude in the range of −180 degree (−π) to +180 degree (+π). With this transformation, the coordinate of each pixel, according to the image size of the equirectangular projection image EC, can be calculated from the latitude and longitude system.

The projection converter 556 extracts a peripheral area PA, which is a part surrounding the point of gaze GP1, from the equirectangular projection image EC. The projection converter 556 converts the peripheral area PA, from the equirectangular projection to the perspective projection, to generate a peripheral area image PI (S140). The peripheral area PA is determined, such that, after projection transformation, the square-shaped, peripheral area image PI has a vertical angle of view (or a horizontal angle of view), which is the same as the diagonal angle of view α of the planar image P. Here, the central point CP2 of the peripheral area image PI corresponds to the point of gaze GP 1.

(Transformation of Projection)

The following describes transformation of a projection, performed at S140 of FIG. 20, in detail. As described above referring to FIGS. 3 to 5, the equirectangular projection image EC covers a surface of the sphere CS, to generate the spherical panoramic image CE. Therefore, each pixel in the equirectangular projection image EC corresponds to each pixel in the surface of the sphere CS, that is, the three-dimensional, spherical image. The projection converter 556 applies the following transformation equation. Here, the coordinate system used for the equirectangular projection image EC is expressed with (latitude, longitude)=(ea, aa), and the rectangular coordinate system used for the three-dimensional sphere CS is expressed with (x, y, z).

(x,y,z)=(cos(ea)×cos(aa), cos(ea)×sin(aa), sin(ea)), (Equation 4)

wherein the sphere CS has a radius of 1.

The planar image P in perspective projection, is a two-dimensional image. When the planar image P is represented by the two-dimensional polar coordinate system (moving radius, argument)=(r, a), the moving radius r, which corresponds to the diagonal angle of view α, has a value in the range from 0 to tan (diagonal angle view/2). That is, 0<=r<=tan(diagonal angle view/2). The planar image P, which is represented by the two-dimensional rectangular coordinate system (u, v), can be expressed using the polar coordinate system (moving radius, argument)=(r, a) using the following transformation equation 5.

u=r×cos(a),v=r×sin(a) (Equation 5)

The equation 5 is represented by the three-dimensional coordinate system (moving radius, polar angle, azimuth). For the surface of the sphere CS, the moving radius in the three-dimensional coordinate system is “1”. The equirectangular projection image, which covers the surface of the sphere CS, is converted from the equirectangular projection to the perspective projection, using the following equations 6 and 7. Here, the equirectangular projection image is represented by the above-described two-dimensional polar coordinate system (moving radius, azimuth)=(r, a), and the virtual camera IC is located at the center of the sphere.

r=tan(polar angle) (Equation 6)

a=azimuth Assuming that the polar angle is t, (Equation 7)

Equation 6 can be expressed as: t=arctan(r).

Accordingly, the three-dimensional polar coordinate (moving radius, polar angle, azimuth) is expressed as (1,arctan(r),a).

The three-dimensional polar coordinate system is transformed into the rectangle coordinate system (x, y, z), using Equation 8.

(x,y,z)=(sin(t)×cos(a), sin(t)×sin(a), cos(t)) (Equation 8)

Equation 8 is applied to convert between the equirectangular projection image EC in equirectangular projection, and the planar image P in perspective projection. More specifically, the moving radius r, which corresponds to the diagonal angle of view α of the planar image P, is used to calculate transformation map coordinates, which indicate correspondence of a location of each pixel between the planar image P and the equirectangular projection image EC. With this transformation map coordinates, the equirectangular projection image EC is transformed to generate the peripheral area image PI in perspective projection.

Through the above-described projection transformation, the coordinate (latitude=90°, longitude=0°) in the equirectangular projection image EC becomes the central point CP2 in the peripheral area image PI in perspective projection. In case of applying projection transformation to an arbitrary point in the equirectangular projection image EC as the point of gaze, the sphere CS covered with the equirectangular projection image EC is rotated such that the coordinate (latitude, longitude) of the point of gaze is positioned at (90°, 0°).

The sphere CS may be rotated using any known equation for rotating the coordinate.

(Determination of Peripheral Area Image)

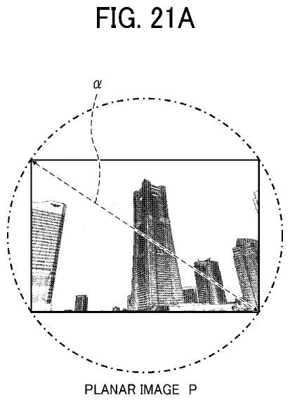

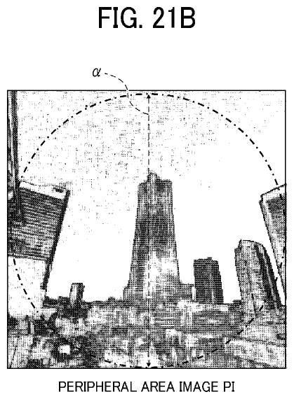

Next, referring to FIGS. 21A and 21B, determination of a peripheral area image P1 is described according to the embodiment. FIGS. 21A and 21B are conceptual diagrams for describing determination of the peripheral area image PI.

To enable the first area calculator 552 to determine correspondence between the planar image P and the peripheral area image PI, it is desirable that the peripheral area image PI is sufficiently large to include the entire second area CA2. If the peripheral area image PI has a large size, the second area CA2 is included in such large-size area image. With the large-size peripheral area image PI, however, the time required for processing increases as there are a large number of pixels subject to similarity calculation. For this reasons, the peripheral area image PI should be a minimum-size image area including at least the entire second area CA2. In this embodiment, the peripheral area image PI is determined as follows.

More specifically, the peripheral area image PI is determined using the 35 mm equivalent focal length of the planar image, which is obtained from the Exif data recorded when the image is captured. Since the 35 mm equivalent focal length is a focal length corresponding to the 24 mm×36 mm film size, it can be calculated from the diagonal and the focal length of the 24 mm×36 mm film, using Equations 9 and 10.

film diagonal=sqrt(24*24+36*36) (Equation 9)

angle of view of the image to be combined/2=arctan((film diagonal/2)/35 mm equivalent focal length of the image to be combined) (Equation 10)

The image with this angle of view has a circular shape. Since the actual imaging element (film) has a rectangular shape, the image taken with the imaging element is a rectangle that is inscribed in such circle. In this embodiment, the peripheral area image PI is determined such that, a vertical angle of view α of the peripheral area image PI is made equal to a diagonal angle of view α of the planar image P. That is, the peripheral area image PI illustrated in FIG. 21B is a rectangle, circumscribed around a circle containing the diagonal angle of view α of the planar image P illustrated in FIG. 21A. The vertical angle of view α is calculated from the diagonal angle of a square and the focal length of the planar image P, using Equations 11 and 12.

angle of view of square=sqrt(film diagonal*film diagonal+film diagonal*film diagonal) (Equation 11)

vertical angle of view α/2=arctan((angle of view of square/2)/35 mm equivalent focal length of planar image)) (Equation 12)

The calculated vertical angle of view α is used to obtain the peripheral area image PI in perspective projection, through projection transformation. The obtained peripheral area image PI at least contains an image having the diagonal angle of view α of the planar image P while centering on the point of gaze, but has the vertical angle of view α that is kept small as possible.

(Calculation of Location Information)

Referring back to FIGS. 16 and 20, the second area calculator 558 calculates the feature value fp2 of a plurality of feature points fp2 in the planar image P, and the feature value fp3 of a plurality of feature points fp3 in the peripheral area image PI. The second area calculator 558 specifies corresponding points between the images, based on similarity between the feature value fv2 and the feature value fv3. Based on the corresponding points between the images, the second area calculator 558 calculates the homography for transformation between the planar image P and the peripheral area image PI. The second area calculator 558 then applies second homography transformation to the planar image P (S160). Accordingly, the second area calculator 558 obtains a second (corresponding) area CA2 (“second area CA2”), in the peripheral area image PI, which corresponds to the planar image P (S170).

In the above-described transformation, in order to increase the calculation speed, an image size of at least one of the planar image P and the equirectangular projection image EC may be changed, before applying the first homography transformation. For example, assuming that the planar image P has 40 million pixels, and the equirectangular projection image EC has 30 million pixels, the planar image P may be reduced in size to 30 million pixels. Alternatively, both of the planar image P and the equirectangular projection image EC may be reduced in size to 10 million pixels. Similarly, an image size of at least one of the planar image P and the peripheral area image PI may be changed, before applying the second homography transformation.

The homography in this embodiment is a transformation matrix indicating the projection relation between the equirectangular projection image EC and the planar image P. The coordinate system for the planar image P is multiplied by the homography transformation matrix to convert into a corresponding coordinate system for the equirectangular projection image EC (spherical image CE).

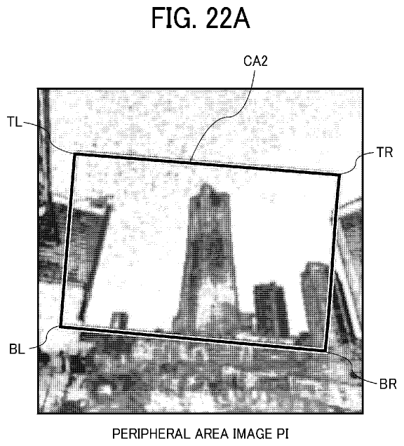

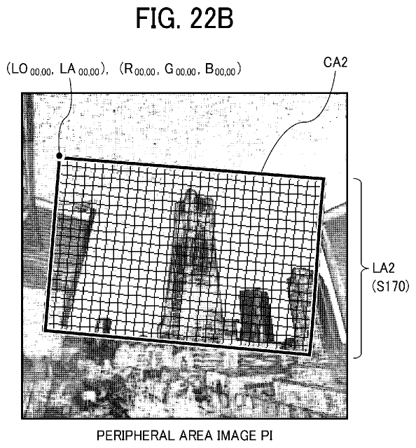

The area divider 560 divides a part of the image into a plurality of grid areas. Referring to FIGS. 22A and 22B, operation of dividing the second area CA2 into a plurality of grid areas is described according to the embodiment. FIGS. 22A and 22B illustrate conceptual diagrams for explaining operation of dividing the second area into a plurality of grid areas, according to the embodiment.

As illustrated in FIG. 22A, the second area CA2 is a rectangle defined by four vertices each obtained with the second homography transformation, by the second area calculator 558. As illustrated in FIG. 22B, the area divider 560 divides the second area CA2 into a plurality of grid areas LA2. For example, the second area CA2 is equally divided into 30 grid areas in the horizontal direction, and into 20 grid areas in the vertical direction.

Next, dividing the second area CA2 into the plurality of grid areas LA2 is explained in detail.

The second area CA2 is equally divided using the following equation. Assuming that a line connecting two points, A(X1, Y1) and B(X2, Y2), is to be equally divided into “n” coordinates, the coordinate of a point Pm that is the “m”th point counted from the point A is calculated using the equation 13.

Pm=(X1+(X2−X1)×m/n, Y1+(Y2−Y1)×m/n) (Equation 13)

With Equation 13, the line can be equally divided into a plurality of coordinates. The upper line and the lower line of the rectangle are each divided into a plurality of coordinates, to generate a plurality of lines connecting corresponding coordinates of the upper line and the lower line. The generated lines are each divided into a plurality of coordinates, to further generate a plurality of lines. Here, coordinates of points (vertices) of the upper left, upper right, lower right, and lower left of the rectangle are respectively represented by TL, TR, BR, and BL. The line connecting TL and TR, and the line connecting BR and BL are each equally divided into 30 coordinates (0 to 30th coordinates). Next, each of the lines connecting corresponding 0 to 30th coordinates of the TL-TR line and the BR-BL line, is equally divided into 20 coordinates. Accordingly, the rectangular area is divided into 30×20, sub-areas. FIG. 22B shows an example case of the coordinate (LO_{00,00}, LA_{00,00}) of the upper left point TL.

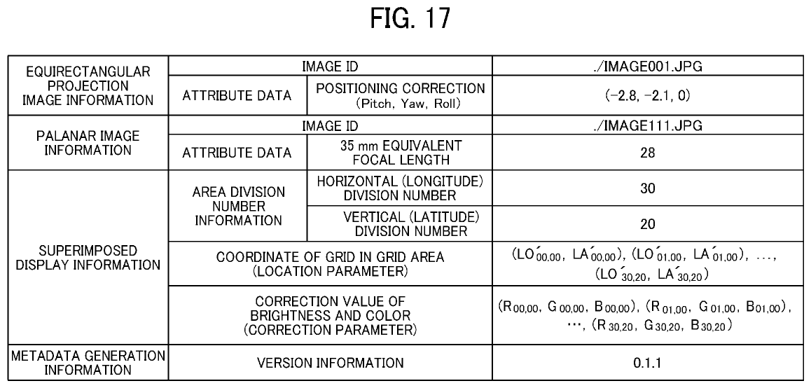

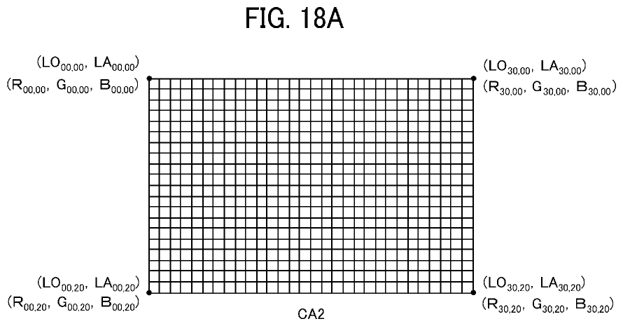

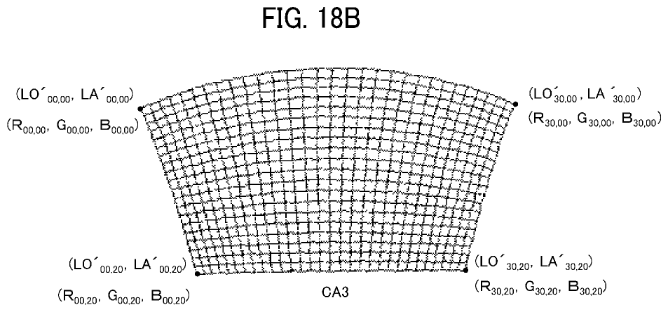

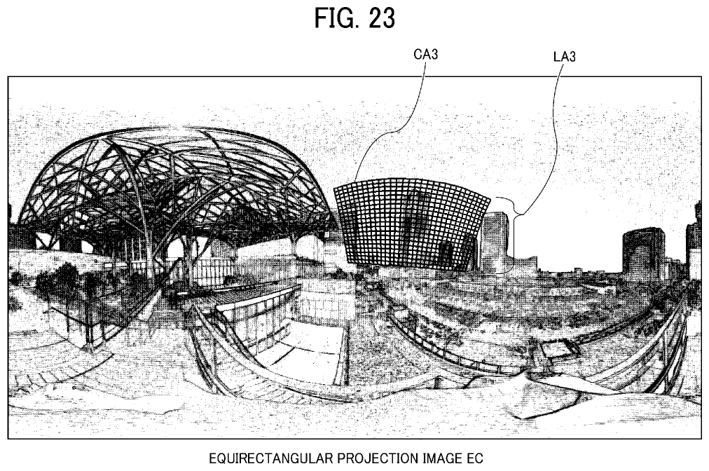

Referring back to FIGS. 16 and 20, the projection reverse converter 562 reversely converts projection applied to the second area CA2, back to the equirectangular projection applied to the equirectangular projection image EC. With this projection transformation, the third area CA3 in the equirectangular projection image EC, which corresponds to the second area CA2, is determined. Specifically, the projection reverse converter 562 determines the third area CA3 in the equirectangular projection image EC, which contains a plurality of grid areas LA3 corresponding to the plurality of grid areas LA2 in the second area CA2. FIG. 23 illustrates an enlarged view of the third area CA3 illustrated in FIG. 20. FIG. 23 is a conceptual diagram for explaining determination of the third area CA3 in the equirectangular projection image EC. The planar image P is superimposed on the spherical image CE, which is generated from the equirectangular projection image EC, so as to fit in a portion defined by the third area CA3 by mapping. Through processing by the projection reverse converter 562, a location parameter is generated, which indicates the coordinate of each grid in each grid area LA3. The location parameter is illustrated in FIG. 17 and FIG. 18B. In this example, the gird may be referred to as a single point of a plurality of points.

As described above, the location parameter is generated, which is used to calculate the correspondence of each pixel between the equirectangular projection image EC and the planar image P.

Although the planar image P is superimposed on the equirectangular projection image EC at a right location with the location parameter, these image EC and image P may vary in brightness or color (such as tone), causing an unnatural look. The shape converter 564 and the correction parameter generator 566 are provided to avoid this unnatural look, even when these images that differ in brightness and color, are partly superimposed one above the other.

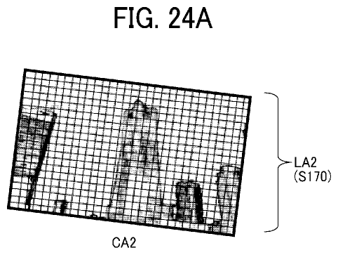

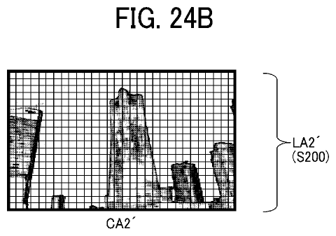

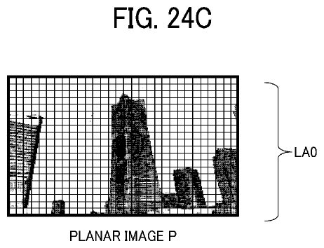

Before applying color correction, the shape converter 564 converts the second area CA2 to have a shape that is the same as the shape of the planar image P. To made the shape equal, the shape converter 564 maps four vertices of the second area CA2, on corresponding four vertices of the planar image P. More specifically, the shape of the second area CA2 is made equal to the shape of the planar image P, such that each grid area LA2 in the second area CA2 illustrated in FIG. 24A, is located at the same position of each grid area LAO in the planar image P illustrated in FIG. 24C. That is, a shape of the second area CA2 illustrated in FIG. 24A is converted to a shape of the second area CA2′ illustrated in FIG. 24B. As each grid area LA2 is converted to the corresponding grid area LA2′, the grid area LA2′ becomes equal in shape to the corresponding grid area LAO in the planar image P.

The correction parameter generator 566 generates the correction parameter, which is to be applied to each grid area LA2′ in the second area CA2′, such that each grid area LA2′ is equal to the corresponding grid area LAO in the planar image P in brightness and color. Specifically, the correction parameter generator 566 specifies four grid areas LAO that share one common grid, and calculates an average avg=(Rₐᵥₑ, Gₐᵥₑ, Bₐᵥₑ) of brightness and color values (R, G, B) of all pixels contained in the specified four grid areas LAO. Similarly, the correction parameter generator 566 specifies four grid areas LA2′ that share one common grid, and calculates an average avg′=(Rₐᵥₑ, Gₐᵥₑ, Bₐᵥₑ) of brightness and color values (R, G, B) of all pixels contained in the specified four grid areas LA2′. If one gird of the specified grid areas LAO and the corresponding grid of the specific grid areas LA2′ correspond to one of four vertices of the second area CA2 (or the third area CA3), the correction parameter generator 566 calculates the average avg and the average avg′ of the brightness and color of pixels from one grid area located at the corner. If one grid of the specific grid areas LAO and the corresponding grid of the specific grid areas LA2′ correspond to a gird of the outline of the second area CA2 (or the third area CA3), the correction parameter generator 566 calculates the average avg and the average avg′ of the brightness and color of pixels from two grid areas inside the outline. In this embodiment, the correction parameter is gain data for correcting the brightness and color of the planar image P. Accordingly, the correction parameter Pa is obtained by dividing the avg′ by the avg, as represented by the following equation 14.

Pa=avg′/avg (Equation 14)

In displaying images being superimposed, each grid area LAO is multiplied with the gain, represented by the correction parameter. Accordingly, the brightness and color of the planar image P is made substantially equal to that of the equirectangular projection image EC (spherical image CE). This prevents unnatural look, even when the planar image P is superimposed on the equirectangular projection image EC. In addition to or in alternative to the average value, the correction parameter may be calculated using the median or the most frequent value of brightness and color of pixels in the grid areas.

In this embodiment, the values (R, G, B) are used to calculate the brightness and color of each pixel. Alternatively, any other color space may be used to obtain the brightness and color, such as brightness and color difference using YUV, and brightness and color difference using sYCC(YCbCr) according to the JPEG. The color space may be converted from RGB, to YUV, or to sYCC (YCbCr), using any desired known method. For example, RGB, in compliance with JPEG file interchange format (JFIF), may be converted to YCbCr, using Equation 15.

$$( Equation 15 )$$

$$( \begin{matrix}Y \\ Cb \\ Cr\end{matrix} ) = ( \begin{matrix}0.299 & 0.587 & 0.114 \\ - 0.1687 & - 0.3313 & 0.5 \\ 0.5 & - 0.4187 & - 0.0813\end{matrix} ) ( \begin{matrix}R \\ G \\ B\end{matrix} ) + ( \begin{matrix}0 \\ 128 \\ 128\end{matrix} )$$

The superimposed display metadata generator 570 generates superimposed display metadata indicating a location where the planar image P is superimposed on the spherical image CE, and correction values for correcting brightness and color of pixels, using such as the location parameter and the correction parameter.

(Superimposed Display Metadata)

Referring to FIG. 17, a data structure of the superimposed display metadata is described according to the embodiment. FIG. 17 illustrates a data structure of the superimposed display metadata according to the embodiment.

As illustrated in FIG. 17, the superimposed display metadata includes equirectangular projection image information, planar image information, superimposed display information, and metadata generation information.

The equirectangular projection image information is transmitted from the special image capturing device 1, with the captured image data. The equirectangular projection image information includes an image identifier (image ID) and attribute data of the captured image data. The image identifier, included in the equirectangular projection image information, is used to identify the equirectangular projection image. While FIG. 17 uses an image file name as an example of image identifier, an image ID for uniquely identifying the image may be used instead.

The attribute data, included in the equirectangular projection image information, is any information related to the equirectangular projection image. In the case of metadata of FIG. 17, the attribute data includes positioning correction data (Pitch, Yaw, Roll) of the equirectangular projection image, which is obtained by the special image capturing device 1 in capturing the image. The positioning correction data is stored in compliance with a standard image recording format, such as Exchangeable image file format (Exif). Alternatively, the positioning correction data may be stored in any desired format defined by Google Photo Sphere schema (GPano). As long as an image is taken at the same place, the special image capturing device 1 captures the image in 360 degrees with any positioning. However, in displaying such spherical image CE, the positioning information and the center of image (point of gaze) should be specified. Generally, the spherical image CE is corrected for display, such that its zenith is right above the user capturing the image. With this correction, a horizontal line is displayed as a straight line, thus the displayed image have more natural look.

The planar image information is transmitted from the generic image capturing device 3 with the captured image data. The planar image information includes an image identifier (image ID) and attribute data of the captured image data. The image identifier, included in the planar image information, is used to identify the planar image P. While FIG. 17 uses an image file name as an example of image identifier, an image ID for uniquely identifying the image may be used instead.

The attribute data, included in the planar image information, is any information related to the planar image P. In the case of metadata of FIG. 17, the planar image information includes, as attribute data, a value of 35 mm equivalent focal length. The value of 35 mm equivalent focal length is not necessary to display the image on which the planar image P is superimposed on the spherical image CE. However, the value of 35 mm equivalent focal length may be referred to determine an angle of view when displaying superimposed images.

The superimposed display information is generated by the smart phone 5. In this example, the superimposed display information includes area division number information, a coordinate of a grid in each grid area (location parameter), and correction values for brightness and color (correction parameter). The area division number information indicates a number of divisions of the first area CA1, both in the horizontal (longitude) direction and the vertical (latitude) direction. The area division number information is referred to when dividing the first area CA1 into a plurality of grid areas.

The location parameter is mapping information, which indicates, for each grid in each grid area of the planar image P, a location in the equirectangular projection image EC. For example, the location parameter associates a location of each grid in each grid area in the equirectangular projection image EC, with each grid in each grid area in the planar image P. The correction parameter, in this example, is gain data for correcting color values of the planar image P. Since the target to be corrected may be a monochrome image, the correction parameter may be used only to correct the brightness value. Accordingly, at least the brightness of the image is to be corrected using the correction parameter.

The perspective projection, which is used for capturing the planar image P, is not applicable to capturing the 360-degree omnidirectional image, such as the spherical image CE. The wide-angle image, such as the spherical image, is often captured in equirectangular projection. In equirectangular projection, like Mercator projection, the distance between lines in the horizontal direction increases away from the standard parallel. This results in generation of the image, which looks very different from the image taken with the general-purpose camera in perspective projection. If the planar image P, superimposed on the spherical image CE, is displayed, the planar image P and the spherical image CE that differ in projection, look different from each other. Even scaling is made equal between these images, the planar image P does not fit in the spherical image CE. In view of the above, the location parameter is generated as described above referring to FIG. 20.

Referring to FIGS. 18A and 18B, the location parameter and the correction parameter are described in detail, according to the embodiment. FIG. 18A is a conceptual diagram illustrating a plurality of grid areas in the second area CA2, according to the embodiment. FIG. 18B is a conceptual diagram illustrating a plurality of grid areas in the third area CA3, according to the embodiment.

As described above, the first area CAL which is a part of the equirectangular projection image EC, is converted to the second area CA2 in perspective projection, which is the same projection with the projection of the planar image P. As illustrated in FIG. 18A, the second area CA2 is divided into 30 grid areas in the horizontal direction, and 20 grid areas in the vertical direction, resulting in 600 grid areas in total. Still referring to FIG. 18A, the coordinate of each grid in each grid area can be expressed by (LO_{00,00}, LA_{00,00}), (LO_{01,00}, LA_{01,00}), . . . , (LO_{30,20}, LA_{30,20}). The correction value of brightness and color of each grid in each grid area can be expressed by (R_{00,00}, G_{00,00} B_{00,00}), (R_{01,00}, G_{01,00}, B_{01,00}), . . . , (R_{30,20}, G_{30,20}, B_{30,20}). For simplicity, in FIG. 18A, only four vertices (grids) are each shown with the coordinate value, and the correction value for brightness and color. However, the coordinate value and the correction value for brightness and color, are assigned to each of all girds. The correction values R, G, B for brightness and color, corresponds to correction gains for red, green, and blue, respectively. In this example, the correction values R, G, B for brightness and color, are generated for a predetermined area centering on a specific grid. The specific grid is selected, such that the predetermined area of such grid does not overlap with a predetermined area of an adjacent specific gird.

As illustrated in FIG. 18B, the second area CA2 is reverse converted to the third area CA3 in equirectangular projection, which is the same projection with the projection of the equirectangular projection image EC. In this embodiment, the third area CA3 is equally divided into 30 grid areas in the horizontal direction, and 20 grid areas in the vertical direction, resulting in 600 grid areas in total. Referring to FIG. 18B, the coordinate of each grid in each area can be expressed by (LO′_{00,00}, LA′_{00,00}), (LO′_{01,00}, LA′_{01,00}), . . . , (LO′_{30,20}, LA′_{30,20}). The correction values of brightness and color of each grid in each grid area are the same as the correction values of brightness and color of each grid in each grid area in the second area CA2. For simplicity, in FIG. 18B, only four vertices (grids) are each shown with the coordinate value, and the correction value for brightness and color. However, the coordinate value and the correction value for brightness and color, are assigned to each of all girds.

Referring back to FIG. 17, the metadata generation information includes version information indicating a version of the superimposed display metadata.

As described above, the location parameter indicates correspondence of pixel positions, between the planar image P and the equirectangular projection image EC (spherical image CE). If such correspondence information is to be provided for all pixels, data for about 40 million pixels is needed in case the generic image capturing device 3 is a high-resolution digital camera. This increases processing load due to the increased data size of the location parameter. In view of this, in this embodiment, the planar image P is divided into 600 (30×20) grid areas. The location parameter indicates correspondence of each gird in each of 600 grid areas, between the planar image P and the equirectangular projection image EC (spherical image CE). When displaying the superimposed images by the smart phone 5, the smart phone 5 may interpolate the pixels in each grid area based on the coordinate of each grid in that grid area.

(Functional Configuration of Superimposing Unit)

Referring to FIG. 16, a functional configuration of the superimposing unit 55b is described according to the embodiment. The superimposing unit 55b includes a superimposed area generator 582, a correction unit 584, an image generator 586, an image superimposing unit 588, and a projection converter 590.

The superimposed area generator 582 specifies a part of the sphere CS, which corresponds to the third area CA3, to generate a partial sphere PS.

The correction unit 584 corrects at least one of the brightness and color of the planar image P, using the correction parameter of the superimposed display metadata, to match the at least one of the brightness and color of the equirectangular projection image EC.

The image generator 586 superimposes (maps) the planar image P (or the corrected image C of the planar image P), on the partial sphere PS to generate an image to be superimposed on the spherical image CE, which is referred to as a superimposed image S for simplicity. The image generator 586 generates mask data M, based on a surface area of the partial sphere PS. The image generator 586 covers (attaches) the equirectangular projection image EC, over the sphere CS, to generate the spherical image CE.

The mask data M, having information indicating the degree of transparency, is referred to when superimposing the superimposed image S on the spherical image CE. The mask data M sets the degree of transparency for each pixel, or a set of pixels, such that the degree of transparency increases from the center of the superimposed image S toward the boundary of the superimposed image S with the spherical image CE. With this mask data M, the pixels around the center of the superimposed image S have brightness and color of the superimposed image S, and the pixels near the boundary between the superimposed image S and the spherical image CE have brightness and color of the spherical image CE. Accordingly, superimposition of the superimposed image S on the spherical image CE is made unnoticeable. However, application of the mask data M can be made optional, such that the mask data M does not have to be generated.

The image superimposing unit 588 superimposes the superimposed image S and the mask data M, on the spherical image CE. The image is generated, in which the high-definition superimposed image S is superimposed on the low-definition spherical image CE.

As illustrated in FIG. 7, the projection converter 590 converts projection, such that the predetermined area T of the spherical image CE, with the superimposed image S being superimposed, is displayed on the display 517, for example, in response to a user instruction for display. The projection transformation is performed based on the line of sight of the user (the direction of the virtual camera IC, represented by the central point CP of the predetermined area T), and the angle of view α of the predetermined area T. In projection transformation, the projection converter 590 converts a resolution of the predetermined area T, to match with a resolution of a display area of the display 517. Specifically, when the resolution of the predetermined area T is less than the resolution of the display area of the display 517, the projection converter 590 enlarges a size of the predetermined area T to match the display area of the display 517. In contrary, when the resolution of the predetermined area T is greater than the resolution of the display area of the display 517, the projection converter 590 reduces a size of the predetermined area T to match the display area of the display 517. Accordingly, the display control 56 displays the predetermined-area image Q, that is, the image of the predetermined area T, in the entire display area of the display 517.

Referring now to FIGS. 19 to 30, operation of capturing the image and displaying the image, performed by the image capturing system, is described according to the embodiment. First, referring to FIG. 19, operation of capturing the image, performed by the image capturing system, is described according to the embodiment. FIG. 19 is a data sequence diagram illustrating operation of capturing the image, according to the embodiment. The following describes the example case in which the object and surroundings of the object are captured. However, in addition to capturing the object, audio may be recorded by the audio collection unit 14 as the captured image is being generated.

As illustrated in FIG. 19, the acceptance unit 52 of the smart phone 5 accepts a user instruction to start linked image capturing (S11). In response to the user instruction to start linked image capturing, the display control 56 controls the display 517 to display a linked image capturing device configuration screen as illustrated in FIG. 15B. The screen of FIG. 15B includes, for each image capturing device available for use, a radio button to be selected when the image capturing device is selected as a main device, and a check box to be selected when the image capturing device is selected as a sub device. The screen of FIG. 15B further displays, for each image capturing device available for use, a device name and a received signal intensity level of the image capturing device. Assuming that the user selects one image capturing device as a main device, and other image capturing device as a sub device, and presses the “Confirm” key, the acceptance unit 52 of the smart phone 5 accepts the instruction for starting linked image capturing. In this example, more than one image capturing device may be selected as the sub device. For this reasons, more than one check boxes may be selected.

The near-distance communication unit 58 of the smart phone 5 sends a polling inquiry to start image capturing, to the near-distance communication unit 38 of the generic image capturing device 3 (S12). The near-distance communication unit 38 of the generic image capturing device 3 receives the inquiry to start image capturing.

The determiner 37 of the generic image capturing device 3 determines whether image capturing has started, according to whether the acceptance unit 32 has accepted pressing of the shutter button 315a by the user (S13).

The near-distance communication unit 38 of the generic image capturing device 3 transmits a response based on a result of the determination at S13, to the smart phone 5 (S14). When it is determined that image capturing has started at S13, the response indicates that image capturing has started. In such case, the response includes an image identifier of the image being captured with the generic image capturing device 3. In contrary, when it is determined that the image capturing has not started at S13, the response indicates that it is waiting to start image capturing. The near-distance communication unit 58 of the smart phone 5 receives the response.

The description continues, assuming that the determination indicates that image capturing has started at S13 and the response indicating that image capturing has started is transmitted at S14.

The generic image capturing device 3 starts capturing the image (S15). The processing of S15, which is performed after pressing of the shutter button 315a, includes capturing the object and surroundings to generate captured image data (planar image data) with the image capturing unit 33, and storing the captured image data in the memory 3000 with the storing and reading unit 39.

At the smart phone 5, the near-distance communication unit 58 transmits an image capturing start request, which requests to start image capturing, to the special image capturing device 1 (S16). The near-distance communication unit 18 of the special image capturing device 1 receives the image capturing start request.

The special image capturing device 1 starts capturing the image (S17). Specifically, at S17, the image capturing unit 13 captures the object and surroundings to generate captured image data, i.e., two hemispherical images as illustrated in FIGS. 3A and 3B. The image and audio processing unit 15 then generates one equirectangular projection image as illustrated in FIG. 3C, based on these two hemispherical images. The storing and reading unit 19 stores data of the equirectangular projection image in the memory 1000.

At the smart phone 5, the near-distance communication unit 58 transmits a request to transmit a captured image (“captured image request”) to the generic image capturing device 3 (S18). The captured image request includes the image identifier received at S14. The near-distance communication unit 38 of the generic image capturing device 3 receives the captured image request.

The near-distance communication unit 38 of the generic image capturing device 3 transmits planar image data, obtained at S15, to the smart phone 5 (S19). With the planar image data, the image identifier for identifying the planar image data, and attribute data, are transmitted. The image identifier and attribute data of the planar image, are a part of planar image information illustrated in FIG. 17. The near-distance communication unit 58 of the smart phone 5 receives the planar image data, the image identifier, and the attribute data.

The near-distance communication unit 18 of the special image capturing device 1 transmits the equirectangular projection image data, obtained at S17, to the smart phone 5 (S20). With the equirectangular projection image data, the image identifier for identifying the equirectangular projection image data, and attribute data, are transmitted. As illustrated in FIG. 17, the image identifier and the attribute data are a part of the equirectangular projection image information. The near-distance communication unit 58 of the smart phone 5 receives the equirectangular projection image data, the image identifier, and the attribute data.

Next, the storing and reading unit 59 of the smart phone 5 stores the planar image data received at S19, and the equirectangular projection image data received at S20, in the same folder in the memory S000 (S21).

Next, the image and audio processing unit 55 of the smart phone 5 generates superimposed display metadata, which is used to display an image where the planar image P is partly superimposed on the spherical image CE (S22). Here, the planar image P is a high-definition image, and the spherical image CE is a low-definition image. The storing and reading unit 59 stores the superimposed display metadata in the memory 5000.

Referring to FIGS. 20 to 24, operation of generating superimposed display metadata is described in detail, according to the embodiment. Even when the generic image capturing device 3 and the special image capturing device 1 are equal in resolution of imaging element, the imaging element of the special image capturing device 1 captures a wide area to obtain the equirectangular projection image, from which the 360-degree spherical image CE is generated. Accordingly, the image data captured with the special image capturing device 1 tends to be low in definition per unit area.

<Generation of Superimposed Display Metadata>

First, operation of generating the superimposed display metadata is described. The superimposed display metadata is used to display an image on the display 517, where the high-definition planar image P is superimposed on the spherical image CE. The spherical image CE is generated from the low-definition equirectangular projection image EC. As illustrated in FIG. 17, the superimposed display metadata includes the location parameter and the correction parameter, each of which is generated as described below.

Referring to FIG. 20, the extractor 550 extracts a plurality of feature points fp1 from the rectangular, equirectangular projection image EC captured in equirectangular projection (S110). The extractor 550 further extracts a plurality of feature points fp2 from the rectangular, planar image P captured in perspective projection (S110).

Next, the first area calculator 552 calculates a rectangular, first area CA1 in the equirectangular projection image EC, which corresponds to the planar image P, based on similarity between the feature value fv1 of the feature 8 points fp1 in the equirectangular projection image EC, and the feature value fv2 of the feature points fp2 in the planar image P, using the homography (S120). More specifically, the first area calculator 552 calculates a rectangular, first area CA1 in the equirectangular projection image EC, which corresponds to the planar image P, based on similarity between the feature value fv1 of the feature points fp1 in the equirectangular projection image EC, and the feature value fv2 of the feature points fp2 in the planar image P, using the homography (S120). The above-described processing is performed to roughly estimate corresponding pixel (gird) positions between the planar image P and the equirectangular projection image EC that differ in projection.

Next, the point of gaze specifier 554 specifies the point (referred to as the point of gaze) in the equirectangular projection image EC, which corresponds to the central point CP1 of the planar image P after the first homography transformation (S130).

The projection converter 556 extracts a peripheral area PA, which is a part surrounding the point of gaze GP1, from the equirectangular projection image EC. The projection converter 556 converts the peripheral area PA, from the equirectangular projection to the perspective projection, to generate a peripheral area image PI (S140).

The extractor 550 extracts a plurality of feature points fp3 from the peripheral area image PI, which is obtained by the projection converter 556 (S150).

Next, the second area calculator 558 calculates a rectangular, second area CA2 in the peripheral area image PI, which corresponds to the planar image P, based on similarity between the feature value fv2 of the feature points fp2 in the planar image P, and the feature value fv3 of the feature points fp3 in the peripheral area image PI using second homography (S160). In this example, the planar image P, which is a high-definition image of 40 million pixels, may be reduced in size.

Next, the area divider 560 divides the second area CA2 into a plurality of grid areas LA2 as illustrated in FIG. 22B (S170).

As illustrated in FIG. 20, the projection reverse converter 562 converts (reverse converts) the second area CA2 from the perspective projection to the equirectangular projection, which is the same as the projection of the equirectangular projection image EC (S180). As illustrated in FIG. 23, the projection reverse converter 562 determines the third area CA3 in the equirectangular projection image EC, which contains a plurality of grid areas LA3 corresponding to the plurality of grid areas LA2 in the second area CA2. FIG. 23 is a conceptual diagram for explaining determination of the third area CA3 in the equirectangular projection image EC. Through processing by the projection reverse converter 562, a location parameter is generated, which indicates the coordinate of each grid in each grid area LA3. The location parameter is illustrated in FIG. 17 and FIG. 18B.

Referring to FIGS. 20 to 24C, operation of generating the correction parameter is described according to the embodiment. FIGS. 24A to 24C are conceptual diagrams illustrating operation of generating the correction parameter, according to the embodiment.

After S180, the shape converter 564 converts the second area CA2 to have a shape that is the same as the shape of the planar image P. Specifically, the shape converter 564 maps four vertices of the second area CA2, illustrated in FIG. 24A, on corresponding four vertices of the planar image P, to obtain the second area CA2 as illustrated in FIG. 24B.

As illustrated in FIG. 24C, the area divider 560 divides the planar image P into a plurality of grid areas LAO, which are equal in shape and number to the plurality of grid areas LA2′ of the second area CA2′ (S200).

The correction parameter generator 566 generates the correction parameter, which is to be applied to each grid area LA2′ in the second area CA2′, such that each grid area LA2′ is equal to the corresponding grid area LAO in the planar image P in brightness and color (S210).

As illustrated in FIG. 17, the superimposed display metadata generator 570 generates the superimposed display metadata, using the equirectangular projection image information obtained from the special image capturing device 1, the planar image information obtained from the generic image capturing device 3, the area division number information previously set, the location parameter generated by the projection reverse converter 562, the correction parameter generated by the correction parameter generator 566, and the metadata generation information (S220). The superimposed display metadata is stored in the memory S000 by the storing and reading unit 59.

Then, the operation of generating the superimposed display metadata performed at S22 of FIG. 19 ends. The display control 56, which cooperates with the storing and reading unit 59, superimposes the images, using the superimposed display metadata (S23).

<Superimposition>

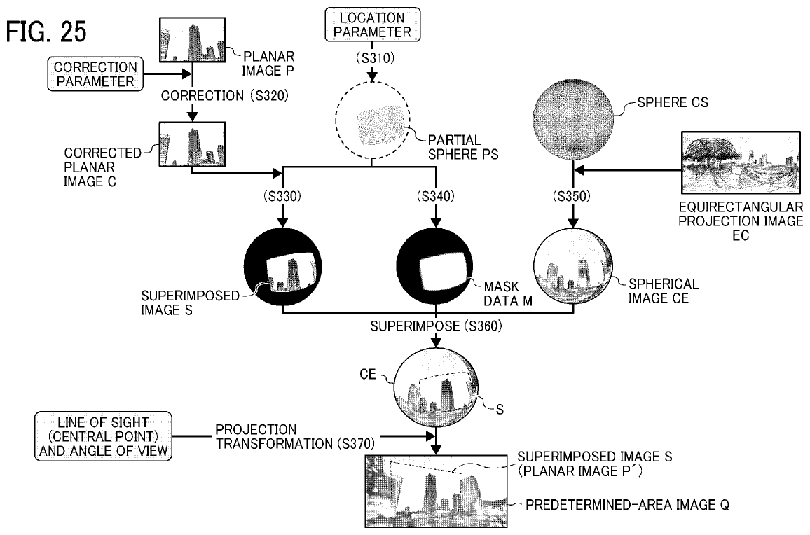

Referring to FIGS. 25 to 30D, operation of superimposing images is described according to the embodiment. FIG. 25 is a conceptual diagram illustrating operation of superimposing images, with images being processed or generated, according to the embodiment.

The storing and reading unit 59 (obtainer) illustrated in FIG. 14 reads from the memory 5000, data of the equirectangular projection image EC in equirectangular projection, data of the planar image P in perspective projection, and the superimposed display metadata.

As illustrated in FIG. 25, using the location parameter, the superimposed area generator 582 specifies a part of the virtual sphere CS, which corresponds to the third area CA3, to generate a partial sphere PS (S310). The pixels other than the pixels corresponding to the grids having the positions defined by the location parameter are interpolated by linear interpolation.

The correction unit 584 corrects the brightness and color of the planar image P, using the correction parameter of the superimposed display metadata, to match the brightness and color of the equirectangular projection image EC (S320). The planar image P, which has been corrected, is referred to as the “corrected planar image C”.

The image generator 586 superimposes the corrected planar image C of the planar image P, on the partial sphere PS to generate the superimposed image S (S330). The pixels other than the pixels corresponding to the grids having the positions defined by the location parameter are interpolated by linear interpolation. The image generator 586 generates mask data M based on the partial sphere PS (S340). The image generator 586 covers (attaches) the equirectangular projection image EC, over a surface of the sphere CS, to generate the spherical image CE (S350). The image superimposing unit 588 superimposes the superimposed image S and the mask data M, on the spherical image CE (S360). The image is generated, in which the high-definition superimposed image S is superimposed on the low-definition spherical image CE. With the mask data, the boundary between the two different images is made unnoticeable.

As illustrated in FIG. 7, the projection converter 590 converts projection, such that the predetermined area T of the spherical image CE, with the superimposed image S being superimposed, is displayed on the display 517, for example, in response to a user instruction for display. The projection transformation is performed based on the line of sight of the user (the direction of the virtual camera IC, represented by the central point CP of the predetermined area T), and the angle of view α of the predetermined area T (S370). The projection converter 590 may further change a size of the predetermined area T according to the resolution of the display area of the display 517. Accordingly, the display control 56 displays the predetermined-area image Q, that is, the image of the predetermined area T, in the entire display area of the display 517 (S24). In this example, the predetermined-area image Q includes the superimposed image S superimposed with the planar image P.

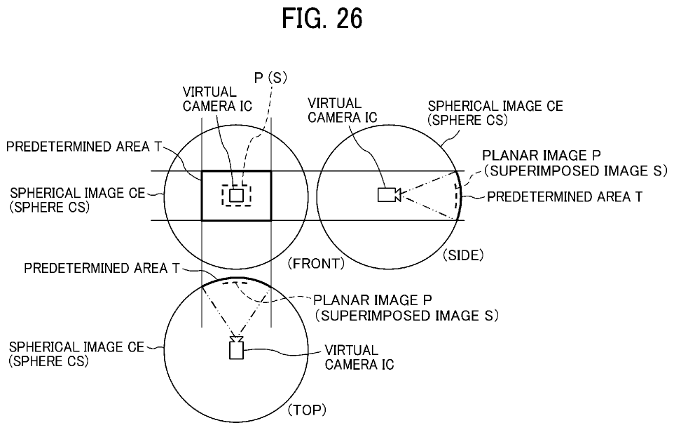

Referring to FIGS. 26 to 30D, display of the superimposed image is described in detail, according to the embodiment. FIG. 26 is a conceptual diagram illustrating a two-dimensional view of the spherical image CE superimposed with the planar image P. The planar image P is superimposed on the spherical image CE illustrated in FIG. 5. As illustrated in FIG. 26, the high-definition superimposed image S is superimposed on the spherical image CE, which covers a surface of the sphere CS, to be within the inner side of the sphere CS, according to the location parameter.

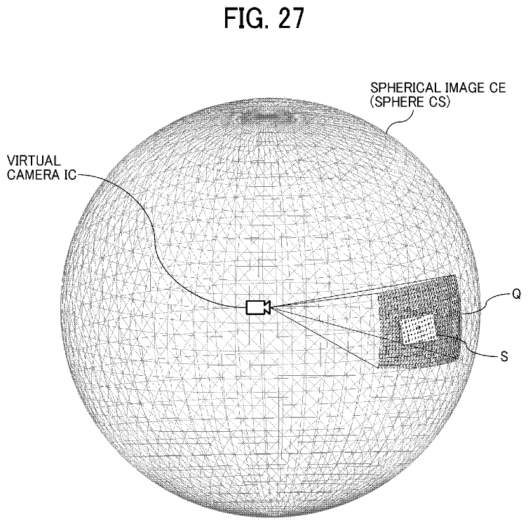

FIG. 27 is a conceptual diagram illustrating a three-dimensional view of the spherical image CE superimposed with the planar image P. FIG. 27 represents a state in which the spherical image CE and the superimposed image S cover a surface of the sphere CS, and the predetermined-area image Q includes the superimposed image S.

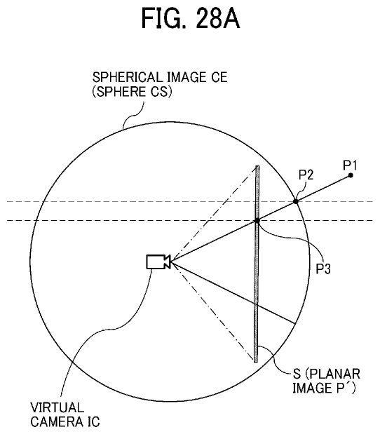

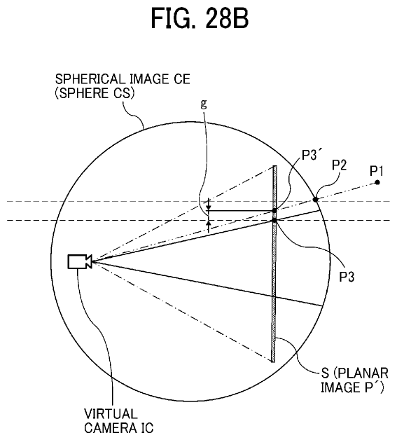

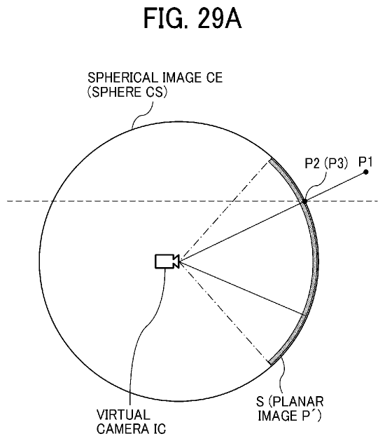

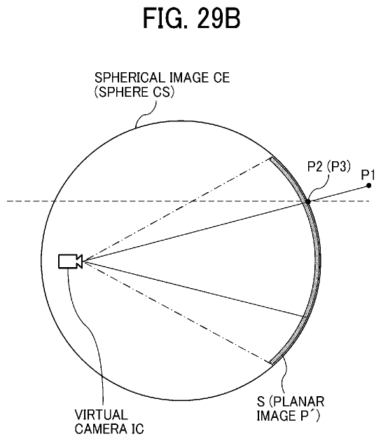

FIGS. 28A and 28B are conceptual diagrams illustrating a two-dimensional view of a spherical image superimposed with a planar image, without using the location parameter, according to a comparative example. FIGS. 29A and 29B are conceptual diagrams illustrating a two-dimensional view of the spherical image CE superimposed with the planar image P, using the location parameter, in this embodiment.

As illustrated in FIG. 28A, it is assumed that the virtual camera IC, which corresponds to the user's point of view, is located at the center of the sphere CS, which is a reference point. The object P1, as an image capturing target, is represented by the object P2 in the spherical image CE. The object P1 is represented by the object P3 in the superimposed image S. Still referring to FIG. 28A, the object P2 and the object P3 are positioned along a straight line connecting the virtual camera IC and the object P1. This indicates that, even when the superimposed image S is displayed as being superimposed on the spherical image CE, the coordinate of the spherical image CE and the coordinate of the superimposed image S match. As illustrated in FIG. 28B, if the virtual camera IC is moved away from the center of the sphere CS, the position of the object P2 stays on the straight line connecting the virtual camera IC and the object P1, but the position of the object P3 is slightly shifted to the position of an object P3′. The object P3′ is an object in the superimposed image S, which is positioned along the straight line connecting the virtual camera IC and the object P1. This will cause a difference in grid positions between the spherical image CE and the superimposed image S, by an amount of shift “g” between the object P3 and the object P3′. Accordingly, in displaying the superimposed image S, the coordinate of the superimposed image S is shifted from the coordinate of the spherical image CE.

In view of the above, in this embodiment, the location parameter is generated, which indicates respective positions of a plurality of grid areas in the superimposed image S with respect to the planar image P. With this location parameter, as illustrated in FIGS. 29A and 29B, the superimposed image S is superimposed on the spherical image CE at right positions, while compensating the shift. More specifically, as illustrated in FIG. 29A, when the virtual camera IC is at the center of the sphere CS, the object P2 and the object P3 are positioned along the straight line connecting the virtual camera IC and the object P1. As illustrated in FIG. 29B, even when the virtual camera IC is moved away from the center of the sphere CS, the object P2 and the object P3 are positioned along the straight line connecting the virtual camera IC and the object P1. Even when the superimposed image S is displayed as being superimposed on the spherical image CE, the coordinate of the spherical image CE and the coordinate of the superimposed image S match.

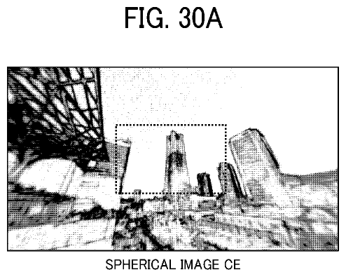

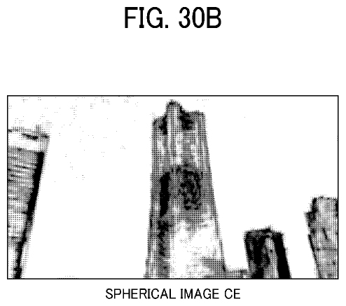

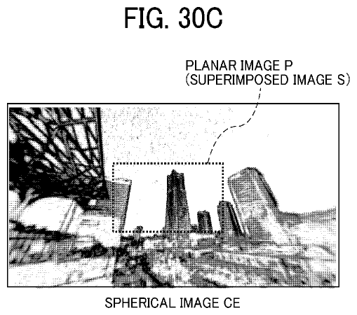

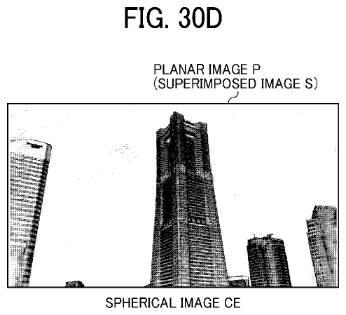

Accordingly, the image capturing system of this embodiment is able to display an image in which the high-definition planar image P is superimposed on the low-definition spherical image CE, with high image quality. This will be explained referring to FIGS. 30A to 30D. FIG. 30A illustrates the spherical image CE, when displayed as a wide-angle image. Here, the planar image P is not superimposed on the spherical image CE. FIG. 30B illustrates the spherical image CE, when displayed as a telephoto image. Here, the planar image P is not superimposed on the spherical image CE. FIG. 30C illustrates the spherical image CE, superimposed with the planar image P, when displayed as a wide-angle image. FIG. 30D illustrates the spherical image CE, superimposed with the planar image P, when displayed as a telephoto image. The dotted line in each of FIGS. 30A and 30C, which indicates the boundary of the planar image P, is shown for the descriptive purposes. Such dotted line may be displayed, or not displayed, on the display 517 to the user.

It is assumed that, while the spherical image CE without the planar image P being superimposed, is displayed as illustrated in FIG. 30A, a user instruction for enlarging an area indicated by the dotted area is received. In such case, as illustrated in FIG. 30B, the enlarged, low-definition image, which is a blurred image, is displayed to the user. As described above in this embodiment, it is assumed that, while the spherical image CE with the planar image P being superimposed, is displayed as illustrated in FIG. 30C, a user instruction for enlarging an area indicated by the dotted area is received. In such case, as illustrated in FIG. 30D, a high-definition image, which is a clear image, is displayed to the user. For example, assuming that the target object, which is shown within the dotted line, has a sign with some characters, even when the user enlarges that section, the user may not be able to read such characters if the image is blurred. If the high-definition planar image P is superimposed on that section, the high-quality image will be displayed to the user such that the user is able to read those characters.

As described above in this embodiment, even when images that differ in projection are superimposed one above the other, the grid shift caused by the difference in projection can be compensated. For example, even when the planar image P in perspective projection is superimposed on the equirectangular projection image EC in equirectangular projection, these images are displayed with the same coordinate positions. More specifically, the special image capturing device 1 and the generic image capturing device 3 capture images using different projection methods. In such case, if the planar image P obtained by the generic image capturing device 3, is superimposed on the spherical image CE that is generated from the equirectangular projection image EC obtained by the special image capturing device, the planar image P does not fit in the spherical image CE as these images CE and P look different from each other. In view of this, as illustrated in FIG. 20, the smart phone 5 according to this embodiment determines the first area CA1 in the equirectangular projection image EC, which corresponds to the planar image P, to roughly determine the area where the planar image P is superimposed (S120). The smart phone 5 extracts a peripheral area PA, which is a part surrounding the point of gaze GP1 in the first area CA1, from the equirectangular projection image EC. The smart phone 5 further converts the peripheral area PA, from the equirectangular projection, to the perspective projection that is the projection of the planar image P, to generate a peripheral area image PI (S140). The smart phone 5 determines the second area CA2, which corresponds to the planar image P, in the peripheral area image PI (S160), and reversely converts the projection applied to the second area CA2, back to the equirectangular projection applied to the equirectangular projection image EC. With this projection transformation, the third area CA3 in the equirectangular projection image EC, which corresponds to the second area CA2, is determined (S180). As illustrated in FIG. 30C, the high-definition planar image P is superimposed on a part of the predetermined-area image on the low-definition, spherical image CE. The planar image P fits in the spherical image CE, when displayed to the user.

Further, in this embodiment, the location parameter indicates positions where the superimposed image S is superimposed on the spherical image CE, using the third area CA3 including a plurality of grid areas. Accordingly, as illustrated in FIG. 29B, the superimposed image S is superimposed on the spherical image CE at right positions. This compensates the shift in grid due to the difference in projection, even when the position of the virtual camera IC changes.

### Second Embodiment

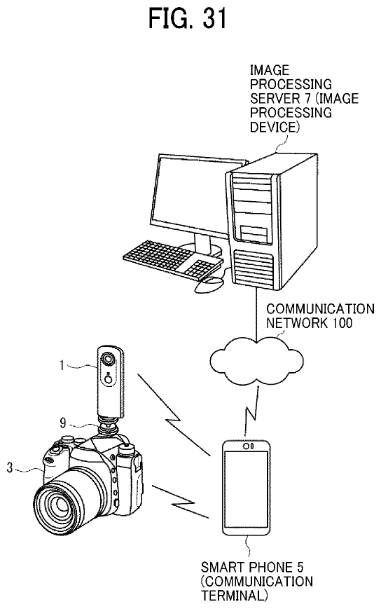

Referring now to FIGS. 31 to 35, an image capturing system is described according to a second embodiment.

<Overview of Image Capturing System>

First, referring to FIG. 31, an overview of the image capturing system is described according to the second embodiment. FIG. 31 is a schematic block diagram illustrating a configuration of the image capturing system according to the second embodiment.

As illustrated in FIG. 31, compared to the image capturing system of the first embodiment described above, the image capturing system of this embodiment further includes an image processing server 7. In the second embodiment, the elements that are substantially same to the elements described in the first embodiment are assigned with the same reference numerals. For descriptive purposes, description thereof is omitted. The smart phone 5 and the image processing server 7 communicate with each other through the communication network 100 such as the Internet and the Intranet.

In the first embodiment, the smart phone 5 generates superimposed display metadata, and processes superimposition of images. In this second embodiment, the image processing server 7 performs such processing, instead of the smart phone 5. The smart phone 5 in this embodiment is one example of the communication terminal, and the image processing server 7 is one example of the image processing apparatus or device.

The image processing server 7 is a server system, which is implemented by a plurality of computers that may be distributed over the network to perform processing such as image processing in cooperation with one another.

<Hardware Configuration>

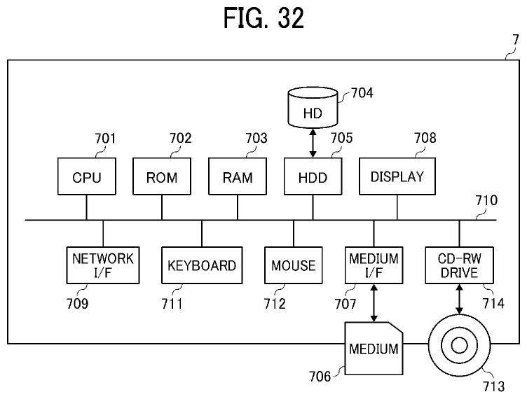

Next, referring to FIG. 32, a hardware configuration of the image processing server 7 is described according to the embodiment. FIG. 32 illustrates a hardware configuration of the image processing server 7 according to the embodiment. Since the special image capturing device 1, the generic image capturing device 3, and the smart phone 5 are substantially the same in hardware configuration, as described in the first embodiment, description thereof is omitted.

<Hardware Configuration of Image Processing Server>

Referring to FIG. 32, the image processing server 7, which is implemented by the general-purpose computer, includes a CPU 701, a ROM 702, a RAM 703, a HD 704, a HDD 705, a medium I/F 707, a display 708, a network I/F 709, a keyboard 711, a mouse 712, a CD-RW drive 714, and a bus line 710. Since the image processing server 7 operates as a server, an input device such as the keyboard 711 and the mouse 712, or an output device such as the display 708 does not have to be provided.

The CPU 701 controls entire operation of the image processing server 7. The ROM 702 stores a control program for controlling the CPU 701. The RAM 703 is used as a work area for the CPU 701. The HD 704 stores various data such as programs. The HDD 705 controls reading or writing of various data to or from the HD 704 under control of the CPU 701. The medium I/F 707 controls reading or writing of data with respect to a recording medium 706 such as a flash memory. The display 708 displays various information such as a cursor, menu, window, characters, or image. The network I/F 709 is an interface that controls communication of data with an external device through the communication network 100. The keyboard 711 is one example of input device provided with a plurality of keys for allowing a user to input characters, numerals, or various instructions. The mouse 712 is one example of input device for allowing the user to select a specific instruction or execution, select a target for processing, or move a curser being displayed. The CD-RW drive 714 reads or writes various data with respect to a Compact Disc ReWritable (CD-RW) 713, which is one example of removable recording medium.

The image processing server 7 further includes the bus line 710. The bus line 710 is an address bus or a data bus, which electrically connects the elements in FIG. 32 such as the CPU 701.

<Functional Configuration of Image Capturing System>

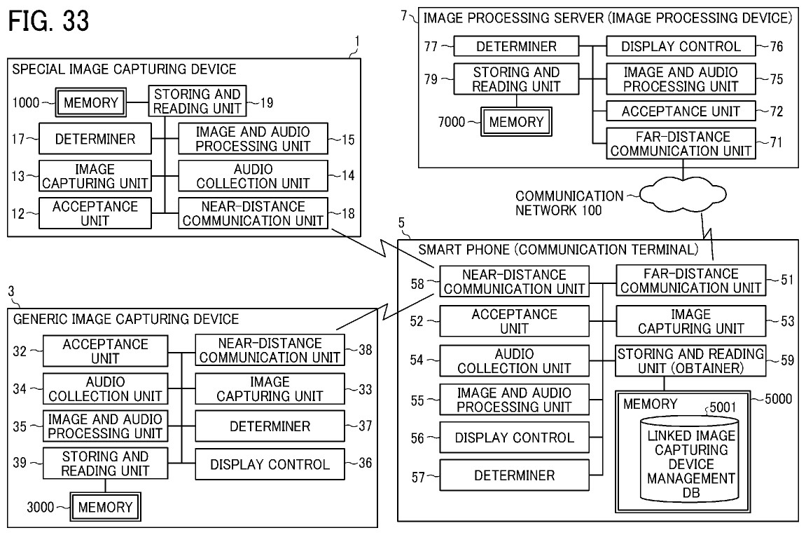

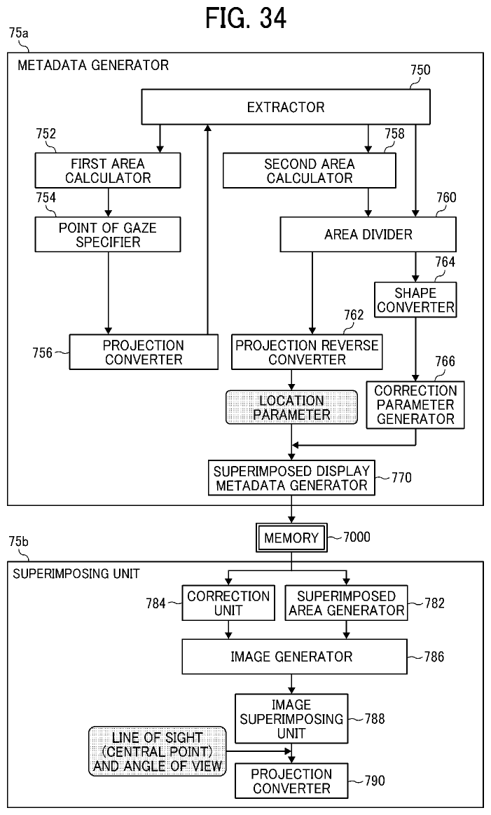

Referring now to FIGS. 33 and 34, a functional configuration of the image capturing system of FIG. 31 is described according to the second embodiment. FIG. 33 is a schematic block diagram illustrating a functional configuration of the image capturing system of FIG. 31 according to the second embodiment. Since the special image capturing device 1, the generic image capturing device 3, and the smart phone 5 are substantially same in functional configuration, as described in the first embodiment, description thereof is omitted. In this embodiment, however, the image and audio processing unit 55 of the smart phone 5 does not have to be provided with all of the functional units illustrated in FIG. 16.

<Functional Configuration of Image Processing Server>

As illustrated in FIG. 33, the image processing server 7 includes a far-distance communication unit 71, an acceptance unit 72, an image and audio processing unit 75, a display control 76, a determiner 77, and a storing and reading unit 79. These units are functions that are implemented by or that are caused to function by operating any of the elements illustrated in FIG. 32 in cooperation with the instructions of the CPU 701 according to the control program expanded from the HD 704 to the RAM 703.

The image processing server 7 further includes a memory 7000, which is implemented by the ROM 702, the RAM 703 and the HD 704 illustrated in FIG. 32.

The far-distance communication unit 71 of the image processing server 7 is implemented by the network I/F 709 that operates under control of the CPU 701, illustrated in FIG. 32, to transmit or receive various data or information to or from other device (for example, other smart phone or server) through the communication network such as the Internet.

The acceptance unit 72 is implement by the keyboard 711 or mouse 712, which operates under control of the CPU 701, to receive various selections or inputs from the user.

The image and audio processing unit 75 is implemented by the instructions of the CPU 701. The image and audio processing unit 75 applies various types of processing to various types of data, transmitted from the smart phone 5.

The display control 76, which is implemented by the instructions of the CPU 701, generates data of the predetermined-area image Q, as a part of the planar image P, for display on the display 517 of the smart phone 5. The display control 76 superimposes the planar image P, on the spherical image CE, using superimposed display metadata, generated by the image and audio processing unit 75. With the superimposed display metadata, each grid area LAO of the planar image P is placed at a location indicated by a location parameter, and is adjusted to have a brightness value and a color value indicated by a correction parameter.

The determiner 77 is implemented by the instructions of the CPU 701, illustrated in FIG. 32, to perform various determinations.

The storing and reading unit 79, which is implemented by instructions of the CPU 701 illustrated in FIG. 32, stores various data or information in the memory 7000 and read out various data or information from the memory 7000. For example, the superimposed display metadata may be stored in the memory 7000. In this embodiment, the storing and reading unit 79 functions as an obtainer that obtains various data from the memory 7000.

(Functional Configuration of Image and Audio Processing Unit)

Referring to FIG. 34, a functional configuration of the image and audio processing unit 75 is described according to the embodiment. FIG. 34 is a block diagram illustrating the functional configuration of the image and audio processing unit 75 according to the embodiment.

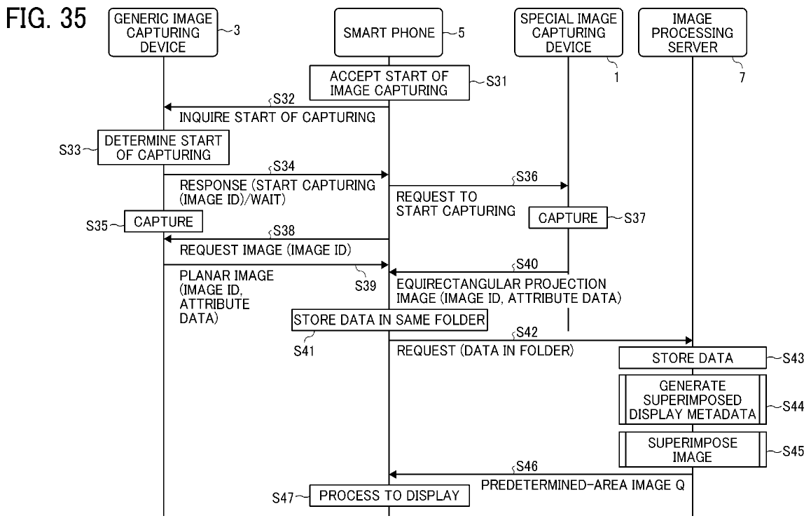

The image and audio processing unit 75 mainly includes a metadata generator 75a that performs encoding, and a superimposing unit 75b that performs decoding. The metadata generator 75a performs processing of S44, which is processing to generate superimposed display metadata, as illustrated in FIG. 35. The superimposing unit 75b performs processing of S45, which is processing to superimpose the images using the superimposed display metadata, as illustrated in FIG. 35.

(Functional Configuration of Metadata Generator)

First, a functional configuration of the metadata generator 75a is described according to the embodiment. The metadata generator 75a includes an extractor 750, a first area calculator 752, a point of gaze specifier 754, a projection converter 756, a second area calculator 758, an area divider 760, a projection reverse converter 762, a shape converter 764, a correction parameter generator 766, and a superimposed display metadata generator 770. These elements of the metadata generator 75a are substantially similar in function to the extractor 550, first area calculator 552, point of gaze specifier 554, projection converter 556, second area calculator 558, area divider 560, projection reverse converter 562, shape converter 564, correction parameter generator 566, and superimposed display metadata generator 570 of the metadata generator 55a, respectively. Accordingly, the description thereof is omitted.

Referring to FIG. 34, a functional configuration of the superimposing unit 75b is described according to the embodiment. The superimposing unit 75b includes a superimposed area generator 782, a correction unit 784, an image generator 786, an image superimposing unit 788, and a projection converter 790. These elements of the superimposing unit 75b are substantially similar in function to the superimposed area generator 582, correction unit 584, image generator 586, image superimposing unit 588, and projection converter 590 of the superimposing unit 55b, respectively. Accordingly, the description thereof is omitted.

<Operation>

Referring to FIG. 35, operation of capturing the image, performed by the image capturing system of FIG. 31, is described according to the second embodiment. Referring to FIG. 35, operation of capturing the image, performed by the image capturing system of FIG. 31, is described according to the second embodiment. FIG. 35 is a data sequence diagram illustrating operation of capturing the image, according to the second embodiment. S31 to S41 are performed in a substantially similar manner as described above referring to S11 to S21 according to the first embodiment, and description thereof is omitted.

At the smart phone 5, the far-distance communication unit 51 transmits a superimposing request, which requests for superimposing one image on other image that are different in projection, to the image processing server 7, through the communication network 100 (S42). The superimposing request includes image data to be processed, which has been stored in the memory 5000. In this example, the image data to be processed includes planar image data, and equirectangular projection image data, which are stored in the same folder. The far-distance communication unit 71 of the image processing server 7 receives the image data to be processed.

Next, at the image processing server 7, the storing and reading unit 79 stores the image data to be processed (planar image data and equirectangular projection image data), which is received at S42, in the memory 7000 (S43). The metadata generator 75a illustrated in FIG. 34 generates superimposed display metadata (S44). Further, the superimposing unit 75b superimposes images using the superimposed display metadata (S45). More specifically, the superimposing unit 75b superimposes the planar image on the equirectangular projection image. S44 and S45 are performed in a substantially similar manner as described above referring to S22 and S23 of FIG. 19, and description thereof is omitted.

Next, the display control 76 generates data of the predetermined-area image Q, which corresponds to the predetermined area T, to be displayed in a display area of the display 517 of the smart phone 5. As described above in this example, the predetermined-area image Q is displayed so as to cover the entire display area of the display 517. In this example, the predetermined-area image Q includes the superimposed image S superimposed with the planar image P. The far-distance communication unit 71 transmits data of the predetermined-area image Q, which is generated by the display control 76, to the smart phone 5 (S46). The far-distance communication unit 51 of the smart phone 5 receives the data of the predetermined-area image Q.

The display control 56 of the smart phone 5 controls the display 517 to display the predetermined-area image Q including the superimposed image S (S47).

Accordingly, the image capturing system of this embodiment can achieve the advantages described above referring to the first embodiment.

Further, in this embodiment, the smart phone 5 performs image capturing, and the image processing server 7 performs image processing such as generation of superimposed display metadata and generation of superimposed images. This results in decrease in processing load on the smart phone 5. Accordingly, high image processing capability is not required for the smart phone 5.

In this embodiment, the smart phone 5 and the image processing server 7 may cooperate with each other to operate as the image processing system.

<Variation in Correcting Brightness or Color of Image>

Referring to FIG. 25, the brightness and color of the planar image P are corrected at S320 to match the brightness and color of the equirectangular projection image EC. In some cases, correction of the brightness and color should be performed, while considering such as exposure and white balance.

Generally, the special image capturing device 1 generates a spherical image, such that exposure and white balance are optimized over the entire coverage area, which is relatively a wide area. On the other hand, the generic image capturing device 3 generates a planar image, such that exposure and white balance are optimized in a focused area, which is narrower than the coverage area of the spherical image. Accordingly, image characteristics such as exposure and white balance tend to largely differ between the spherical image CE and the superimposed S (planar image P). If the planar image P is to be simply corrected to match brightness or color of the spherical image CE, such correction may not be desirable as the spherical image tends to have a part that is over exposed or under exposed.

### Third Embodiment

In view of this, in the third embodiment described below, the correction unit 584 corrects at least one of brightness and color of the superimposed image S, according to a ratio of an area of the superimposed image S (the planar image P) in the predetermined area T with respect to the predetermined area T.

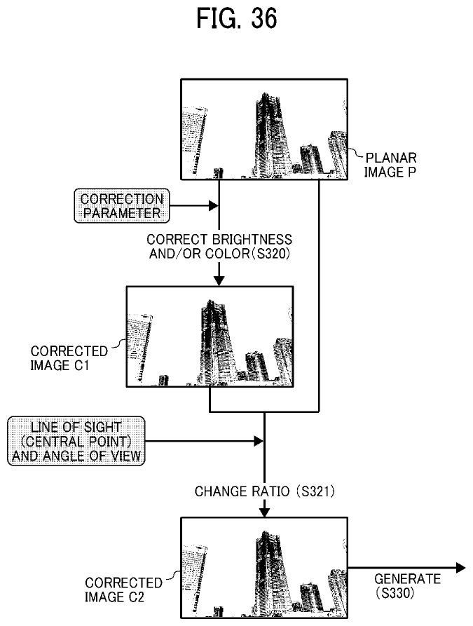

Referring now to FIGS. 36 to 42, operation of correcting the planar image P is described according to the third embodiment. For the descriptive purposes, the following assumes that the brightness and color of the superimposed image S (planar image P) are corrected. However, as described above, at least one of the brightness and color may be corrected.

FIG. 36 is a conceptual diagram illustrating processing to correct the planar image with images being processed or generated, according to this embodiment. More specifically, the following describes other example operation of correcting the planar image P, to be performed at S320 illustrated in FIG. 25. Here, a first corrected planar image C1 and a second corrected planar image C2 are generated, as the corrected planar image C having the brightness and color corrected.

As illustrated in FIG. 36, the correction unit 584 applies processing of S320 on the planar image P using the correction parameter in the superimposed display metadata, to generate the first corrected planar image C1 having the brightness and color corrected so as to match the brightness and color of the equirectangular projection image EC.

The correction unit 584 determines a combined ratio of the first corrected planar image C1 and the uncorrected planar image P to be used for generating the second corrected planar image C2, according to the imaging direction of the virtual camera IC (central point of the predetermined area T, which corresponds to the line of sight of the user) and the angle of view α of the virtual camera IC. The correction unit 584 generates the second corrected planar image C2 by combining the first corrected planar image C1 and the planar image P according to the determined combined ratio (S321). More specifically, in this embodiment, the correction unit 584 calculates a ratio of an area of the planar image P being displayed in the predetermined area T with respect to the predetermined area T, according to the central point of the predetermined area T and the angle of view α specifying a range (size) of the predetermined area T, with respect to the central point of the planar image P and the angle of view α specifying a range (size) of an area of the planar image.

The correction unit 584 corrects the brightness and the color of the superimposed image S, according to a ratio of an area of the superimposed image S to the predetermined area T.

At S330, the image generator 586 maps the second corrected image C2 on the partial sphere PS to generate the superimposed image S, as described above referring to FIG. 25.

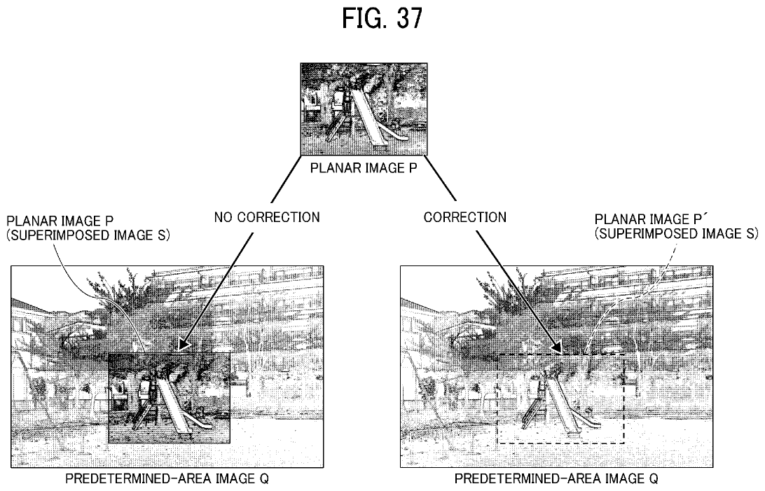

Next, S321 of changing the combined ratio of the corrected image C1 and the planar image P is described in detail. FIG. 37 illustrates an example superimposed image when the brightness and color of the planar image are corrected (right side), and an example superimposed image when the brightness and color of the planar image are not corrected (left side). In figure, P′ denotes the planar image P that has been corrected.

Referring to the image shown at the lower right of FIG. 37, the brightness and color of the planar image P are corrected to match the brightness and color of the predetermined-area image Q, i.e., an image of the predetermined area T of the spherical image CE. As illustrated in FIG. 37, the superimposed image S fits in the predetermined-area image Q, such that the user can hardly tell that the superimposed image S is superimposed on the predetermined-area image Q.

Referring to the image shown at the lower left of FIG. 37, the brightness and color of the planar image are not corrected, such that they do not match the brightness and color of the predetermined-area image Q. As illustrated in FIG. 37, it is obvious that the superimposed image S, which is a different image, is superimposed on the predetermined-area image Q.

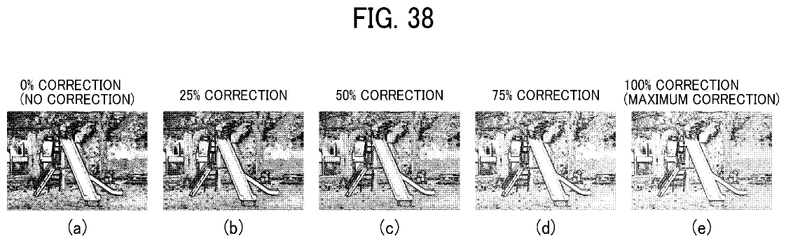

FIG. 38 illustrates example superimposed images having brightness and color that are corrected differently according to an area ratio of the superimposed image S to the predetermined-area image Q. While FIG. 37 illustrates only two cases, that is, the first case (right side) in which the image has been corrected and the second case (left side) in which the image has not been corrected, FIG. 38 illustrates five cases including the first case (a) to the fifth case (e).

Specifically, the image of the first case (a) is the superimposed image S that has not been corrected (0% correction). That is, the superimposed image S is generated with the brightness and color values of the uncorrected planar image P.

The image of the second case (b) is the superimposed image S with 25% (or 0.25) correction, which has pixel values generated by combining 25% (0.25) of brightness and color values of the predetermined-area image Q (equirectangular projection image EC) and 75% (0.75) of brightness and color values of the superimposed image S (planar image P). As described above referring to FIG. 36, 25% of brightness and color values of the first corrected planar image C1 and 75% of brightness and color values of the planar image P are combined.

The image of the second case (c) is the superimposed image S with 50% (or 0.50) correction, which has pixel values generated by combining 50% (0.50) of brightness and color values of the predetermined-area image Q (equirectangular projection image EC) and 50% (0.50) of brightness and color values of the superimposed image S (planar image P). As described above referring to FIG. 36, 50% of brightness and color values of the first corrected planar image C1 and 50% of brightness and color values of the planar image P are combined.

The image of the second case (d) is the superimposed image S with 75% (or 0.75) correction, which has pixel values generated by combining 75% (0.75) of brightness and color values of the predetermined-area image Q (equirectangular projection image EC) and 25% (0.25) of brightness and color values of the superimposed image S (planar image P). As described above referring to FIG. 36, 75% of brightness and color values of the first corrected planar image C1 and 25% of brightness and color values of the planar image P are combined.

The image of the second case (e) is the superimposed image S with 100% (or 1.00) correction, which has pixel values generated by combining 100% (1.00) of brightness and color values of the predetermined-area image Q (equirectangular projection image EC) and 0% (0.00) of brightness and color values of the superimposed image S (planar image P). That is, the superimposed image S is corrected to have the brightness and color values of the predetermined-area image Q. As described above referring to FIG. 36, 100% of brightness and color values of the first corrected planar image C1 and 0% of brightness and color values of the planar image P are combined.

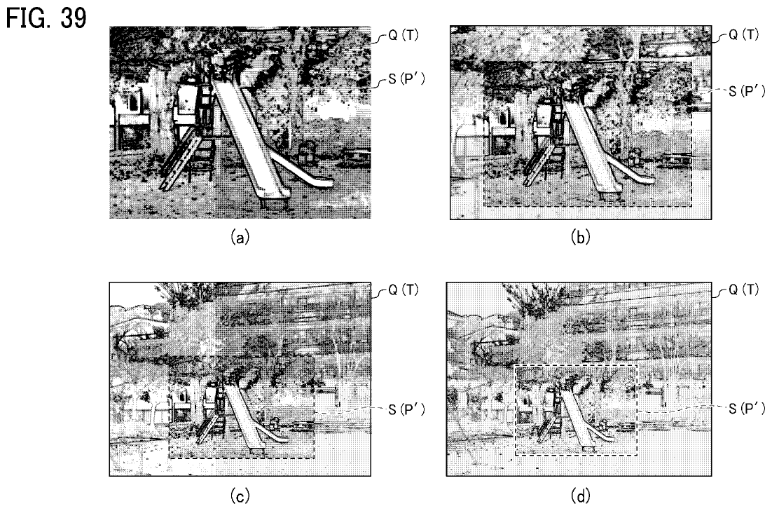

In this embodiment, as an area ratio of the planar image P (superimposed S) with respect to the predetermined area T (predetermined-area image Q) becomes smaller, the correction unit 584 corrects the brightness and color of the planar image P so as to reflect more of the brightness and color of the predetermined-area image Q. On the other hand, as an area ratio of the planar image P with respect to the predetermined area T becomes larger, the correction unit 584 tends to keep the brightness and color of the planar image P uncorrected so as to reflect more of the original value. FIG. 39 illustrates example cases of a predetermined-area image, displayed with the superimposed image S having brightness or color corrected according to an area ratio of the superimposed image S (planar image P′) to the predetermined-area image Q (predetermined area T). The area ratio of the superimposed image S (planar image P′) with respect to the predetermined-area image Q (predetermined area T) decreases, in this order, from the example cases (a), (b), (c), and (d). Accordingly, influences of correction to be performed on the superimposed S (planar image P′) to have brightness and color that match brightness and color of the predetermined-area image Q increase, in this order, from the example cases (a), (b), (c), and (d). That is, with the decrease in area ratio of the superimposed image S (planar image P′) with respect to the predetermined-area image Q (predetermined area T), the brightness and color of the superimposed image S (planar image P′) become closer to the brightness and color of the predetermined-area image Q, which is a part of the spherical image CE.

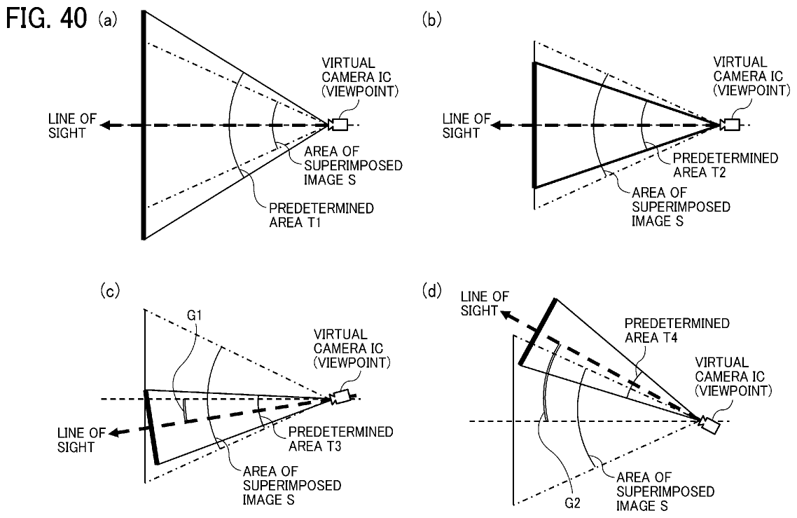

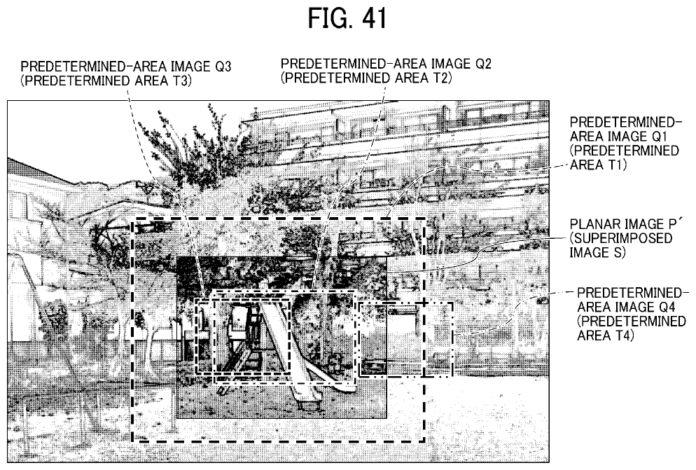

Referring now to FIGS. 40 and 41, a relationship between the imaging direction of the virtual camera IC (central point of the predetermined area T, which corresponds to the line of sight of the user) and the angle of view α of the virtual camera IC, and display of the superimposed image S (planar image P′) is described according to the embodiment. FIG. 40 illustrates a relationship between the predetermined area T and an area of the superimposed image S, which changes according to the imaging direction and the angle of view of the virtual camera IC. FIG. 41 illustrates the change in display of the predetermined-area image in relation to the superimposed image.

In the case (a) of FIG. 40 in which an area of the superimposed image S is within the predetermined area T1, a predetermined-area image Q1, which is an image of the predetermined area T1, is displayed as it surrounds the superimposed image S, as illustrated in FIG. 41.

In the case (b) of FIG. 40 in which a predetermined area T2 is within an area of the superimposed image S, a predetermined-area image Q2, which is an image of the predetermined area T2, is displayed as it is within the superimposed image S, as illustrated in FIG. 41.

In the case (c) of FIG. 40 in which about a half of the superimposed image S is within a predetermined area T3, as the central point of the superimposed image S that corresponds to the line of sight direction is shifted by an amount of shift G1, a predetermined-area image Q3, which is an image of the predetermined area T3, is displayed as it is within the superimposed image S toward left, as illustrated in FIG. 41.

In the case (d) of FIG. 40 in which about one third of the superimposed image S is within a predetermined area T4, as the central point of the superimposed image S that corresponds to the line of sight direction is shifted by an amount of shift G2, a predetermined-area image Q4, which is an image of the predetermined area T4, is displayed as illustrated in FIG. 41. When displayed, the predetermined-area image Q4 partly displays the superimposed image S.

The operation of correcting the superimposed image S according to an area ratio of the superimposed image S (planar image P) with respect to the predetermined-area image Q (predetermined area T) may be performed in various other ways. For example, in alternative to changing a combined ratio of brightness and color values of the first corrected planar image C1 and brightness and color values of the planar image P in generation of the second corrected planar image C2, the correction parameter may be adjusted beforehand.

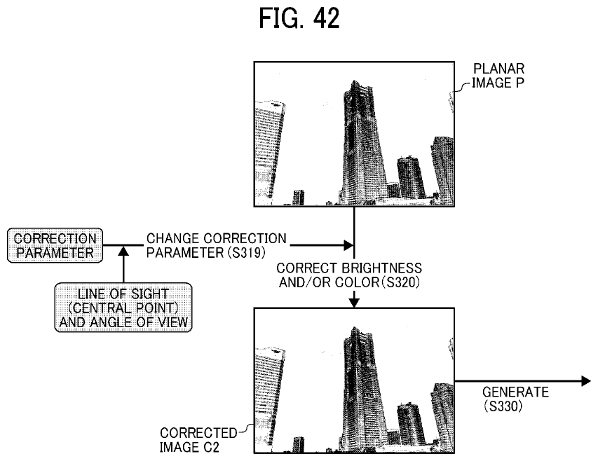

FIG. 42 is a conceptual diagram illustrating processing to correct the planar image according to this example. More specifically, the following describes other example operation of correcting the planar image P, to be performed at S320 illustrated in FIG. 25.

As illustrated in FIG. 42, the correction unit 584 adjusts the correction parameter, so as to change a ratio of an area of the planar image P with the predetermined area T according to the imaging direction of the virtual camera IC (central point of the predetermined area T, which corresponds to the line of sight of the user) and the angle of view α of the virtual camera IC (S319). The correction parameter is adjusted in a range between the maximum value causing the brightness and color of the planar image P to be corrected with the correction parameter having the originally calculated value, and the minimum value causing the brightness and color of the planar image P to be uncorrected.

The correction unit 584 performs processing of S320, as described above referring to FIG. 25, to generate the second corrected image C2.

As described above referring to FIG. 25, at S330, the image generator 586 maps the second corrected image C2 on the partial sphere PS to generate the superimposed image S.

### Fourth Embodiment

While the above-described third embodiment illustrates the example case in which the planar image P is corrected to be closer in brightness and color to the equirectangular planar image EC, both of the planar image P and the equirectangular planar image EC may be corrected so as to be closer in brightness and color, for example, as described below.

Further, correction of the planar image P or the equirectangular planar image EC may be performed in various ways, other than the above-described embodiment in which the degree of correction is controlled according to an area of the planar image P (superimposed image S) to be displayed in the predetermined area T (predetermined-area image Q).

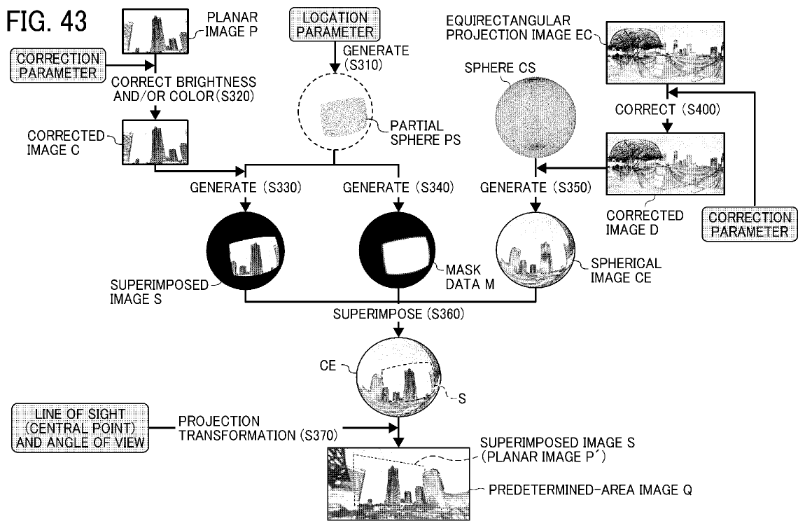

FIG. 43 is a conceptual diagram illustrating processing to correct the planar image and the equirectangular image with images being processed or generated, according to this embodiment. Compared to the operation described referring to FIG. 25, the operation of FIG. 43 additionally includes S400 of correcting color and brightness of the equirectangular projection image EC. At S400, the correction unit 584 corrects the brightness and color of the equirectangular projection image EC, using the correction parameter of the superimposed display metadata, to match the brightness and color of the planar image P. The equirectangular projection image EC that has been corrected at S400 is referred to as the “corrected equirectangular projection image D”.

The operation of FIG. 43 differs from the operation of FIG. 25 further in S320. In FIG. 43, the correction unit 584 controls an amount of correction of the brightness and color of the planar image P, according to an angle β between the line of sight direction and the central point of the planar image P. The correction of the equirectangular projection image EC at S400 may be performed in a substantially similar, according to the angle β between the line of sight direction and the central point of the planar image P.

Referring back to FIG. 36, correction of the planar image P is described according to this embodiment.

As described above, the correction unit 584 corrects the brightness and color of the planar image P so as to match the brightness and color of the equirectangular projection image EC (that is, the predetermined-area image Q), using the correction parameter of the superimposed display metadata, to generate the first corrected planar image C1 (S320).

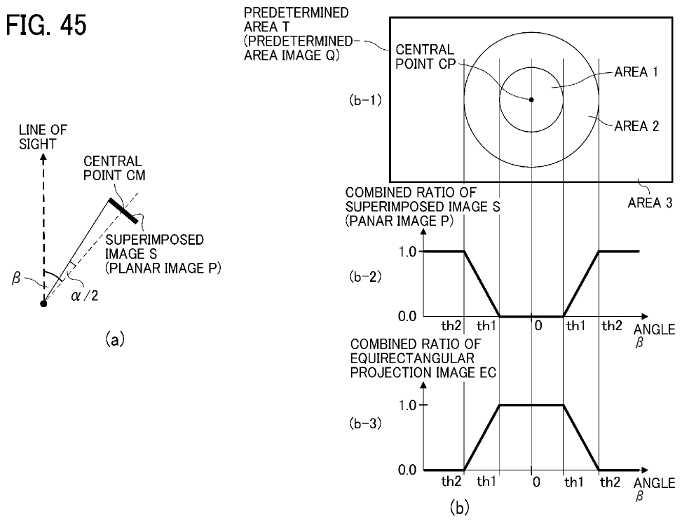

In this embodiment, S321 of determining a combined ratio of the first corrected planar image C1 and the planar image P is performed differently than the above-described embodiment. More specifically, in this embodiment, the correction unit 584 refers to the angle β between the imaging direction of the virtual camera IC (central point of the predetermined area T, which corresponds to the line of sight of the user) and the central point of the planar image P, to change the combined ratio of the first corrected planar image C1 and the planar image P. This processing results in generation of the second corrected planar image C2. In the following, the imaging direction of the virtual camera IC, which corresponds to the line of sight direction of the user, is referred to as the line of sight direction of the virtual camera IC. This operation of changing the combined ratio will be described in detail referring to FIG. 45.

At S330, the image generator 586 maps the second corrected planar image C2 on the partial sphere PS to generate the superimposed image S.

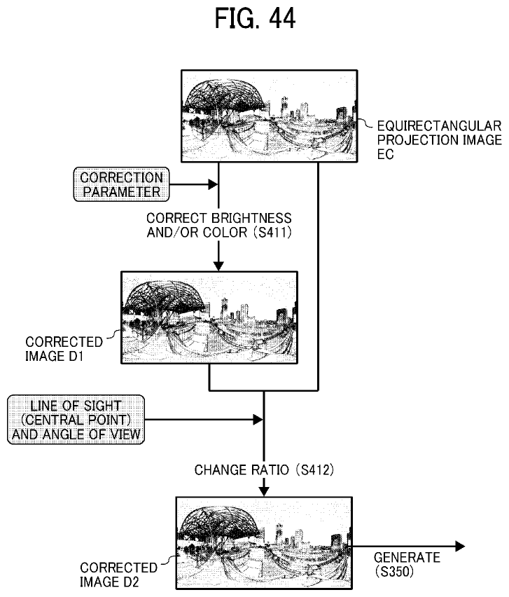

FIG. 44 is a conceptual diagram illustrating processing to correct the equirectangular projection image EC with images being processed or generated, according to this embodiment. The correction of the equirectangular projection image EC performed at S400 of FIG. 43 is now described in detail.

At S411, the correction unit 584 corrects the brightness and color of the equirectangular projection image EC, to match the brightness and color of the planar image P, to generate a first corrected equirectangular projection image D1. The correction parameter in the superimposed display metadata includes gain data for correcting the brightness and color of the planar image P, to match the brightness and color of the equirectangular projection image EC. The correction unit 584 is able to perform correction of S411, by multiplying the equirectangular projection image EC with an inverse of the gain data. The correction parameter of the superimposed display metadata is correction information to be used for matching the brightness and color in an area of the superimposed image S (planar image P′). Through applying the correction parameter to an entire area of the equirectangular projection image EC, an area other than the superimposed image S (planar image P′) may also be corrected, while the accuracy may decrease compared to the case of applying the correction parameter to the area of the superimposed image S (planar image P′).

At S412, the correction unit 584 refers to the angle β between the line of sight direction of the virtual camera IC and the central point of the superimposed image S (planar image P), which are defined by a user operation, to change the combined ratio of the first corrected equirectangular projection image D1 and the equirectangular projection image EC. This processing results in generation of a second corrected equirectangular projection image D2.

At S350, the image generator 586 maps the second corrected equirectangular projection image D2, over a surface of the sphere CS, to generate the spherical image CE.

FIG. 45 is an illustration for explaining operation of changing a combined ratio of the images according to the embodiment. The diagram (a) of FIG. 45 illustrates an angle β, as an amount of displacement (or shift) between the line of sight direction of the virtual camera IC and the central point CM of the superimposed image S (planar image P). As illustrated in FIG. 7, the line of sight direction of the virtual camera IC (that is, the line of sight of the user), which is previously determined, is equal to the central point CP of the predetermined area T. In this disclosure, the angle β is defined as a difference between the central point CP of the predetermined area T and the central point CM of the superimposed image S. The angle β has a value ranging from 0 to 180 degrees.

The diagram and graphs (b) of FIG. 45 illustrate how a combined ratio of images is changed according to the value of the angle β, in each of correction on the superimposed image S at S320 and correction on the equirectangular projection image EC at S400. The diagram (b-1) of (b) of FIG. 45 illustrates a range of the angle β. Centering on the central point CP of the predetermined area T (predetermined-area image Q), Area 1 represents values of angle β being equal to or less than a first threshold th1, and Area 2 (excluding the Area 1) represents values of angle β greater than th1 but being equal to or less than th2. Area 3 is an area within the predetermined area T, but not included in any of the Area 1 and Area 2. Accordingly, Area 3 represents values of angle β greater than th2. The first threshold th1 and the second threshold th2 may each be set by a service provider or a user according to, for example, empirical data, the user preference, etc.

First, operation of calculating a combined ratio of the first corrected planar image C1 and the planar image P is described according to the embodiment. The graph (b-2) of (b) of FIG. 45 illustrates a relationship between a combined ratio of the first corrected planar image C1 and the planar image P, and the angle β. The vertical axis represents a Combined ratio of the superimposed image S, having a value ranging from 0.0 to 1.0. The horizontal axis represents the angle β as illustrated in (b-1). The combined ratio of the superimposed image S is a combined ratio of the first corrected planar image C1 with respect to the planar image P to generate the second corrected planar image C2, as described above referring to FIG. 36. The first corrected planar image C1 is the image having the brightness and color corrected to match the brightness and color of the equirectangular projection image EC. In the case of combined ratio of 0.3, the second corrected planar image C2 has brightness and color values that are generated by combining 0.3 of brightness and color values of the first corrected planar image C1 and 0.7 of brightness and color values of the planar image P. In the case of combined ratio of 0.0, the second corrected planar image C2 becomes equivalent to the planar image P in brightness and color values. In the case of combined ratio of 1.0, the second corrected planar image C2 becomes equivalent to the first corrected planar image C1 in brightness and color values. With the combined ratio, the degree of correction to be performed on the planar image P to become closer in brightness and color to the first corrected planar image C1 can be controlled.

According to the graph (b-2) of (b) of FIG. 45, the combined ratio is 0.0 in the Area 1 (β is equal to or less than th1), such that the second corrected planar image C2 is the same as the planar image P. In the Area 2 (β is greater than th1 but equal to or less than th2), the combined ratio changes. As the angle β becomes closer to the value th2, the combined ratio of the first corrected planar image C1 increases. In the Area 3 (β is greater than th2), the combined ratio is 1.0 such that the second corrected planar image C2 is the same as the first corrected planar image C1.

When displaying the superimposed image S in the predetermined area T, as the superimposed image S is displayed closer to the center of the predetermined area T, that is, the central point CM of the superimposed image S becomes closer to the central point CP of the predetermined area T, the superimposed image S is displayed so as to reflect more of the brightness and color of the planar image P according to the combined ratio. As the superimposed image S is displayed farther from the center of the predetermined area T, that is, the central point CM of the superimposed image S becomes farther from the central point CP of the predetermined area T, the superimposed image S is displayed so as to reflect more of the brightness and color of the equirectangular projection image EC. At the boundary, the superimposed image S matches the equirectangular projection image EC in brightness and color.

The graph (b-3) of (b) of FIG. 45 illustrates a relationship between a combined ratio of the first corrected equirectangular projection image D1 and the equirectangular projection image EC, and the angle β. The vertical axis represents a combined ratio of the equirectangular projection image EC, having a value ranging from 0.0 to 1.0. The horizontal axis represents the angle β as illustrated in (b-1). The combined ratio of the equirectangular projection image EC is a combined ratio of the first corrected equirectangular projection image D1 with respect to the equirectangular projection image EC to generate the second corrected equirectangular projection image D2, as described above referring to FIG. 44. The first corrected equirectangular projection image D1 is the image having the brightness and color corrected to match the brightness and color of the planar image P. In the case of combined ratio of 0.3, the second corrected equirectangular projection image D2 has brightness and color values that are generated by combining 0.3 of brightness and color values of the first corrected equirectangular projection image D1 and 0.7 of brightness and color values of the equirectangular projection image EC. In the case of combined ratio of 0.0, the second corrected equirectangular projection image D2 becomes equivalent to the equirectangular projection image EC in brightness and color values. In the case of combined ratio of 1.0, the second corrected equirectangular projection image D2 becomes equivalent to the first corrected equirectangular projection image D1 in brightness and color values. With the combined ratio, the degree of correction to be performed on the equirectangular projection image EC to become closer in brightness and color to the first corrected equirectangular projection image D1 can be controlled.

The graphs (b-2) and (b-3) of FIG. 45 have the values of combined ratio covering in the same range of the angle β. Further, the graph indicating the combined ratio of the equirectangular projection image EC is reverse of the graph indicating the combined ratio of the superimposed image S. In the Area 2, a sum of the combined ratios for the superimposed image S and the equirectangular projection image EC becomes 1.0.

According to the graph (b-3) of (b) of FIG. 45, the combined ratio is 1.0 in the Area 1 (β is equal to or less than th1), such that the second corrected equirectangular projection image D2 is the same as the first corrected equirectangular projection image D1 in brightness and color values. In the Area 2 (β is greater than th1 but equal to or less than th2), the combined ratio changes. As the angle β becomes closer to the value th2, the combined ratio of the first corrected equirectangular projection image D1 increases. In the Area 3 (β is greater than th2), the combined ratio is 0.0 such that the second corrected equirectangular projection image D2 is the same as the equirectangular projection image EC in brightness and color values.

When displaying the superimposed image S in the predetermined area T, as the superimposed image S is displayed closer to the center of the predetermined area T, that is, the central point CM of the superimposed image S becomes closer to the central point CP of the predetermined area T, the equirectangular projection image EC is displayed according to the combined ratio, as the first corrected equirectangular projection image D1 having brightness and color corrected so as to reflect more of brightness and color of the planar image P. As the superimposed image S is displayed farther from the center of the predetermined area T, that is, the central point CM of the superimposed image S becomes farther from the central point CP of the predetermined area T, the equirectangular projection image EC is displayed while maintaining much of its original brightness and color values.

As a difference between the line of sight direction in the equirectangular projection image EC and the center of the superimposed image S decreases, corrected amounts of pixel values of the planar image P become smaller. That is, the equirectangular projection image EC is corrected such that its pixel values become closer to pixel values of the planar image P. As a difference between the line of sight direction in the equirectangular projection image EC and the center of the superimposed image S increases, corrected amount of pixel values of the equirectangular projection image EC become smaller, such that its pixel values keep original values.

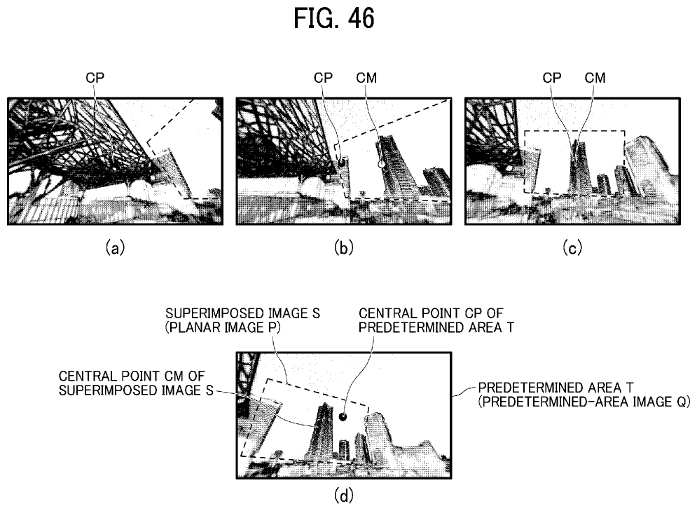

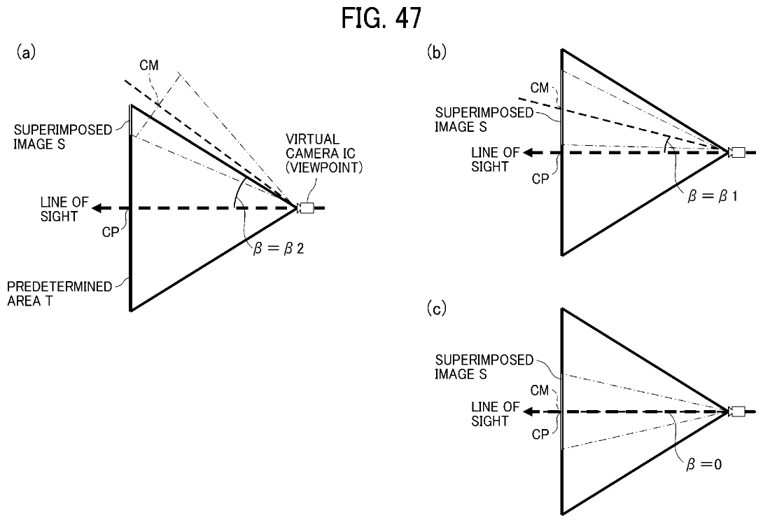

Referring to FIGS. 46 and 47, a relation between the line of sight direction of the virtual camera IC (the central point CP of the predetermined area T) and the central point CM of the superimposed image S is described. The image (d) of FIG. 46 is an image of the predetermined area T (predetermined-area image Q), which is displayed differently according to a line of sight direction in the spherical image CE. The central point CP of the predetermined area T corresponds to the line of sight direction of the virtual camera IC, which is expressed by the black dot. The area where the superimposed image S is superimposed on the spherical image CE is shown by dashed lines, with its central point CM being expressed by a white dot. It is to be noted that the black dot indicating the central point CP, and the white dot indicating the central point CP are only shown for the descriptive purposes, such that they are not to be actually displayed. Further, the dashed lines may or may not be displayed. The central point CM of the superimposed image S, relative to the central point CP of the predetermined area T, may be freely changed by user operation.

FIG. 46 illustrates images to be displayed, when the line of sight direction of the virtual camera IC is changed by user operation on the spherical image CE, for the respective example cases (a), (b), and (c). FIG. 47 are diagrams that respectively correspond to the example cases (a), (b), and (c) of FIG. 46, each explaining a relation between the predetermined area T and the superimposed image S.

Referring to the case (a) of FIGS. 46 and 47, the central point CM of the superimposed image S is shifted toward the right, in a great distance from the line of sight direction of the virtual camera IC (central point CP of the predetermined area T) such that the central point CM is not within the predetermined area T. In such case, as illustrated in FIG. 47, the angle β between the line of sight direction and the central point CM of the superimposed image S has relatively a large value, and is expressed as β2.

Referring to the case (b) of FIGS. 46 and 47, the central point CM of the superimposed image S is shifted toward the right, from the line of sight direction of the virtual camera IC (central point CP of the predetermined area T), but within the predetermined area T. In such case, as illustrated in FIG. 47, the angle β between the line of sight direction and the central point CM of the superimposed image S has relatively a small value, and is expressed as β1.

Referring to the case (c) of FIGS. 46 and 47, the central point CM of the superimposed image S matches the line of sight direction of the virtual camera IC (central point CP of the predetermined area T), in the predetermined area T. In such case, as illustrated in FIG. 47, the angle β between the line of sight direction and the central point CM of the superimposed image S is 0.

In the case (a) in which the central point CM of the superimposed image S is away from the central point CP of the predetermined area T, the user is viewing the spherical image CE. It is thus desirable to display the image with the brightness and color values of the spherical image CE, to reflect the exposure of the spherical image CE. In the case (c) in which the central point CM of the superimposed image S substantially matches the central point CP of the predetermined area T, the user is viewing the superimposed image S. It is thus desirable to display the image with the brightness and color values of the superimposed image S, to reflect the exposure of the superimposed image S. As described above referring to FIG. 45, in this embodiment, the correction unit 584 corrects the brightness and color of the second corrected planar image C2 and the second corrected equirectangular projection image D2 according to the combined ratio. The combined ratio changes as a difference between the central point CM of the superimposed image S and the central point CP of the predetermined area T changes. Accordingly, brightness and color of the spherical image CE and the planar image P are corrected, while taking into consideration the user's viewpoint.

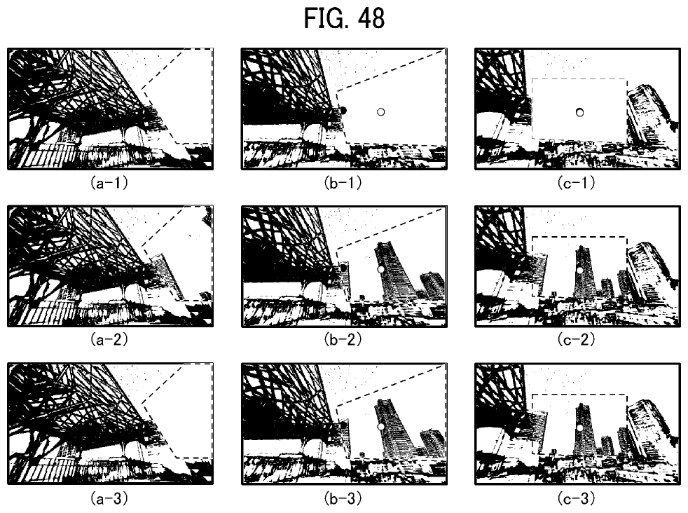

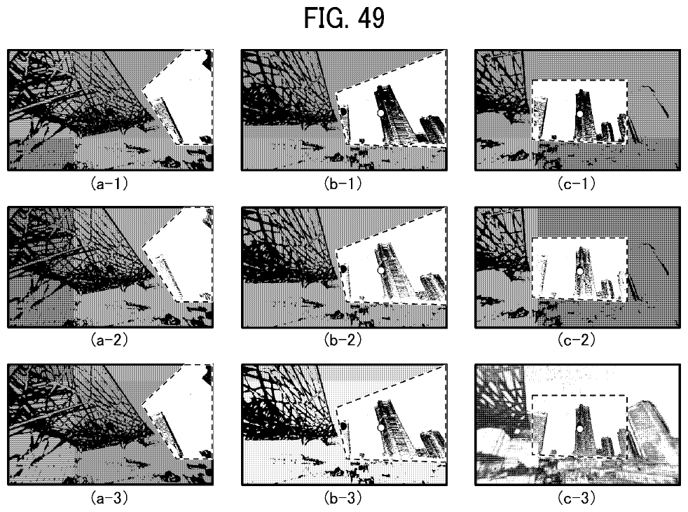

Referring to FIGS. 48 and 49, effects in correcting the images are described according to the embodiment. FIG. 48 illustrates how the overexposed spherical image CE is corrected, when the line of sight direction of the virtual camera IC changes for the example cases (a) to (c) described in FIGS. 46 and 47. It is assumed that the planar image P, to be superimposed on the spherical image CE, is a correctly-exposed image. It is assumed that the spherical image CE is overexposed, such that it has a brighter area.

The images (a-1), (b-1), and (c-1) of FIG. 48, which respectively correspond to the cases (a), (b), and (c) of FIGS. 46 and 47, are each generated by correcting the brightness and color of the superimposed image S to match the brightness and color of the spherical image CE. Since the brightness and color of the superimposed image S are corrected to match the brightness and color of the overexposed spherical image CE, all images (a-1), (b-1), and (c-1) to be displayed are overexposed, even when the line of sight direction of the virtual camera IC changes. That is, even when the central point CM of the superimposed image S coincides with the central point CP of the predetermined area T, the image look overexposed.

The images (a-2), (b-2), and (c-2) of FIG. 48, which respectively correspond to the cases (a), (b), and (c) of FIGS. 46 and 47, are each generated by not correcting the brightness and color of the superimposed image S. Since the superimposed image S is not corrected, the planar image P is displayed with its original brightness and color values, with right exposure. However, compared to the images (a-1), (b-1), and (c-1), the spherical image CE and the superimposed image S look different due to large differences in brightness and color. Accordingly, the superimposed image S does not fit in the spherical image CE, which may cause the user to feel awkward. For the images (a-2), (b-2), and (c-2), the correctly-exposed superimpose image S stands out.

The images (a-3), (b-3), and (c-3) of FIG. 48, which respectively correspond to the cases (a), (b), and (c) of FIGS. 46 and 47, are each generated by correcting the brightness and color of the superimposed image S, according to the calculated combined ratio. Referring to (a-3) of FIG. 48, since the central point CM of the superimposed image S is away from the line of sight direction of the virtual camera IC (the central point CP of the predetermined area T), the image does not look so much different from the image for the case (a-1) of FIG. 48. Referring to (b-3) of FIG. 48, as the central point CM of the superimposed image S becomes closer to the line of sight direction of the virtual camera IC (the central point CP of the predetermined area T), the spherical image CE and the superimposed image S are combined according to a combined ratio, which causes to reflect more of the brightness and color of the correctly exposed planar image P. As described referring to FIG. 45, the combined ratio of the first corrected equirectangular projection image D1 having brightness and color matched with those of the planar image P with right exposure increases for the spherical image CE. On the other hand, the combined ratio of the first corrected planar image C1 having brightness and color matched with those of the equirectangular projection image EC decreases for the superimposed image S, causing more of brightness and color of the correctly-exposed planar image P to be reflected. This lowers effects of the overexposed image CE in the predetermined area T.

Referring to (c-3) of FIG. 48, the central point CM of the superimposed image S becomes closer to the line of sight direction of the virtual camera IC (the central point CP of the predetermined area T), so as to substantially coincide with each other. Accordingly, the combined ratio increases to its maximum value, to reflect the brightness and color of the correctly exposed planar image P. The image is displayed in the predetermined area T with right exposure, based on the brightness and color of the planar image P.

In this order, from (a-3), (b-3), and (c-3), the brightness and color of the spherical image CE become closer to the brightness and color of the planar image P.

For the images (a-3), (b-3), and (c-3), the spherical image CE and the superimposed image S are both corrected. Unlike the images (a-2), (b-2), and (c-2), the spherical image CE and the superimposed image S dot not differ much in brightness and color. Accordingly, the superimposed image S fits in the spherical image CE.

FIG. 49 illustrates how the underexposed spherical image CE is corrected, when the line of sight direction of the virtual camera IC changes for the example cases (a) to (c) described in FIGS. 46 and 47. It is assumed that the planar image P, to be superimposed on the spherical image CE, is a correctly-exposed image. It is assumed that the spherical image CE is underexposed, such that it has a darker area.

The images (a-1), (b-1), and (c-1) of FIG. 49, which respectively correspond to the cases (a), (b), and (c) of FIGS. 46 and 47, are each generated by correcting the brightness and color of the superimposed image S to match the brightness and color of the spherical image CE. The images (a-1), (b-1), and (c-1) of FIG. 49 are all dark, indicating that these are underexposed. Since the brightness and color of the superimposed image S are corrected to match the brightness and color of the underexposed spherical image CE, all images (a-1), (b-1), and (c-1) to be displayed are underexposed, even when the line of sight direction of the virtual camera IC changes. That is, even when the central point CM of the superimposed image S coincides with the central point CP of the predetermined area T, the image look underexposed.

The images (a-2), (b-2), and (c-2) of FIG. 49, which respectively correspond to the cases (a), (b), and (c) of FIGS. 46 and 47, are each generated by not correcting the brightness and color of the superimposed image S. Even if the superimposed image S is displayed with correct exposure, the spherical image CE and the superimposed image S look different due to large differences in brightness and color. Accordingly, the superimposed image S does not fit in the spherical image CE, which may cause the user to feel awkward.

The images (a-3), (b-3), and (c-3) of FIG. 49, which respectively correspond to the cases (a), (b), and (c) of FIGS. 46 and 47, are each generated by correcting the brightness and color of the superimposed image S, according to the calculated combined ratio. Referring to (a-3) of FIG. 49, since the central point CM of the superimposed image S is away from the line of sight direction of the virtual camera IC (the central point CP of the predetermined area T), the image does not look so much different from the image for the case (a-1) of FIG. 49. Referring to (b-3) of FIG. 49, as the central point CM of the superimposed image S becomes closer to the line of sight direction of the virtual camera IC (the central point CP of the predetermined area T), the spherical image CE and the superimposed image S are combined according to a combined ratio, which causes to reflect more of the brightness and color of the correctly exposed planar image P. As described referring to FIG. 45, the combined ratio of the first corrected equirectangular projection image D1 having brightness and color matched with those of the planar image P increases for the spherical image CE. On the other hand, the combined ratio of the first corrected planar image C1 having brightness and color matched with those of the equirectangular projection image EC decreases for the superimposed image S, causing more of brightness and color of the correctly-exposed planar image P to be reflected. This lowers effects of the underexposed image CE in the predetermined area T.

Referring to (c-3) of FIG. 49, the central point CM of the superimposed image S becomes closer to the line of sight direction of the virtual camera IC (the central point CP of the predetermined area T), so as to substantially coincide with each other. Accordingly, the combined ratio increases to its maximum value, to reflect the brightness and color of the correctly exposed planar image P. The image is displayed in the predetermined area T with right exposure, based on the brightness and color of the planar image P. Accordingly, even when the spherical image CE is underexposed, the image of the predetermined area T is not affected much by such underexposed image.

### Fifth Embodiment

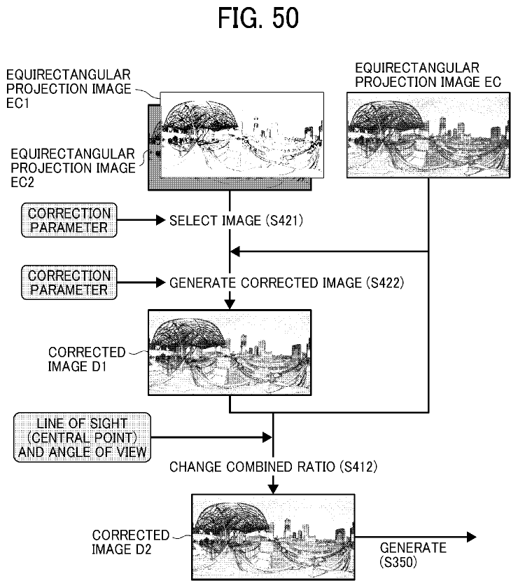

Referring now to FIGS. 50 to 52, operation of correcting the image using at least two equirectangular projection images that differ in exposure is described according to the fifth embodiment.

FIG. 50 is a conceptual diagram illustrating processing to correct the equirectangular projection image EC with images being processed or generated, according to the fifth embodiment. FIG. 50 specifically illustrates other example of correcting the equirectangular projection image EC performed at S400 of FIG. 43.

In this embodiment, a plurality of equirectangular projection images EC1 and EC2 that differ in exposure are used, in addition to the equirectangular projection image EC from which the spherical image is generated. The special image capturing device 1 generates the equirectangular projection images, while just changing exposure, for example, when capturing the target object and its surroundings to generate the equirectangular projection image EC. In this embodiment, it is assumed that at least the equirectangular projection image EC1 with exposure higher than that of the equirectangular projection image EC, and the equirectangular projection image EC2 with exposure lower than that of the equirectangular projection image EC are obtained. For simplicity, the equirectangular projection image EC1 and the equirectangular projection image EC2 are respectively referred to as the overexposed image EC1 and the underexposed image EC2. Alternatively, three or more than three equirectangular projection images that differ in exposure may be generated.

At S421, the correction unit 584 selects an image to be combined with the equirectangular projection image EC, to generate the first corrected equirectangular projection image D1. This selection of image is performed using the correction parameter of the superimposed display metadata. The correction parameter in the superimposed display metadata includes gain data for correcting the brightness and color of the planar image P, to match the brightness and color of the equirectangular projection image EC. The correction unit 584 calculates an inverse of the gain, which is used for correcting the equirectangular projection image EC to have brightness and color values of the planar image P. The inverse of the gain is referred to as inverse gain data. When the inverse gain data has a value equal to or greater than 1.0, the correction unit 584 corrects the equirectangular projection image EC to make it brighter. When the inverse gain data has a value less than 1.0, the correction unit 584 corrects the equirectangular projection image EC to make it darker.

At S422, the correction unit 584 generates the first corrected equirectangular projection image D1 so as to match brightness and color of the planar image P. In case the inverse gain data has the value 1.0 or greater, the correction unit 584 selects the overexposed image EC1. In case the inverse gain data has the value less than 1.0, the correction unit 584 selects the underexposed image EC2. The second corrected equirectangular projection image D2 is generated according to the combined ratio that is calculated at S412, in a substantially similar manner as described above.

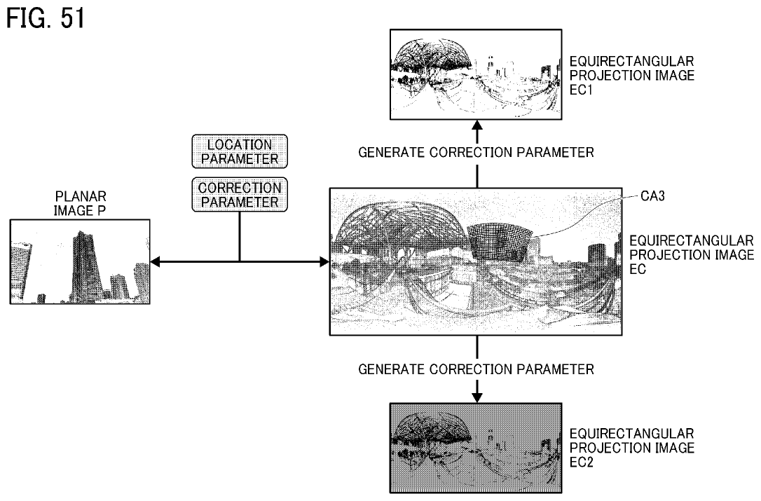

FIG. 51 is an illustration for explaining a relation between the location parameter and the correction parameter, when the plurality of equirectangular projection image EC1 and EC2 that differ in exposure is used. The superimposed display metadata includes the location parameter and the correction parameter, for each of the planar image P and the equirectangular projection image EC.

Since the equirectangular projection image EC, overexposed image EC1, and underexposed image EC2 are generated by capturing the same target object and surroundings but with different exposure, the location parameter is common to those images. However, the correction parameter is applicable only to the equirectangular projection image EC. The correction parameter is obtained as follows for at least one of the overexposed image EC1 and the underexposed image EC2 that has been selected. The correction unit 584 specifies a third area CA3 in the overexposed image EC1, which corresponds to the third area CA2 in the equirectangular projection image EC, using the location parameter, to obtain brightness and color values of pixels in the third area CA3 of the overexposed image EC1. Similarly, the correction unit 584 specifies a third area CA3 in the underexposed image EC2, which corresponds to the third area CA2 in the equirectangular projection image EC, using the location parameter, to obtain brightness and color values of pixels in the third area CA3 of the underexposed image EC2.

The correction unit 584 then calculates a ratio of brightness and color values in the third area CA3, between the equirectangular projection image EC and the overexposed image EC1. Similarly, the correction unit 584 calculates a ratio of brightness and color values in the third area CA3, between the equirectangular projection image EC and the underexposed image EC2.

In this embodiment, the brightness of the third area CA3 in the equirectangular projection image EC, overexposed image EC1, and underexposed image EC2, are respectively represented by Y, Y1, and Y2. The brightness ratio of the overexposed image EC1 to the equirectangular projection image EC is expressed as Y1/Y. The brightness ratio of the underexposed image EC2 to the equirectangular projection image EC is expressed as Y2/Y. This brightness ratio is multiplied with the correction parameter for correcting brightness, which has been calculated for the equirectangular projection image EC, to obtain the correction parameter for at least the selected one of the overexposed image EC1 and the underexposed image EC2.

In a substantially similar manner, the correction parameter for correcting color is calculated, for at least the selected one of the overexposed image EC1 and the underexposed image EC2.

In alternative to generating a brightness ratio (or color ratio), the correction parameter may be generated for at least the selected one of the overexposed image EC1 and the underexposed image EC2 in a substantially similar manner as described above for the case of the equirectangular projection image EC.

Referring back to FIG. 50, at S422, the correction unit 584 generates the first corrected equirectangular projection image D1 using the correction parameter that is calculated for at least the selected one of the overexposed image EC1 and the underexposed image EC2 as described above.

S422 of generating the corrected image is described according to the embodiment. It is assumed that the correction parameters for the equirectangular projection image EC, overexposed image EC1, and underexposed image EC2 are respectively PC, PC1, and PC2. The correction parameter PC is gain data for correcting the brightness and color of the equirectangular projection image EC to match the brightness and color of the planar image P. When the correction parameter is 1.0, the planar image P and the equirectangular projection image EC are substantially the same in brightness and color.

At S422, the correction unit 584 generates the first corrected equirectangular projection image D1, from at least the selected one of the overexposed image EC1 and the underexposed image EC2, so as to match the brightness and color of the planar image P. For example, it is assumed that the correction parameters PC, PC1, and PC2 are respectively 1.2, 1.6, and 0.8. In such case, the inverse gain data is 1/PC=0.833, which is less than 1.0. In such case, at S421, the correction unit 584 selects the underexposed image EC2 to make the equirectangular projection image EC darker.

Next, at S422, the correction unit 584 calculates a combined ratio of the equirectangular projection image EC and one of the overexposed image EC1 and the underexposed image EC2 that is selected at S421. Assuming that the combined ratio of the equirectangular projection image EC and selected one of the overexposed image EC1 and the underexposed image EC2 is k, with k being a value ranging from 0.0 to 1.0, the combined ratio k is calculated using Equation 16 or Equation 17.

k/PC+(1−k)/PC1=1.0 (Equation 16)

k/PC+(1−k)/PC2=1.0 (Equation 17)

Equation 16 is used when the overexposed image EC1 is selected at S421. Equation 17 is used when the underexposed image EC2 is selected at S421.

In case the underexposed image EC2 is selected, the combined ratio k that is calculated using Equation 17 is 0.60. With the combined ratio of 0.60, 0.60 of the equirectangular projection image EC and (1−k)=0.40 of the underexposed image EC2 are combined to generate the first corrected equirectangular projection image D1. This results in generation of the first corrected equirectangular projection image D1 having the brightness and color values closer to the brightness and color values of the planar image P. Since processing of S412 and after S412 is substantially the same as described above, description thereof is omitted.

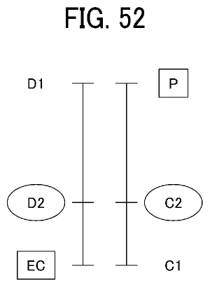

FIG. 52 is an illustration for explaining generation of the corrected images C2 and D2 having the brightness and color corrected, according to the embodiment. FIG. 52 schematically illustrates the difference in brightness and color between the equirectangular projection image EC and the planar image P. In FIG. 52, the brightness and color values increase with the upward direction, and the brightness and color decrease with the downward direction. The equirectangular projection image EC and the first corrected equirectangular projection image D1 are combined according to the determined combined ratio, to generate the second corrected equirectangular projection image D2. The planar image P and the first corrected planar image C1 are combined according to the determined combined ratio to generate the second corrected planar image C2. As illustrated in FIG. 45, the combined ratio to be used for generating the corrected image is reversed, between the equirectangular projection image EC and the superimposed image S. Accordingly, as illustrated in FIG. 52, the second corrected equirectangular projection image D2 and the second corrected planar image C2 match in brightness and color.

### Sixth Embodiment

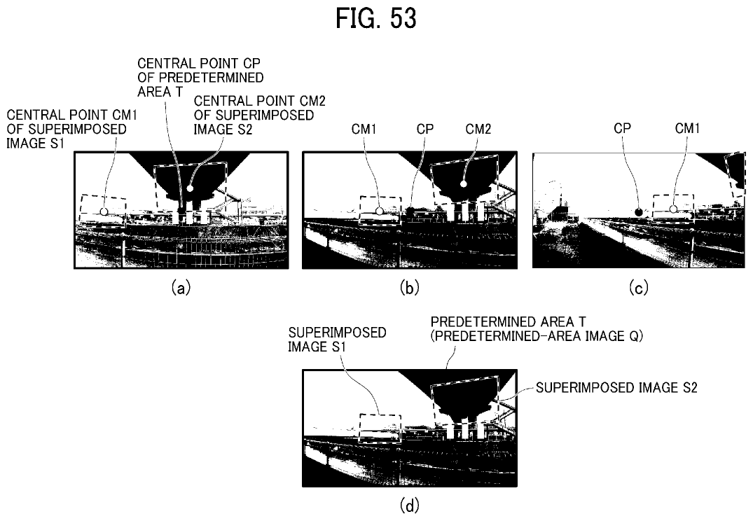

Referring now to FIGS. 53 to 58, operation of correcting the image is described according to the sixth embodiment. In any one of the above-described embodiments, one superimposed image S is superimposed on the equirectangular projection image EC. However, in this embodiment, a plurality of superimposed images S is superimposed on the equirectangular projection image EC.

In the image capturing system illustrated in FIG. 8, one special image capturing device 1 and one generic image capturing device 3 cooperate with each other to capture a pair of the equirectangular projection image EC and the planar image P at substantially the same time. In case the target object is a still object, the user may capture the target object while changing at least one of the imaging direction and the angle of view of the generic image capturing device 3, to obtain other planar image P. In such case, it is assumed that a location where the target object is captured is not changed. The smart phone 5 may superimpose the other planar image P on the equirectangular projection image EC, in addition to superimposing the planar image P on the equirectangular projection image EC.

When more than one generic image capturing device 3 is provided in the image capturing system, the generic image capturing devices 3 may capture planar images of the target object with different imaging directions and angle of views, at the same time. For example, the smart phone 5 includes two cameras at front and back, such that the smart phone 5 is able to capture two planar images at one shot.

The following describes example cases in which a plurality of superimposed images S (planar images P) are superimposed on the equirectangular projection image EC.

FIG. 53 illustrates an image of a predetermined area T, when the equirectangular projection image EC is superimposed with a plurality of superimposed images S, according to the embodiment. In this example case (d) of FIG. 53, the predetermined area T is displayed, while the superimposed images S1 and S2 are being superimposed on the equirectangular projection image EC.

FIG. 53 illustrates images to be displayed in the predetermined area T, when the line of sight direction of the virtual camera IC is changed by user operation on the spherical image CE, for the respective example cases (a), (b), and (c). The central point CP of the predetermined area T is represented by a black dot. The central points CM1 and CM2 of the superimposed images S1 and S2 are represented by white dots. It is to be noted that the black dot indicating the central point CP, and the white dots indicating the central points CM1 and CM2 are only shown for the descriptive purposes, such that they are not to be actually displayed. Further, the dashed lines indicating a boundary of the superimposed image S may or may not be displayed.

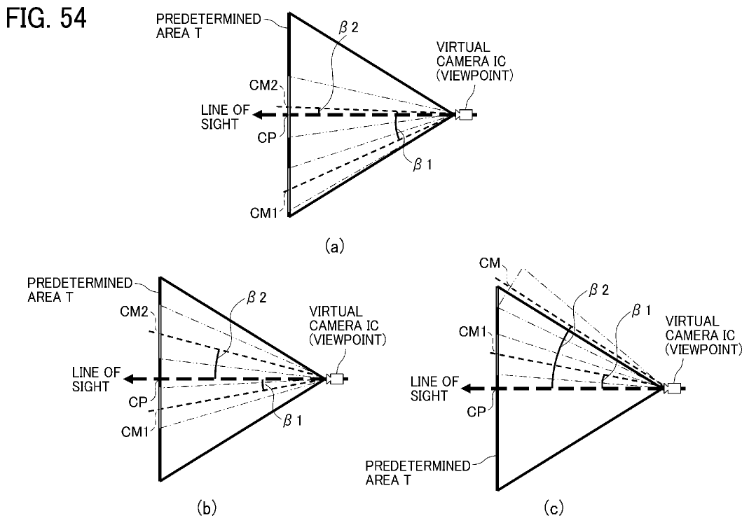

FIG. 54 are diagrams that respectively correspond to the example cases (a), (b), and (c) of FIG. 53, each for explaining a relation between the line of sight direction and the central point CM1 of the superimposed image S1 or the central point CM2 of the superimposed image S2.

Even when the plurality of superimposed images S are superimposed on the equirectangular projection image EC in the predetermined area T, brightness and color of all of the superimposed images S are made closer to brightness and color of one equirectangular projection image EC. In contrary, for the equirectangular projection image EC, there is a plurality of planar images, which could be a target for correcting brightness and color. In view of this, in this embodiment, one of the planar images is selected as a target for correction, using any one of the following first to third methods. Alternatively, a plurality of planar images may be combined to obtain a target value for at least one of brightness and color, as a target for correction.

According to the first method, the planar image as a target for correction is determined based on the angle β between the line of sight direction (the central point CP of the predetermined area T) and the superimposed image S (the central point CM of the superimposed image S). In one example, the correction unit 584 selects one of the superimposed images S having the smallest value of angle β between the line of sight direction and the superimposed image S, as a target for correction. For example, in the case (a) of FIGS. 53 and 54, the superimposed image S1 has the angle β1 with the line of sight direction, and the superimposed image S2 has the angle β2 with the line of sight direction, with β1 being greater than β2. In such case, the correction unit 584 selects the superimposed image S2 having the smallest value of angle β as a target for correction. In the case (b) of FIGS. 53 and 54, since β1 is smaller than β2, the correction unit 584 selects the superimposed image S1 having the smallest value of angle β as a target for correction. In the case (c) of FIGS. 53 and 54, since β1 is smaller than β2, the correction unit 584 selects the superimposed image S1 having the smallest value of angle β as a target for correction.

In another example, the correction unit 584 combines the superimposed images S to generate a combined image, while changing a combined ratio of the superimposed images according to the angle β between the line of sight direction and the superimposed image S. Specifically, the correction unit 584 calculates the combined ratio, from a weighted average of the superimposed images causing the superimposed image having the smallest value of angle β to be combined by a higher combined ratio.

It is assumed that the superimposed image S1 has the angle β1 with the line of sight direction, and the superimposed image S2 has the angle β2 with the line of sight direction. For example, in the case (a) of FIGS. 53 and 54, the combined ratio of the superimposed image S1 is β2/(β1+β2), and the combined ratio of the superimposed image S2 is β1/(β1+β2). The combined ratio of the superimposed image may be calculated in a substantially similar manner for other cases (b) and (c) of FIGS. 53 and 54. Accordingly, the first corrected equirectangular projection image EC1 has brightness and color values that reflect brightness and color values of the plurality of planar images P1 and P2. The method for calculating the value for at least one of brightness and color, as a target for correction, from the combined ratio will be described later.

According to the second method, the planar image as a target for correction is determined, based on a ratio of an area of the superimposed image with respect to the predetermined area T, that is, an area of the superimposed image being displayed (to be displayed) in the predetermined area T. Here, according to the change in line of sight and angle of view of the virtual camera IC, for example, due to the user operation, an area of the superimposed image to be displayed in the predetermined area T changes. With this change in area, the combined ratio is calculated to control the brightness and color of the image to be displayed.

In one example, the correction unit 584 selects one of the superimposed images S having the largest value of an area of the superimposed image being displayed in the predetermined area T, as a target for correction. For example, in the case (a) of FIGS. 53 and 54, the superimposed image S1 has the area SS1 being displayed in the predetermined area T, and the superimposed image S2 has the area SS2 being displayed in the predetermined area T, with SS1 being smaller than SS2. In such case, the correction unit 584 selects the superimposed image S2 having the largest displayed superimposed image area as a target for correction. In the case (b) of FIGS. 53 and 54, as SS1 is smaller than SS2, the correction unit 584 selects the superimposed image S2 having the largest displayed area as a target for correction. In the case (c) of FIGS. 53 and 54, the superimposed image S2 is merely displayed in the predetermined area T, such that SS1 is larger than SS2. In such case, the superimposed image S1 is selected as a target for correction.

In another example, the correction unit 584 combines the superimposed images S to generate a combined image, while changing a combined ratio of the superimposed images according to an area of the superimposed image S being displayed in the predetermined area T. Specifically, the correction unit 584 calculates the combined ratio, from a weighted average of areas of the superimposed images S causing the superimposed image having the largest display area to be combined by a higher combined ratio.

It is assumed that the superimposed image S1 has the area SS1 being displayed in the predetermined area T, and the superimposed image S2 has the area SS2 being displayed in the predetermined area T. In the case (a) of FIGS. 53 and 54, the combined ratio of the superimposed image S1 is SS1/(SS1+SS2), and the combined ratio of the superimposed image S2 is SS2/(SS1+SS2). The combined ratio of the superimposed image may be calculated in a substantially similar manner for other cases (b) and (c) of FIGS. 53 and 54. Accordingly, the first corrected equirectangular projection image EC1 has brightness and color values that reflect brightness and color values of the plurality of planar images P1 and P2. The method for calculating the value for at least one of brightness and color, as a target for correction, from the combined ratio will be described later.

The third method is a combination of the first method and the second method described above. The correction unit 584 selects one of the superimposed images S as a target for correction, based on the angle β between the line of sight direction (the central point CP of the predetermined area T) and the superimposed image S, and an area of the superimposed image S being displayed in the predetermined area T. For example, the correction unit 584 selects the superimposed image S having the angle β that is equal to or less than a given value, and having the largest area being displayed in the predetermined area T, as a target for correction.

Alternatively, the correction unit 584 changes a combined ratio of the superimposed images S, such that the superimposed image S with the smaller value of angle β and the larger displayed area, is combined with higher combined ratio. There are various other combinations of the first method and the second method.

Next, operation of correcting the equirectangular projection image EC and the planar image P, so as to have brightness and color that are close to brightness and color of the target for correction, is described according to the embodiment.

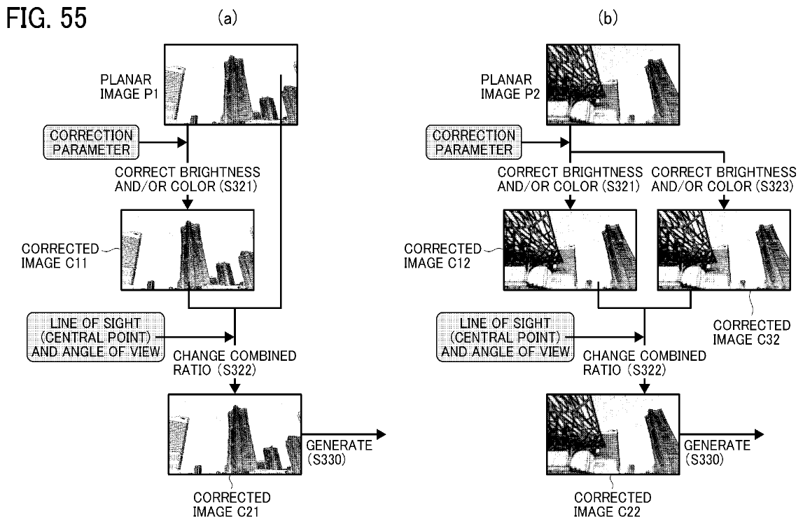

FIG. 55 is a conceptual diagram illustrating processing to correct the planar images P1 and P2 with images being processed or generated, according to the embodiment. In FIG. 55, the planar image P1 is selected as a target for correction using any one of the above-described selection methods. The flow (a), which is shown at left of FIG. 55, is performed on the planar image P selected as a target for correction, i.e., the planar image P1, in a substantially similar manner as described above referring to FIG. 36. Here, the corrected image C11 corresponds to the first corrected planar image C1, which has brightness and color that match brightness and color of the equirectangular projection image EC. The corrected image C21 corresponds to the second corrected planar image C2, which is generated by combining the first corrected planar image C11 and the planar image P1 according to the combined ratio calculated at S321. The flow (b), which is shown at right of FIG. 55, is performed on the planar image P that has not been selected as a target for correction. In this example, the planar image P2 is unselected. The corrected image C12 is the planar image P2 having the brightness and color corrected to match the brightness and color of the equirectangular projection image EC. The corrected image C12 is generated from the planar image P2 in a substantially manner as described above referring to S320 of FIG. 36. The corrected image C32 is an image having the brightness and color corrected to match the brightness and color of the planar image P1 that is a target for correction. At S323, the correction unit 584 corrects the brightness and color of the planar image P2 according to the brightness and color of the planar image P1, to generate the corrected image C32.

At S322, the correction unit 584 changes a combined ratio, and generates the corrected image C22, to be superimposed as the superimposed image S, by combining the corrected image C12 and the corrected image C32 according to the combined ratio.

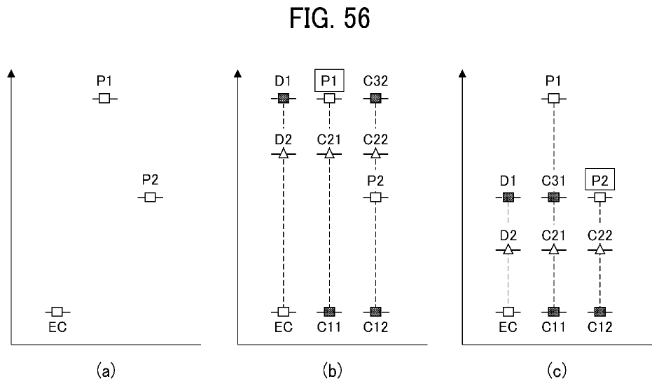

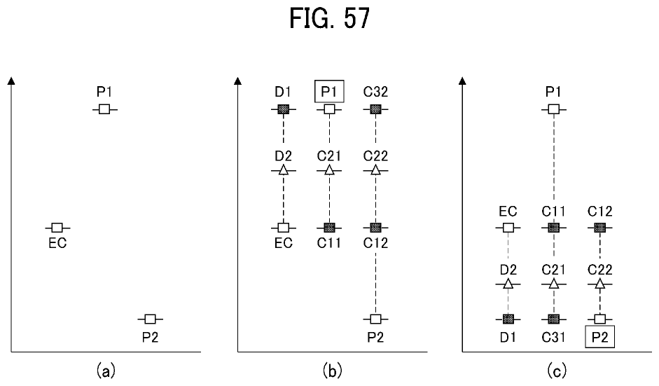

The following describes the example case in which one image is selected as the target for correction, and the example case in which a plurality of images is selected as the target for correction, using any one of the above-described selection methods. FIGS. 56 and 57 are conceptual diagrams for explaining operation of generating the second corrected planar image C2 (that is, C21 and C22) having brightness and color corrected, when there is only one superimposed image S as the target for correction. FIG. 56 illustrates the case when the brightness and color of the equirectangular projection image EC are smaller than those of either one of the planar images P1 and P2. FIG. 57 illustrates the case where the brightness and color of the equirectangular projection image EC are in between the planar images P1 and P2. The diagram (a) of FIG. 56 shows the difference in brightness and color between the equirectangular projection image EC, planar image P1, and planar image P2. The vertical axis represents values of brightness and color, with the values increasing in the upward direction and decreasing in the downward direction. Referring to (a) of FIG. 56, the brightness and color of the equirectangular projection image EC are smaller than those of either one of the planar images P1 and P2.

The diagram (b) of FIG. 56 illustrates a relation between the second corrected planar image C21 generated from the planar image P1 and the second corrected planar image C22 generated from the planar image P2, when the planar image P1 is selected as a target for correction. The corrected images C21 and C22 are generated using correction parameters, which are generated between the equirectangular projection image EC and each one of the planar images P1 and P2. The correction parameter is gain data for correcting the planar image P to have brightness and color that match brightness and color of the equirectangular projection image EC. The equirectangular projection image EC is multiplied with inverse gain data to have brightness and color that match the brightness and color of the planar image P1 or P2.

It is assumed that the gain data for the planar image P1 and planar image P2 are respectively g1 and g2. The inverse gain data for the planar image P1 and the planar image P2 are respectively G1(=1/g1) and G2(=1/g2). The corrected image having brightness and color that match brightness and color of the planar image P1, which is a target for correction, is generated as follows, in each of the processing for the equirectangular projection image EC and the processing for the planar image P2. In processing for the equirectangular projection image EC, the equirectangular projection image EC is multiplied with the inverse gain data G1 to generate the first corrected equirectangular projection image D1 having brightness and color that match brightness and color of the planar image P1. In processing for the planar image P2, the planar image P2 is multiplied with the gain data g2/g1 to generate the corrected image C32 having brightness and color that match brightness and color of the planar image P1.

Next, generation of the first corrected planar image C1 (C11 and C12) having brightness and color that match brightness and color of the equirectangular projection image EC is described according to the embodiment. The planar image P1 is multiplied with the gain data g1 to generate the corrected image C11. The planar image P2 is multiplied with the gain data g2 to generate the corrected image C12.

Next, generation of the second corrected image, to be used for generating the superimposed image, is described according to the embodiment. The correction unit 584 generates the second corrected equirectangular projection image D2 by combining the equirectangular projection image EC and the first corrected equirectangular projection image D1, as described above referring to FIG. 44. In processing for the planar image P1, the planar image P1 and the first corrected planar image C11 are combined to generate the second corrected planar image C21, as described above referring to FIG. 36. In processing for the planar image P2, the corrected image C32 and the first corrected planar image C12 are combined to generate the second corrected planar image C22, as described above referring to FIG. 55.

The diagram (c) of FIG. 56 illustrates a relation between the second corrected planar image C21 generated from the planar image P1 and the second corrected planar image C22 generated from the planar image P2, when the planar image P2 is selected as a target for correction. In processing to generate corrected images based on the planar image P2 as a target for correction, the equirectangular projection image EC is multiplied with the inverse gain data G2 to generate the first corrected equirectangular projection image D1 having brightness and color that match brightness and color of the planar image P2. Similarly, the planar image P is multiplied with the gain data g1/g2 to generate the corrected image C31 having brightness and color that match brightness and color of the planar image P2. In processing to generate corrected images based on the equirectangular projection image EC, the planar image P1 is multiplied with the gain data g1 to generate the corrected image C11 having brightness and color that match brightness and color of the equirectangular projection image EC. Similarly, the planar image P2 is multiplied with the gain data g2 to generate the corrected image C12 having brightness and color that match brightness and color of the equirectangular projection image EC.

Next, generation of the second corrected image, to be used for generating the superimposed image, is described according to the embodiment. The correction unit 584 generates the second corrected equirectangular projection image D2 by combining the equirectangular projection image EC and the first corrected equirectangular projection image D1, as described above referring to FIG. 44. In processing for the planar image P2, the planar image P2 and the first corrected planar image C12 are combined to generate the second corrected planar image C22, as described above referring to FIG. 36. In processing for the planar image P1, the corrected image C31 and the first corrected planar image C11 are combined to generate the second corrected planar image C21, as described above referring to FIG. 55.

Referring to (a) of FIG. 57, the brightness and color of the equirectangular projection image EC are in between the brightness and color of the planar image P1 and the brightness and color of the planar image P2. The diagram (b) of FIG. 57 illustrates a relation between the second corrected planar image C21 generated from the planar image P1 and the second corrected planar image C22 generated from the planar image P2, when the planar image P1 is selected as a target for correction. The diagram (c) of FIG. 57 illustrates a relation between the second corrected planar image C21 generated based on the planar image P1 and the second corrected planar image C22 generated based on the planar image P2, when the planar image P2 is selected as a target for correction. The corrected images C21 and C22 are generated in a substantially similar manner as described above referring to FIG. 55.

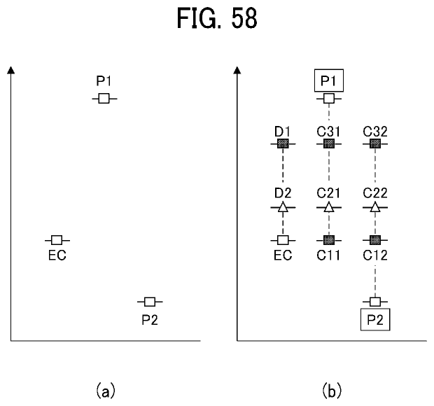

FIG. 58 is a conceptual diagram for explaining operation of generating the second corrected planar image C2 (that is, C21 and C22) having brightness and color corrected, when there are two superimposed images S as the target for correction. When there is more than one superimposed image S as a target for correction, the target values of brightness and color are calculated using a combined ratio of the superimposed images S, and the correction parameters generated for the equirectangular projection image EC and the planar image P1, and the equirectangular projection image EC and the planar image P2.

Referring to (a) of FIG. 58, the brightness and color of the equirectangular projection image EC are in between the brightness and color of the planar image P1 and the brightness and color of the planar image P2. The diagram (b) of FIG. 58 illustrates a relation between the second corrected planar image C21 generated based on the planar image P1 and the second corrected planar image C22 generated based on the planar image P2, when the combined ratio of the planar image P1 is “a” and the combined ratio of the planar image P2 is “1-a”.

It is assumed that the gain data for the planar image P1 and planar image P2 are respectively g1 and g2. The combined ratio “a” is calculated, for example, as described for the first method of selecting the superimposed image as a target for correction.

The correction unit 584 generates the corrected image having the brightness and color that match the brightness and color of the target for correction. The equirectangular projection image EC is multiplied with a/g1+(1-a)/g2, to generate the first corrected equirectangular projection image D1. The planar image P1 is multiplied with {a/g1+(1-a)/g2}*g1, to generate the corrected image C31. The planar image P2 is multiplied with {a/g1+(1-a)/g2}*g2, to generate the corrected image C32. Accordingly, the corrected image has brightness and color, obtained as the weighted average of brightness and color of the planar image P1 and brightness and color of the planar image P2, with a weighing factor being determined according to the combined ratio of planar images P1 and P2.

In processing to generate corrected images based on the equirectangular projection image EC, the planar image P1 is multiplied with the gain data g1 to generate the corrected image C11 having brightness and color that match brightness and color of the equirectangular projection image EC. Similarly, the planar image P2 is multiplied with the gain data g2 to generate the corrected image C12 having brightness and color that match brightness and color of the equirectangular projection image EC.

Next, generation of the second corrected images, to be used for generating the superimposed image, is described according to the embodiment. The correction unit 584 generates the second corrected equirectangular projection image D2 by combining the equirectangular projection image EC and the first corrected equirectangular projection image D1, as described above referring to FIG. 44. In processing for the planar image P1, the corrected image C31 having brightness and color closer to brightness and color of the planar image P1, and the first corrected planar image C11 having brightness and color that match brightness and color of the equirectangular image EC are combined to generate the second corrected planar image C21, in a substantially similar manner as described above referring to FIG. 55. In processing for the planar image P2, the corrected image C32 having brightness and color that match brightness and color of the equirectangular image EC and the first corrected planar image C12 having brightness and color closer to brightness and color of the planar image P2 are combined to generate the second corrected planar image C22, in a substantially similar manner as described above referring to FIG. 55.

The above-described embodiment illustrates an example case where two superimposed images S are superimposed for display in the predetermined area T. However, the above-described operation may be performed when more than two superimposed images are superimposed.

As described above, even when the plurality of superimposed images are being superimposed for display in the predetermined area T, the correction unit 584 automatically selects a target for correction, based on the plurality of superimposed images. The correction unit 584 generates corrected images respectively for the equirectangular projection image EC and planar image P, each having brightness and color that match those of the target for correction. The correction unit 584 then generates the spherical image and the superimposed image, using the corrected images. Accordingly, the image of the predetermined area T is displayed with brightness and color that are adequately corrected, such that the plurality of superimposed images fit in the spherical image when displayed in the predetermined area T.

### Seventh Embodiment

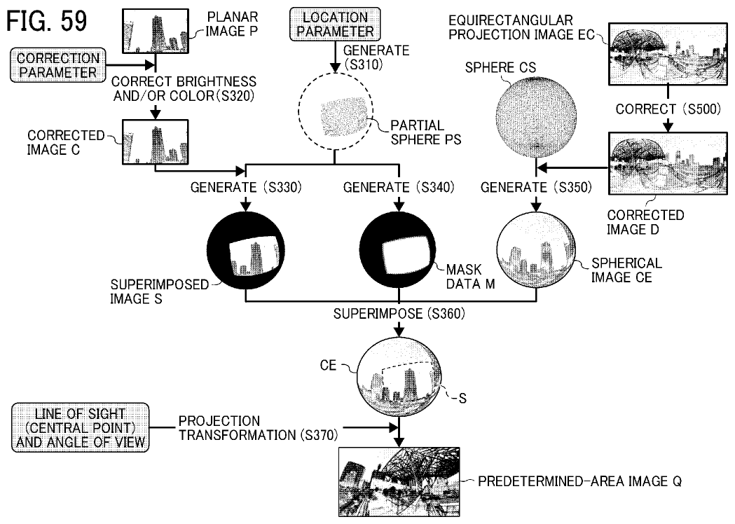

In some cases, however, there may be no superimposed image S being displayed in the predetermined area T depending on the line of sight direction and the angle of view of the virtual camera IC. In such case, there will be no target for correction. Referring now to FIGS. 59 to 63, operation of correcting the image is described according to the seventh embodiment.

FIG. 59 is a conceptual diagram illustrating processing to correct the equirectangular projection image EC with images being processed or generated, according to this embodiment. In this embodiment, there is no superimposed image S in the predetermined-area image Q. For simplicity, only the difference from the operation of FIG. 43 is described. In this embodiment illustrated in FIG. 59, S500 of correcting the equirectangular projection image EC is performed differently than S400 of correcting the equirectangular projection image EC in FIG. 43.

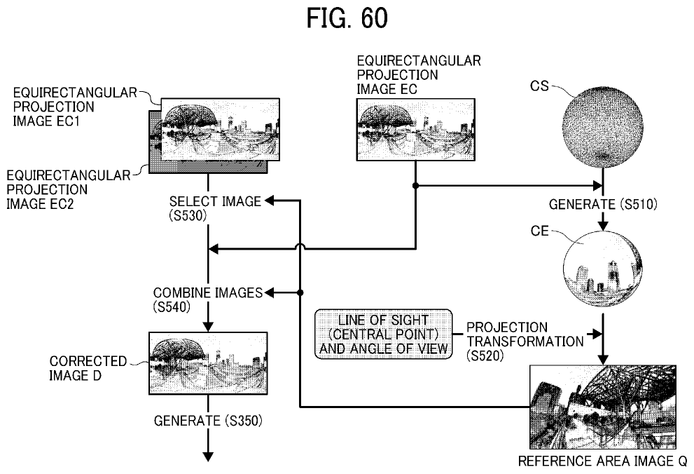

FIG. 60 illustrates operation of correcting the equirectangular projection image EC performed at S500 of FIG. 59. In this embodiment, a plurality of equirectangular projection images EC1 and EC2 that differ in exposure are used, in addition to the equirectangular projection image EC from which the spherical image is generated. Further, the example case in which the brightness is corrected is described.

The special image capturing device 1 generates the equirectangular projection images, while just changing exposure, for example, when capturing the target object and its surroundings to generate the equirectangular projection image EC. In this embodiment, it is assumed that at least the equirectangular projection image EC1 with exposure higher than that of the equirectangular projection image EC (“overexposed image EC1”), and the equirectangular projection image EC2 with exposure lower than that of the equirectangular projection image EC (“underexposed image EC2”) are obtained. Alternatively, three or more than three equirectangular projection images that differ in exposure may be generated.

In FIG. 60, the image generator 586 maps the equirectangular projection image EC, over the sphere CS, to generate the spherical image CE. The projection converter 590 then applies projection transformation to the spherical image CE to generate a predetermined-area image Q. Alternatively, an area corresponding to the predetermined area T may be specified in the equirectangular projection image EC.

At S510, the image generator 586 maps the equirectangular projection image EC, which is uncorrected, over a surface of the sphere CS, to generate the spherical image CE, in a substantially similar manner as described above referring to S350.

At S520, the projection converter 590 applies projection transformation to the spherical image CE, to display a predetermined area T defined by the line of sight direction (the central point CP of the predetermined area T) and the angle of view of the virtual camera IC, in a substantially similar manner as described above referring to S370 of FIG. 25. This results in generation of the predetermined-area image Q. In this embodiment, a part of the equirectangular projection image EC having no planar image P is generated as the predetermined-area image Q.

At S530, the correction unit 584 selects the overexposed image EC1 or the underexposed image EC2, which is to be combined with the equirectangular projection image EC, according to the average of brightness values of the predetermined-area image Q.

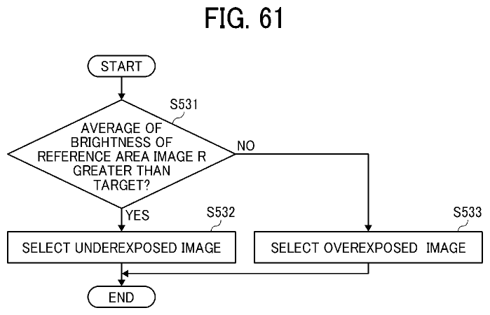

Referring to FIG. 61, selection of the overexposed image EC1 or the underexposed image EC2 is described according to the embodiment. FIG. 61 is a flowchart illustrating operation of selecting the equirectangular projection image to be combined with the predetermined-area image Q, from among a plurality of equirectangular projection images that are captured in different exposure, according to the embodiment.

At S531, the correction unit 584 determines a target brightness value, as a target for correction. The correction unit 584 compares the average brightness value of the entire predetermined-area image Q with the target brightness value. In this example, the target brightness value is previously determined. For example, in the case of 8-bit RGB data having 256 different color values (color levels), the target brightness value is set to the medium value of 128. The correction unit 584 compares the brightness average value of the predetermined-area image Q with the target value 128. More specifically, in this example, the pixel value is normalized to have a value from 0 to 1, such that the target brightness value is expressed by 0.5. Alternatively, the target brightness value may be set to the value 100 or 150 of 256 color levels.

When the average brightness value of the predetermined-area image Q is greater than the target brightness value (“YES” at S521), operation proceeds to S532. At S532, since the predetermined-area image Q is over exposed, the correction unit 584 selects the underexposed image EC2 to be combined with the predetermined-area image Q.

When the average brightness value of the predetermined-area image Q is less than the target brightness value (“NO” at S521), operation proceeds to S533. At S533, the correction unit 584 selects the overexposed image EC1 to be combined with the predetermined-area image Q. When the average brightness value of the predetermined-area image Q is equal to the target brightness value, any one of the overexposed image EC1 and the underexposed image EC2 may be selected.

In the above-described example, the average of brightness of the entire predetermined-area image Q is used. However, the brightness value of a part of the predetermined-area image Q, such as its central part, may be used instead. Alternatively, any characteristic value relating to brightness may be used, such as histogram.

Referring back to FIG. 60, at S540, the correction unit 584 combines the equirectangular projection image EC with one of the overexposed image EC1 and the underexposed image EC2 that has been selected at S530, to generate a corrected equirectangular projection image D. It is assumed that the brightness average value of the predetermined-area image Q is ref (ranging from 0.0 to 1.0), and the target brightness value is aim (ranging from 0.0 to 1.0). The correction value adj is calculated using Equation 18.

adj=|(aim-ref)*correction coefficient|, 0.0<=adj<=1.0 (Equation 18)

Here, the correction value adj is clipped to be within the range from 0.0 to 1.0. Through clipping, any value less than the lower limit 0.0 is corrected to be equal to 0.0. Any value greater than the upper limit 1.0 is corrected to be equal to 1.0. The correction coefficient determines an amount of correction to be performed on the predetermined area image Q, to be closer to the overexposed image EC1 or the underexposed image EC2 in brightness value. The correction coefficient is determined according to a difference between the brightness average value of the predetermined area image Q and the target brightness value. The correction coefficient may be set by the user, by visually checking the image. Alternatively, the smart phone 5 may automatically calculate the correction coefficient based on the exposure value used for image capturing. Alternatively, the correction coefficient may be previously set by default. For example, the correction coefficient may be set to 3.0.

When the equirectangular projection image (EC1 or EC2) selected at S530 is represented by ECS, and the equirectangular image EC is represented by EC, each pixel value D (u, v) of the corrected equirectangular projection image D is obtained using Equation 19.

D(u,v)=ECS(u,v)*adj+EC(u,v)*(1.0-adj) (Equation 19)

The subsequent processing is performed in a substantially similar manner as described above referring to FIG. 43. Referring back to FIG. 59, at S360, the correction unit 584 superimposes the superimposed image S on the spherical image CE. At S370, the projection converter 590 applies projection transformation to the predetermined area T of the spherical image CE according to the line of sight direction and the angle of view of the virtual camera IC. The display control 56 then displays the predetermined-area image Q onto the display 517. In this embodiment, since the planar image P is not displayed in the predetermined-area image Q, the planar image P belongs to the Area 3 of (b-1) of FIG. 45. This results in the combined ratio of the superimposed image S and the corrected planar image C to be 1.0. The second corrected planar image C2 is equivalent to the first corrected planar image C1 having the brightness that matches the brightness of the equirectangular projection image EC. On the other hand, as illustrated in FIG. 45, the combined ratio of the equirectangular projection image EC and the first corrected equirectangular projection image D1 becomes 0.0. The second corrected equirectangular projection image D2 thus has the brightness that matches the brightness of the first corrected equirectangular projection image D1. Accordingly, the image of the predetermined area T, i.e., the predetermined-area image Q, is displayed with brightness that is adequately corrected using the corrected equirectangular projection image D.

Now, operation of correcting the images when there is more than two equirectangular projection images that differ in exposure, in addition to the equirectangular projection image EC, is described according to other example. Specifically, in this example, there are two overexposed images EC1 and two underexposed images EC2. This results in five equirectangular projection images including the equirectangular projection images EC to be used for generating the spherical image CE. These images respectively have exposure values (EV) of −2.0, −1.0, 0.0, +1.0, and +2.0. The EVs −2.0 and −1.0 each indicate that the images are under exposed. The EVs +1.0 and +2.0 each indicate that the images are over exposed. The EV of the equirectangular projection image EC, which is 0.0, is combined with any one of the overexposed and underexposed images that range from −2.0 to +2.0 to correct exposure.

In this example, the combined value “blend”, which indicates a combined ratio, is calculated using Equation 19. However, the range to be clipped may differ. As indicated by Equation 20, the combined value “blend” may be clipped in the range from 0.0 to 2.0.

0.0<=blend<=2.0 (Equation 20)

That is, when there are a plurality of images that differ in exposure for each one of overexposed image and underexposed image, the correction unit 584 changes a range of clipping to switch the images to be combined according to the combined value “blend”.

The combined value “blend” of the corrected image D is then obtained using Equation 21.

D(u,v)=I1(u,v)*adj+I2(u,v)*(1.0-adj) (Equation 21)

Here, I1 represents the image selected as a target for correction, and I2 represents the image to be corrected.

The following describes the example case in which the predetermined-area image Q is made darker.

In the example case (i) where 0.0<=blend<=1.0, the correction value “adj” is equal to the combined value “blend”. In this case (i), the underexposed image with EV −1.0 is selected as the image I1. The equirectangular projection image EC (the predetermined-area image Q) with EV 0.0 is selected as the image I2.

In the example case (ii) where 1.0<blend<=2.0, the correction value “adj” is equal to (combined value “blend”−1.0). In this case (ii), the underexposed image with EV −2.0 is selected as the image I1. The underexposed image with EV −1.0 is selected as the image I2.

As described above, when the combined value “blend” is larger than a given value, the correction unit 584 combines the predetermined-area image Q, and the underexposed image that is the next darkest image to the predetermined-area image Q (case (i)). When the combined value “blend” is smaller than the given value, the correction unit 584 combines two underexposed images each have darker values than the values of the predetermined-area image Q (case (ii)). The predetermined-area image Q may be made darker by a desired amount as indicated by the combined ratio “blend”, through selecting and combining two images from among the predetermined-area image Q and two underexposed images.

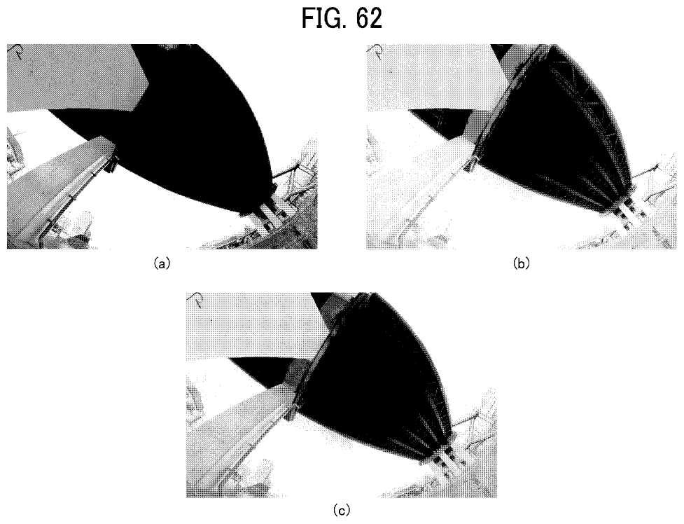

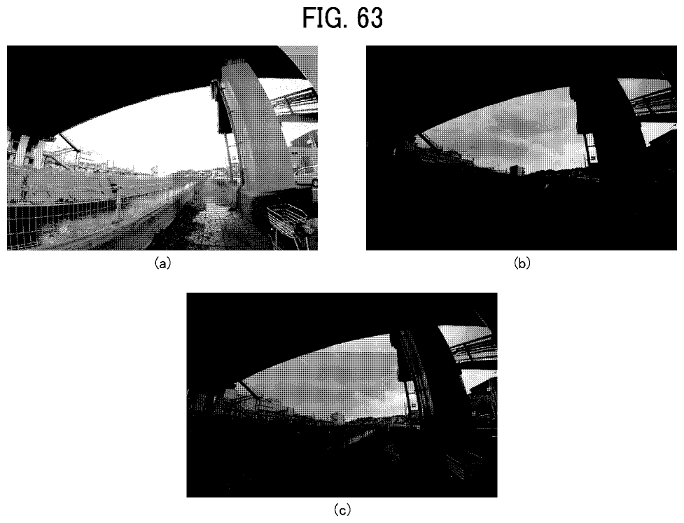

Referring to FIGS. 62 and 63, specific examples of combining images are described. In one example, the image (a) of FIG. 62 is the equirectangular projection image EC, which has been captured with a reference exposure value. Due to the large difference in brightness between the bright part and the dark part in the image of the predetermined area T, the central part of the predetermined area T is displayed in solid black.

In one example, the image (b) of FIG. 62 is an image of the predetermined area T of the overexposed image EC1, which has been captured at the same location as that of the image (a) but with higher exposure. The central part of the image (b) is displayed with the adequate exposure value. The image (c) of FIG. 62 is a corrected equirectangular projection image D, which is generated by combining the equirectangular projection image EC of (a) and the overexposed image EC1 of (b), as described above referring to FIGS. 59 and 60.

Even with absent of the target object, i.e., the planar image P, underexposure of the predetermined area T can be compensated by combining with the overexposed image according to a combined ratio determined by the brightness value of the predetermined area T.

In other example, the image (a) of FIG. 63 is the equirectangular projection image EC, which has been captured with a reference exposure value. Due to the large difference in brightness between the bright part and the dark part in the predetermined area T, the central part of the predetermined area T is displayed with a white spot.

The image (b) of FIG. 63 is an image of the predetermined area T of the underexposed image EC2, which has been captured at the same location as that of the image (a). The central part of the image (b) is displayed with the adequate exposure value. The image (c) of FIG. 63 is a corrected equirectangular projection image D, which is generated by combining the equirectangular projection image EC of (a) and the underexposed image EC2 of (b), as described above referring to FIGS. 59 and 60.

Even with absent of the target object, i.e., the planar image P, overexposure of the predetermined area T can be compensated by combining with the underexposed image according to a combined ratio determined by the brightness value of the predetermined area T.

The above-described operation of correcting at least one of the brightness and color of the spherical image CE, when there is no superimposed image S being displayed in the predetermined area T, may be applied to the example case where the wide-angle view image is displayed with no planar image being displayed.

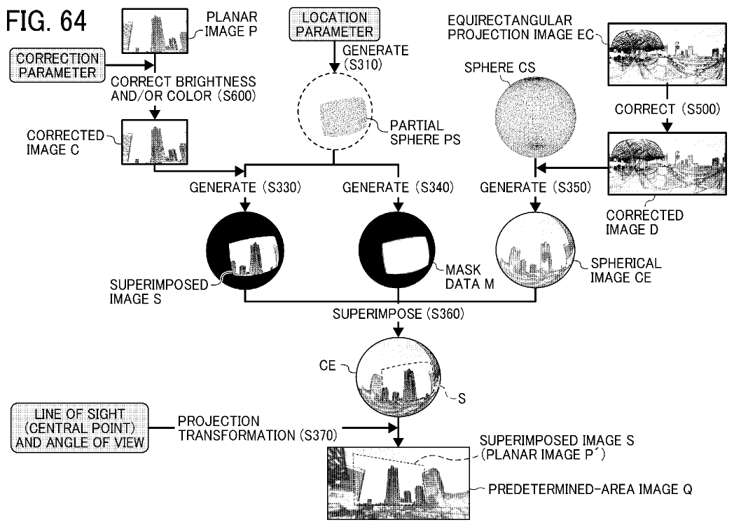

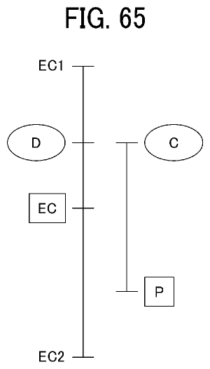

Referring now to FIGS. 64 and 65, operation of correcting the images is described according to the eight embodiment. FIG. 64 is a conceptual diagram illustrating processing to correct the equirectangular projection image EC a For simplicity, only the difference from the operation of FIG. 59 is described.

S500 of correcting the equirectangular projection image EC is performed in a substantially similar manner as described above referring to FIG. 59. Specifically, at S500, the corrected equirectangular projection EC is generated, using at least one of a plurality of equirectangular projection images EC1 and EC2 that differ in exposure, to display the predetermined-area image Q having brightness and color that are adequately corrected based on the target value.

In the above-described embodiment referring to FIGS. 59 to 63, even when the planar image P is not displayed in the predetermined area T, the predetermined-area image Q is displayed with the brightness and color adequately corrected. In this embodiment, the planar image P being displayed in the predetermined area T is corrected so as to match the brightness and color of the equirectangular projection image EC. Accordingly, even when the planar image P is displayed in the predetermined area T, the planar image P is displayed with the brightness and color adequately corrected.

Referring to FIG. 64, at S600, the correction unit 584 corrects the planar image P to generate the corrected planar image C, which has the brightness and color that match the brightness and color of the corrected equirectangular projection image D.

FIG. 65 illustrates a relation between the corrected equirectangular projection image D and the corrected planar image C. The value of brightness increases with the upward direction, and the value of brightness decreases with the downward direction. As described above referring to FIG. 59, at S500, the correction unit 584 selects the overexposed image EC1 or the underexposed image EC2, which is to be combined with the equirectangular projection image EC. The correction unit 584 generates the corrected equirectangular projection image D, using the equirectangular projection image EC and the selected one of the overexposed image EC1 and the underexposed image EC2.

At S600, the correction unit 584 corrects the planar image P to generate the corrected planar image C, which has the brightness and color that match the brightness and color of the corrected equirectangular projection image D.

Now, the specific example of generating the corrected planar image C is described. The corrected equirectangular projection image D is generated by correcting the brightness and color of the equirectangular projection image EC. The correction unit 584 calculates a ratio of the third area CA 3 between the equirectangular projection image EC and the corrected equirectangular projection image D in brightness and color.

In this embodiment, the brightness of the third area CA3 in the equirectangular projection image EC, and the brightness of the corrected equirectangular projection image D, are respectively represented by Y and YD. The brightness ratio of the corrected equirectangular projection image D to the equirectangular projection image EC is expressed as YD/Y. The correction parameter in the superimposed display metadata includes gain data for correcting the brightness and color of the planar image P, to match the brightness and color of the equirectangular projection image EC. The correction unit 584 calculates a correction parameter for correcting the brightness of the planar image P to match the brightness of the corrected image D, by multiplying this correction parameter with the obtained brightness ratio. In a substantially similar manner, the correction parameter for correcting color of the planar image P to match the color of the corrected image D is calculated by multiplying the correction parameter with the obtained color ratio. The planar image P is multiplied with the calculated correction parameter for correcting brightness and color, to generate the corrected image having the brightness and color that match the brightness and color of the corrected image D.

As illustrated in FIG. 65, the equirectangular projection image EC is combined with the overexposed image EC1, to generate the corrected equirectangular projection image D having the brightness and color adequately corrected. Further, the corrected planar image C having the brightness and color adequately corrected, is generated from the planar image P.

Since the corrected planar image C is corrected to match the brightness and color of the corrected equirectangular projection image D, it does not matter whether the planar image P is displayed in the predetermined area T. Accordingly, the smart phone 5 displays the predetermined-area image Q based on the corrected equirectangular projection image D, with the brightness and color adequately corrected.

As described above, with use of the corrected image D and the corrected image C, the predetermined-area image Q being displayed in the display area of the display is displayed with the brightness and color that are optimized when viewed from the user.

### Eight Embodiment

In this eighth embodiment, the brightness and color of the images are corrected more flexibly, compared to the fourth and fifth embodiments. In any one of the above-described fourth and fifth embodiments, the brightness and color of the image being displayed are within a range between the equirectangular projection image EC and the planar image P, as illustrated in FIG. 52. In the eighth embodiment, the brightness and color of the equirectangular projection image EC are made close to the target brightness and color values. Similarly, the brightness and color of the planar image P are made close to the target brightness and color values. Since the target values are not limited in the range between the equirectangular projection image EC and the planar image P, the brightness and color values of the image being displayed may be corrected more desirably.

Any one of the above-described embodiments may be implemented in various other ways. For example, as illustrated in FIG. 14, the equirectangular projection image data, planar image data, and superimposed display metadata, may not be stored in a memory of the smart phone 5. For example, any of the equirectangular projection image data, planar image data, and superimposed display metadata may be stored in any server on the network.

In any of the above-described embodiments, the planar image P is superimposed on the spherical image CE. Alternatively, the planar image P to be superimposed may be replaced by a part of the spherical image CE. In another example, after deleting a part of the spherical image CE, the planar image P may be embedded in that part having no image.

Furthermore, in the second embodiment, the image processing server 7 performs superimposition of images (S45). For example, the image processing server 7 may transmit the superimposed display metadata to the smart phone 5, to instruct the smart phone 5 to perform superimposition of images and display the superimposed images. In such case, at the image processing server 7, the metadata generator 75a illustrated in FIG. 34 generates superimposed display metadata. At the smart phone 5, the superimposing unit 75b illustrated in FIG. 34 superimposes one image on other image, in a substantially similar manner in the case of the superimposing unit 55b in FIG. 16. The display control 56 illustrated in FIG. 14 processes display of the superimposed images.

Further, in alternative to defining the angle β as a difference (displacement or shift) between the line of sight direction and the superimposed image (planar image), the angle β may be defined by a distance between the line of sight direction and the superimposed image (planar image).

Further, display of the spherical image may be performed using any desired software such as browser software or application software.

Further, any number of imaging elements, such as cameras, may be provided on the smart phone 5 or connected to the smart phone 5.

In this disclosure, examples of superimposition of images include, but not limited to, placement of one image on top of other image entirely or partly, laying one image over other image entirely or partly, mapping one image on other image entirely or partly, pasting one image on other image entirely or partly, combining one image with other image, and integrating one image with other image. That is, as long as the user can perceive a plurality of images (such as the spherical image and the planar image) being displayed on a display as they were one image, processing to be performed on those images for display is not limited to the above-described examples.

The present invention can be implemented in any convenient form, for example using dedicated hardware, or a mixture of dedicated hardware and software. The present invention may be implemented as computer software implemented by one or more networked processing apparatuses. The processing apparatuses can compromise any suitably programmed apparatuses such as a general-purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium such as a recording medium. The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

In one example, the present invention resides in an image processing apparatus including circuitry to obtain a first image and a second image; control a display to display an image of a predetermined area of the first image, the first image being superimposed with the second image; and correct at least one of brightness and color of the second image according to a ratio of an area of the second image in the predetermined area with respect to the predetermined area of the first image.

In one example, the image processing apparatus further accepts an instruction to change at least one of a location and a size of the predetermined area in the first image. Based on a determination that the instruction to change causes the change in ratio of the area of the second image to the predetermined area, the circuitry corrects the at least one of brightness and color of the second image according to the ratio of the area of the second image to the predetermined area that has been changed.

In one example, with decrease in the ratio of the area of the second image to the predetermined area, the circuitry increases an amount of correction to be performed on the second image such that the second image reflects more of the at least one of brightness and color of the predetermined area.

With increase in the ratio of the area of the second image to the predetermined area, the circuitry reduces an amount of correction to be performed on the second image such that the second image reflects less of the at least one of brightness and color of the predetermined area.

In one example, the first image is in first projection and the second image is in second projection, the first projection and the second projection being different from each other. The circuitry generates a correction image based on the second image, the correction image having the at least one of brightness and color that matches the at least one of brightness and color of the first image, and determines a combined ratio of the at least one of brightness and color of the second image with respect to the at least one of brightness and color of the corrected image according to the ratio of the area of the second image to the predetermined area. The combined ratio has a value ranging from a first value to a second value. The first value causes the at least one of brightness and color of the second image be unchanged, and the second value causes the at least one of brightness and color of the second image be corrected to match the at least one of brightness and color of the corrected image.

In one example, the circuitry calculates the ratio of the area of the second image to the predetermined area, based on an angle of view indicating a central point and a size of the predetermined area, with respect to an angle of view indicating a central point and a size of the second image.

In another example, an image processing apparatus includes circuitry to obtain a first image and a second image; control a display to display an image of a predetermined area of the first image, the first image being superimposed with the second image; and correct at least one of brightness and color of at least one of the first image and the second image, according to a difference between a line of sight direction in the first image and a central point of the second image.

In one example, with decrease in the difference between a line of sight direction in the first image and a central point of the second image, the circuitry controls correction performed respectively on the first image and the second image, such that the first image reflects more of the at least one of brightness and color of the second image while the second image keeps more of the at least one of brightness and color of the second image.

With increase in the difference between a line of sight direction in the first image and a central point of the second image, the circuitry controls correction performed respectively on the first image and the second image, such that the second image reflects more of the at least one of brightness and color of the first image while the first image keeps more of the at least one of brightness and color of the first image.

In one example, the first image is in first projection and the second image is in second projection, the first projection and the second projection being different from each other. The circuitry generates a first correction image based on the second image, the first correction image having the at least one of brightness and color that matches the at least one of brightness and color of the first image, determines a first combined ratio of the at least one of brightness and color of the second image with respect to the at least one of brightness and color of the first corrected image, according to the difference between a line of sight direction in the first image and a central point of the second image, and combines the at least one of brightness and color of the second image and the at least one of brightness and color of the first corrected image according to the first combined ratio, to correct the at least one of brightness and color of the second image.

In one example, the first image is in first projection and the second image is in second projection, the first projection and the second projection being different from each other. The circuitry generates a second correction image based on the first image, the second correction image having the at least one of brightness and color that matches the at least one of brightness and color of the second image, determines a second combined ratio of the at least one of brightness and color of the first image with respect to the at least one of brightness and color of the second corrected image, according to the difference between a line of sight direction in the first image and a central point of the second image, and combines the at least one of brightness and color of the first image and the at least one of brightness and color of the second corrected image according to the second combined ratio, to correct the at least one of brightness and color of the first image.

In one example, the circuitry obtains a plurality of first projection images that respectively have different exposure values from an exposure value of the first image being superimposed with the second image, and adjusts the at least one of brightness and color of the first image to be used for generating the second correction image, using at least one of the plurality of first projection images, to compensate overexposure or underexposure of the first image.

In one example, when the second image includes a plurality of second images to be superimposed on the first image, the circuitry calculates target values of the at least one of brightness and color to be used for correcting the at least one of brightness and color of the first image, the target values being calculated based on one of: 1) the at least one of brightness and color of one of the plurality of second images having the smallest difference between a line of sight direction in the first image and a central point of the second image; 2) the at least one of brightness and color of one of the plurality of second images having the largest area of the second image in the predetermined area; 3) the at least one of brightness and color of a combined image generated by combining at least two of the plurality of second images according to a combined ratio that is determined by a weighted average of differences each indicating a difference between a line of sight direction in the first image and a central point of the second image for each of the second images; and 4) the at least one of brightness and color of a combined image generated by combining at least two of the plurality of second images according to a combined ratio that is determined by a weighted average of areas of the second images in the predetermined area.

This patent application is based on and claims priority pursuant to 35 U.S.C. § 119(a) to Japanese Patent Application Nos. 2016-256581, filed on Dec. 28, 2016, 2017-051838, filed on Mar. 16, 2017, 2017-208677, filed on Oct. 27, 2017, and 2017-245455, filed on Dec. 21, 2017, in the Japan Patent Office, the entire disclosure of which is hereby incorporated by reference herein.

### REFERENCE SIGNS LIST

1 special-purpose image capturing device (example of first image capturing device)
3 general-purpose image capturing device (example of second image capturing device)
5 smart phone (example of image processing device)
52 acceptance unit
55 image and audio processing unit
55a metadata generator
55b superimposing unit
56 display control
58 near-distance communication unit
517 display
550 extractor
552 first area calculator
554 point of gaze specifier
556 projection converter
558 second area calculator
560 area divider
562 projection reverse converter
564 shape converter
566 correction parameter generator
570 superimposed display metadata generator
582 attribute area generator
584 corrector
586 image generator
588 image superimposing unit
590 projection converter
5000 memory
5001 linked image capturing device DB

1-21. (canceled)

22. An image processing apparatus, comprising:
circuitry configured to
obtain a first image and a second image;
control a display to display an image of a predetermined area of the first image, the first image being superimposed with the second image; and
correct at least one of brightness and color of the second image according to a ratio of an area of the second image within the predetermined area with respect to the predetermined area of the first image.

23. The image processing apparatus of claim 22, wherein the circuitry is further configured to:
accept an instruction to change at least one of a location and a size of the predetermined area in the first image, and
based on a determination that the instruction to change causes a change in the ratio of the area of the second image to the predetermined area, correct the at least one of brightness and color of the second image according to the ratio of the area of the second image to the predetermined area that has been changed.

24. The image processing apparatus of claim 22, wherein, with a decrease in the ratio of the area of the second image to the predetermined area, the circuitry is further configured to increase an amount of correction to be performed on the second image such that the second image reflects more of at least one of brightness and color of the predetermined area of the first image.

25. The image processing apparatus of claim 22, wherein, with an increase in the ratio of the area of the second image to the predetermined area, the circuitry is further configured to reduce an amount of correction to be performed on the second image such that the second image reflects less of at least one of brightness and color of the predetermined area of the first image.

26. The image processing apparatus of claim 22,
wherein the first image has a first projection and the second image has a second projection, the first projection and the second projection being different from each other,
wherein the circuitry is further configured to
generate a correction image based on the second image, the correction image having at least one of brightness and color that matches at least one of brightness and color of the first image; and
determine a combined ratio of the at least one of brightness and color of the second image with respect to the at least one of brightness and color of the corrected image according to the ratio of the area of the second image to the predetermined area,
the combined ratio has a value ranging from a first value to a second value,
the first value causing the at least one of brightness and color of the second image to be unchanged, and
the second value causing the at least one of brightness and color of the second image to be corrected to match the at least one of brightness and color of the corrected image.

27. The image processing apparatus of claim 22, wherein the circuitry is further configured to calculate the ratio of the area of the second image to the predetermined area, based on an angle of view indicating a central point and a size of the predetermined area, with respect to an angle of view indicating a central point and a size of the second image.

28. An image processing apparatus, comprising:
circuitry configured to
obtain a first image and a second image;
control a display to display an image of a predetermined area of the first image, the first image being superimposed with the second image; and
correct at least one of brightness and color of at least one of the first image and the second image, according to a difference between a line of sight direction in the first image and a central point of the second image.

29. The image processing apparatus of claim 28, wherein, with a decrease in the difference between the line of sight direction in the first image and the central point of the second image, the circuitry is further configured to control a correction performed respectively on the first image and the second image, such that the first image reflects more of the at least one of brightness and color of the second image while the second image keeps more of the at least one of brightness and color of the second image.

30. The image processing apparatus of claim 28, wherein, with an increase in the difference between the line of sight direction in the first image and the central point of the second image, the circuitry is further configured to control correction performed respectively on the first image and the second image, such that the second image reflects more of the at least one of brightness and color of the first image while the first image keeps more of the at least one of brightness and color of the first image.

31. The image processing apparatus of claim 29,
wherein the first image has a first projection and the second image has a second projection, the first projection and the second projection being different from each other,
wherein the circuitry is further configured to
generate a first correction image based on the second image, the first correction image having at least one of brightness and color that matches the at least one of brightness and color of the first image;
determine a first combined ratio of the at least one of brightness and color of the second image with respect to the at least one of brightness and color of the first corrected image, according to the difference between the line of sight direction in the first image and the central point of the second image; and
combine the at least one of brightness and color of the second image and the at least one of brightness and color of the first corrected image according to the first combined ratio, to correct the at least one of brightness and color of the second image.

32. The image processing apparatus of claim 29,
wherein the first image has a first projection and the second image has a second projection, the first projection and the second projection being different from each other,
wherein the circuitry is further configured to
generate a second correction image based on the first image, the second correction image having at least one of brightness and color that matches the at least one of brightness and color of the second image;
determine a second combined ratio of the at least one of brightness and color of the first image with respect to the at least one of brightness and color of the second corrected image, according to the difference between the line of sight direction in the first image and the central point of the second image; and
combine the at least one of brightness and color of the first image and the at least one of brightness and color of the second corrected image according to the second combined ratio, to correct the at least one of brightness and color of the first image.

33. The image processing apparatus of claim 28, wherein the circuitry is further configured to:
obtain a plurality of first projection images that respectively have different exposure values from an exposure value of the first image being superimposed with the second image; and
adjust the at least one of brightness and color of the first image to be used for generating the second correction image, using at least one of the plurality of first projection images, to compensate overexposure or underexposure of the first image.

34. The image processing apparatus of claim 28, wherein, when the second image includes a plurality of second images to be superimposed on the first image, the circuitry is further configured to calculate target values of the at least one of brightness and color to be used for correcting the at least one of brightness and color of the first image, the target values being calculated based on one of:
(1) the at least one of brightness and color of one of the plurality of second images having the smallest difference between the line of sight direction in the first image and the central point of the second image;
(2) the at least one of brightness and color of one of the plurality of second images having the largest area of the second image in the predetermined area;
(3) the at least one of brightness and color of a combined image generated by combining at least two of the plurality of second images according to a combined ratio that is determined by a weighted average of differences each indicating a difference between the line of sight direction in the first image and the central point of the second image for each of the second images; and
(4) the at least one of brightness and color of a combined image generated by combining at least two of the plurality of second images according to a combined ratio that is determined by a weighted average of areas of the second images in the predetermined area.

35. The image processing apparatus of claim 22, wherein the first image obtained by the circuitry is an equirectangular projection image and the second image is a perspective projection image.

36. The image processing apparatus of claim 22, wherein the first image obtained by the circuitry is a spherical image and the second image is a planar image.

37. An image capturing system, comprising:
the image processing apparatus of claim 22;
a first image capturing device configured to capture a target object and surroundings of the target object to obtain the first image having a first projection, and transmit the first image having the first projection to the image processing apparatus; and
a second image capturing device configured to capture the target object to obtain the second image having a second projection, and transmit the second image having the second projection to the image processing apparatus.

38. An image processing system, comprising:
circuitry configured to
obtain a first image and a second image;
control a display to display an image of a predetermined area of the first image,
the first image being superimposed with the second image; and
correct at least one of brightness and color of the second image according to a ratio of an area of the second image in the predetermined area with respect to the predetermined area of the first image.

39. An image processing system, comprising:
circuitry configured to
obtain a first image and a second image;
control a display to display an image of a predetermined area of the first image, the first image being superimposed with the second image; and
correct at least one of brightness and color of at least one of the first image and the second image, according to a difference between a line of sight direction in the first image and a central point of the second image.

40. An image processing method, comprising:
obtaining a first image and a second image;
displaying, on a display, an image of a predetermined area of the first image, the first image being superimposed with the second image; and
correcting at least one of brightness and color of the second image according to a ratio of an area of the second image in the predetermined area with respect to the predetermined area of the first image.

41. An image processing method, comprising:
obtaining a first image and a second image;
displaying, on a display, an image of a predetermined area of the first image, the first image being superimposed with the second image; and
correcting at least one of brightness and color of at least one of the first image and the second image, according to a difference between a line of sight direction in the first image and a central point of the second image.
